(19) United States
(12) Patent Application Publication
(10) Pub. No.: US 2010/0224555 A1
(43) Pub. Date: Sep. 9, 2010

(54) NANOCOMPOSITE MEMBRANES AND METHODS OF MAKING AND USING SAME

(76) Inventors: Eric M.V. Hoek, Los Angeles, CA (US); Asim K. Ghosh, Mumbai (IN)

Correspondence Address: Ballard Spahr LLP, SUITE 1000, 999 PEACHTREE STREET, ATLANTA, GA, 30309-3915, US

(21) Appl. No.: 12/679,393

(22) PCT Filed: Sep. 20, 2008
(86) PCT No.: PCT/US08/77146

§ 371 Date: Mar. 22, 2010

Related U.S. Application Data
(60) Provisional application No. 60/974,411, filed on Sep. 21, 2007.

(51) Int. Cl. B01D 69/00; B05D 3/12

(52) U.S. Cl. 210/500.42; 427/322

(57) ABSTRACT

Disclosed are composite membranes for removing contaminants from water, the membranes comprising a water-permeable thin film polymerized on a porous support membrane and, optionally, a mixture, including a surface coating material having a different chemical composition than the thin film, coated on the thin film. In one aspect, one or more layers of the composite membranes further comprise nanoparticles. This abstract is intended as a scanning tool for purposes of searching in the particular art and is not intended to be limiting of the present invention.

### CROSS-REFERENCE TO RELATED APPLICATIONS

This application claims the benefit of U.S. Application No. 60/974,411, filed Sep. 21, 2007, which is hereby incorporated herein by reference in its entirety.

### BACKGROUND

A breakthrough in the field of membrane separations was the development of thin film composite membranes, which are characterized by an ultra-thin “barrier” layer supported on a porous substrate. Among thin film composite membranes, polyamide thin film composite membranes have been widely commercialized for water purification applications such as seawater desalination, surface water treatment, and wastewater reclamation due to their excellent separation performance and energy efficiency.

In recent years, the water permeability of conventional polyamide thin film composite membranes has improved dramatically without an appreciable change in solute rejection. Polyamide thin film composite membranes are widely commercialized for use in RO separations such as seawater desalination, water treatment, and wastewater reclamation due to their excellent membrane selectivity. Despite this advantage, one concern with conventional polyamide (PA) thin film composite (TFC) membranes in these applications is their loss of performance due to biofouling, which typically cannot be eliminated by feed water pretreatment, membrane surface modification, module and process optimization, or chemical cleaning. S. Kang et al., Direct Observation of Biofouling in Cross-flow Microfiltration: Mechanisms of Deposition and Release, Journal of Membrane Science 244 (2004) 151. A small amount of microbial deposition can result in extensive biofilm growth, which in RO processes leads to higher operating pressures and more frequent chemical cleanings. This in turn can shorten membrane life and compromise product water quality.

Conventional thin film composite (TFC) polyamide membranes have been used for desalination and water purification, but the application of hydraulic pressures to these membranes is known to cause a reduction of membrane permeability, probably due to compaction. When a polymeric membrane is put under pressure, the polymers are slightly reorganized and the structure is changed, resulting in a lowered porosity, increased membrane resistance, and eventually lowered flux. As the applied pressure is increases, so does the extent of physical compaction. Generally the flux decline of TFC membranes due to physical compaction in brackish water desalination is around 15-25% and in sea water desalination it is as high as 25-50%. The compaction problem in polyamide thin film composite (TFC) reverse osmosis (RO) membranes probably arises mainly due to compaction of the thick porous polysulfone support layer.

Therefore, there remains a need for methods and compositions that overcome these deficiencies and that effectively provide for membranes having improved fouling resistance, anti-microbial (biocidal) activity, water permeability, and salt rejection.

### SUMMARY

As embodied and broadly described herein, in one aspect a nanocomposite membrane can include a film having a polymer matrix with nanoparticles disposed within the polymer matrix, wherein the film is substantially permeable to water and substantially impermeable to impurities. In a further aspect, the membrane can further have a hydrophilic layer.

Also disclosed is a composite membrane for removing contaminants from water, comprising a porous support membrane; a water-permeable thin film polymerized on the porous support membrane by interfacial polymerization; and a mixture, including a surface coating material having a different chemical composition than the thin film and nanoparticles, coated on the thin film to form a composite membrane, wherein the presence of the nanoparticles in the mixture alters surface characteristics of the composite membrane related to fouling.

Also disclosed is a composite membrane for removing contaminants from water, comprising a porous support membrane cast in the presence of nanoparticles; and a water-permeable thin film polymerized on the porous support membrane by interfacial polymerization in the presence of nanoparticles to form a composite membrane.

Also disclosed is a composite membrane for removing contaminants from water, comprising a porous support membrane; a water-permeable thin film polymerized on the porous support membrane by interfacial polymerization to form a composite membrane, wherein the porous membrane is cast, and/or the thin film is formed by interfacial polymerization, in the presence of nanoparticles, and wherein the porous membrane or thin film nanoparticles have been modified to alter chemical composition of the surface of the nanoparticles.

Also disclosed is a method for preparing a composite membrane for removing contaminants from water, the method comprising interfacially polymerizing a polymer matrix film onto a porous support membrane; and coating a mixture, including a surface coating material having a different chemical composition than the thin film and nanoparticles, on the thin film to form a composite membrane.

Also disclosed is a method for preparing a composite membrane for removing contaminants from water, the method comprising interfacially polymerizing a polymer matrix film in the presence of nanoparticles onto a porous support membrane cast in the presence of nanoparticles, thereby forming a composite membrane.

Also disclosed is a method for preparing a composite membrane for removing contaminants from water, the method comprising interfacially polymerizing a water-permeable thin film onto a porous support membrane, thereby forming a composite membrane, wherein the porous membrane is cast, and/or the thin film is formed by interfacial polymerization, in the presence of nanoparticles, and wherein the porous membrane or thin film nanoparticles have been modified to alter chemical composition of the surface of the nanoparticles.

Also disclosed are the products of the disclosed methods.

In a further aspect, a nanocomposite membrane can include a film having an interfacially-polymerized polyamide matrix and zeolite nanoparticles dispersed within the polymer matrix, wherein the film is substantially permeable to water and substantially impermeable to sodium ions. In a further aspect, the membrane can further include a hydrophilic layer.

In a further aspect, a method for preparing a nanocomposite membrane can include providing a polar mixture comprising a polar liquid and a first monomer that is miscible with the polar liquid; providing an apolar mixture comprising an apolar liquid substantially immiscible with the polar liquid and a second monomer that is miscible with the apolar liquid; providing nanoparticles in either the polar mixture or the apolar mixture, wherein the nanoparticles can be miscible with the apolar liquid and miscible with the polar liquid; and contacting the polar mixture and the apolar mixture at a temperature sufficient to react the first monomer with the second monomer, thereby interfacially-polymerizing the first monomer and the second monomer to form a polymer matrix, wherein the nanoparticles are disposed within the polymer matrix.

In a further aspect, a method for preparing a nanocomposite membrane can include soaking a polysulfone membrane in an aqueous solution comprising m-phenylenediamine, and pouring onto the soaked polysulfone membrane a hexane solution comprising trimesoyl chloride and zeolite nanoparticles suspended in the hexane solution, thereby interfacially-polymerizing the m-phenylenediamine and the trimesoyl chloride to form a film, wherein the zeolite nanoparticles are dispersed within the film.

In a further aspect, a nanocomposite membrane can include a film having a face, wherein the film can have a polymer matrix; a hydrophilic layer proximate to the face; and nanoparticles disposed within the hydrophilic layer, wherein the film is substantially permeable to water and substantially impermeable to impurities.

In a further aspect, a method for preparing a nanocomposite membrane can include providing an aqueous mixture comprising water, a hydrophilic polymer, nanoparticles, and optionally, at least one crosslinking agent; providing a polymer film that is substantially permeable to water and substantially impermeable to impurities; contacting the mixture and the film, thereby forming a hydrophilic nanocomposite layer in contact with the film; and evaporating at least a portion of the water from the hydrophilic nanocomposite layer.

In a further aspect, products can be produced by the methods disclosed.

In a further aspect, methods for purifying water can include providing the nanocomposite membranes or the products of the disclosed methods, wherein the membrane has a first face and a second face; contacting the first face of the membrane with a first solution of a first volume having a first salt concentration at a first pressure; and contacting the second face of the membrane with a second solution of a second volume having a second salt concentration at a second pressure; wherein the first solution is in fluid communication with the second solution through the membrane, wherein the first salt concentration can be higher than the second salt concentration, thereby creating an osmotic pressure across the membrane, and wherein the first pressure can be sufficiently higher than the second pressure to overcome the osmotic pressure, thereby increasing the second volume and decreasing the first volume.

In a further aspect, methods for concentrating an impurity can include providing the nanocomposite membranes wherein the membrane has a first face and a second face; contacting the first face of the membrane with a first mixture of a first volume having a first impurity concentration at a first pressure; contacting the second face of the membrane with a second mixture of a second volume having a second impurity concentration at a second pressure; and collecting the impurity, wherein the first mixture can be in fluid communication with the second solution through the membrane, wherein the first impurity concentration can be higher than the second impurity concentration, thereby creating an osmotic pressure across the membrane, and wherein the first pressure can be sufficiently higher than the second pressure to overcome the osmotic pressure, thereby increasing the second volume and decreasing the first volume.

In another aspect, nanocomposite membranes can be formed by dispersing functional nanoparticles within a porous polymer matrix, such as a polysulfone support membrane and subsequently casting over the top of the porous polymer matrix or support membrane a thin film having of a dense polymer such as a polyamide or nanoparticle-dense polymer nanocomposite. The resulting membrane can function as a nanofiltration (NF) or reverse osmosis (RO) membrane and be applied to desalination and water purification. One substantial advantage of the adding nanoparticles to the support membrane is the improved mechanical strength of the final membrane, which tends to resist physical compaction, a.k.a., internal or irreversible fouling, when subjected to the high mechanical pressures common to RO/NF processes.

A micro- or nanocomposite membrane can include a polymeric support having a body, a surface, and pores disposed within the surface, micro- or nanoparticles disposed within the body of the polymeric support and a polymeric thin film disposed at the surface. The membrane can then be substantially permeable to water and substantially impermeable to impurities. The polymeric thin film can be adhered to the surface, the polymeric thin film can be bonded to the surface, and the polymeric thin film can be adjacent to, in contact with or laminated to the surface. The polymeric support can be disposed upon a woven or non-woven textile laminated to the surface.

The membrane can have enhanced compaction resistance compared to an equivalent membrane without micro- or nanoparticles in the support. The membrane compaction resistance (i.e., percent loss of flux as a function of time) can be 5%, 10%, 15%, 20%, 25%, 30%, 40%, 50%, 60%, 70%, or 75% of that of a comparable membrane, in which the micro- or nanoparticles are substantially absent from the body of the support. The membrane can have enhanced anti-fouling and/or increased hydrophilicity and/or increased surface hydrophilicity compared to an equivalent membrane without micro- or nanoparticles in the support.

The membrane can have an average thickness of from about 10 μm to about 1000 μm, from about 50 μm to about 100 μm, from about 50 μm to about 100 μm, from about 50 μm to about 100 μm, from about 50 μm to about 100 μm, or from about 50 μm to about 100 μm. The membrane can have a flux of from about 0.01 to about 1, from about 0.01 to about 0.5, from about 0.02 to about 0.5, or from about 0.03 to about 0.3 gallons per square foot of membrane per day per psi of applied pressure. The membrane can have a pure water equilibrium contact angle of less than about 70°, less than about 75°, less than about 80°, or less than about 85°. The membrane can have a zeta potential of at least as negative as about −5 mV, about −10 mV, about −15 mV, or about −20 mV and/or an RMS surface roughness of less than about 60 nm, less than about 65 nm, less than about 70 nm, or less than about 75 nm, or less than about 80 nm.

The membrane support can be a cross-linked polymer such as polysulfone or polyethersulfone and/or be non-ceramic or non-metallic. The membrane support can have an average thickness of from about 10 μm to about 1000 μm, from about 50 μm to about 100 μm, from about 50 μm to about 100 μm, from about 50 μm to about 100 μm, from about 50 μm to about 100 μm, or from about 50 μm to about 100 μm. The membrane support can have an average pore size of from about 1 nm to about 1000 nm, from about 10 nm to about 1000 nm, from about 50 nm to about 500 nm, from about 100 nm to about 400 nm, or from about 200 nm to about 300 nm.

The micro- or nanoparticles can be dispersed, embedded within and/or encapsulated within the body. At least a portion, or substantially all, of the micro- or nanoparticles can penetrate the surface and/or the thin film and/or be present in the pores and/or in the body and/or the pores. Less than about 30%, less than about 20%, less than about 10%, or less than about 5% of the micro- or nanoparticles can be present in the pores. The micro- or nanoparticles can be preferential flow paths and/or are inorganic and/or hydrophilic micro- or nanoparticles. The micro- or nanoparticles can have an average hydrodynamic diameter of from about 10 nm to about 1000 nm, from about 50 nm to about 500 nm, from about 50 nm to about 200 nm, or from about 200 nm to about 300 nm.

The micro- or nanoparticles can be at least one of gold, silver, copper, zinc, titanium, silicon, iron, aluminum, zirconium, indium, tin, magnesium, or calcium or an alloy thereof or an oxide thereof or a mixture thereof and/or Si3N4, SiC, BN, B4C, or TiC or an alloy thereof or a mixture thereof. The micro- or nanoparticles can be graphite, carbon glass, a carbon cluster of at least C2, buckminsterfullerene, a higher fullerene, a carbon nanotube, a carbon micro- or nanoparticle, or a mixture thereof. The micro- or nanoparticles can be a dendrimer such as poly(vinyl alcohol)-divinylsulfone or N-isopropyl acrylamide-acrylic acid or a mixture thereof.

The micro- or nanoparticles can be polymeric micro- or nanofibers and/or a mesoporous molecular sieve including an oxide of aluminum or silicon, an aluminosilicate, or an aluminophopsphate or a mixture thereof or a zeolite such as Zeolite A.

The zeolite can have a negatively charged functionality which binds silver and/or other ions.

The micro- or nanoparticles can be an interconnected porous material having a pore size of about 2 Å to an about 20 Å porous material or of about 3 Å to an about 12 Å.

The film can further include nanoparticles, for example, the film can be an interfacially-polymerized polyamide matrix with such particles. The membrane can have an average thickness of from about 1 nm to about 1000 nm, from about 10 nm to about 1000 nm, from about 10 nm to about 500 nm, from about 25 nm to about 500 nm, from about 50 nm to about 250 nm, from about 50 nm to about 500 nm, or from about 100 nm to about 200 nm. The film can have an average thickness approximately equal to the average hydrodynamic diameter of the nanoparticles and/or an average thickness greater than or less than the average hydrodynamic diameter of the nanoparticles.

The thin film can have pores disposed within the surface having an average pore size of from about 1 Å to about 10 Å, from about 1 Å to about 9 Å, from about 1 Å to about 8 Å, from about 1 Å to about 7 Å, from about 1 Å to about 6 Å, from about 1 Å to about 5 Å, from about 1 Å to about 4 Å, from about 1 Å to about 3 Å, from about 2 Å to about 10 Å, from about 2 Å to about 9 Å, from about 2 Å to about 8 Å, from about 2 Å to about 7 Å, from about 2 Å to about 6 Å, from about 2 Å to about 5 Å, from about 2 Å to about 4 Å, from about 2 Å to about 3 Å, from about 3 Å to about 7 Å, from about 3 Å to about 9 Å, from about 3 Å to about 8 Å, from about 3 Å to about 7 Å, from about 3 Å to about 6 Å, from about 3 Å to about 5 Å, from about 3 Å to about 4 Å, from about 4 Å to about 10 Å, from about 4 Å to about 9 Å, from about 4 Å to about 8 Å, from about 4 Å to about 7 Å, from about 4 Å to about 6 Å, or from about 4 Å to about 5 Å. The thin film can have an average pore size capable of substantially including water and substantially excluding sodium ions.

The thin film can be a polyamide, a polyether, a polyether-urea, a polyester, or a polyimide or a copolymer thereof or a mixture thereof. The thin film can be a polyamide such as residues of a phthaloyl halide, a trimesyl halide, or a mixture thereof and/or residues of diaminobenzene, triaminobenzene, or piperazine or a mixture thereof. The thin film can be an aromatic polyamide such as residues of a trimesoyl halide and residues of a diaminobenzene.

The impurities can be monovalent and/or divalent ions such as sodium, potassium, magnesium or a calcium ion and/or a silicate, an organic acid, or a nonionized dissolved solid with a molecular weight of greater than about 200 Daltons or a mixture thereof.

A method for preparing a micro- or nanocomposite membrane can include providing a first polymer, mixing micro- or nanoparticles with the first polymer, forming a support membrane having the micro- or nanoparticles and the first polymer, wherein the support has a body, a surface, and pores disposed within the surface and coating at least a portion of the surface of the support membrane with a polymeric thin film. The forming step can include solution casting, for example, from N-methylpyrrolidone. The forming step can be accomplished by in-situ polymerization. In one aspect, the forming step can be accomplished by interfacial polymerization and the mixing step can occur simultaneously with the forming step.

The support membrane can be a polysulfone or polyethersulfone webbing.

The method can include adding nanoparticles to a polymeric thin film. The coating step can be accomplished by interfacial polymerization and the adding step can occur simultaneously with the coating step.

The coating step can be accomplished by solution casting and/or by in-situ polymerization and/or by interfacial polymerization. The method polymerization can not substantially occur at the surface of the body in contact with at least one micro- or nanoparticle.

The coating step can include providing a polar mixture having a polar liquid and a first monomer that is miscible with the polar liquid. An apolar mixture can be provided having an apolar liquid substantially immiscible with the polar liquid and a second monomer that is miscible with the apolar liquid. Nanoparticles can be provided in either the polar mixture or the apolar mixture and be miscible with the apolar and polar liquids. The polar and apolar mixtures can be contacted at a temperature sufficient to react the first monomer with the second monomer, thereby interfacially-polymerizing the first monomer and the second monomer to form a polymer matrix in which the nanoparticles are disposed, dispersed and/or encapsulated within the polymer matrix.

The nanoparticles can be provided as part of the apolar mixture and/or dispersed within the apolar liquid. The polar mixture can be adsorbed upon a substantially insoluble support membrane prior to the contacting step.

The first monomer can be a polynucleophilic monomer such as a diaminobenzene or m-phenylenediamine. The first monomer can be a piperazine or a piperazine derivative. The second monomer can be a polyelectrophilic monomer such as a trimesoyl halide or a trimesoyl chloride.

The polar liquid can be water. The apolar liquid can be a linear hydrocarbon, a branched hydrocarbon, a cyclic hydrocarbon, naptha, heavy naptha, paraffin, or isoparaffin or a mixture thereof. The apolar liquid can be hexane.

The micro- or nanoparticles can be an interconnected porous material, e.g. about 2 Å to about 20 Å or about 3 Å to an about 12 Å pore size. The micro- or nanoparticles can be gold, silver, copper, zinc, titanium, silicon, iron, aluminum, zirconium, indium, tin, magnesium, or calcium or an alloy thereof or an oxide thereof or a mixture thereof. The micro- or nanoparticles can be SiN₄, SiC, BN, B4C, or TiC or an alloy thereof or a mixture thereof. The micro- or nanoparticles can be graphite, carbon glass, a carbon cluster of at least Cz, buckminsterfullerene, a higher fullerene, a carbon nanotube, a carbon micro- or nanoparticle, or a mixture thereof.

The micro- or nanoparticles can be a dendrimer such as poly(vinyl alcohol)-divinylsulfone or N-isopropyl acrylamide-acrylic acid or a mixture thereof.

The micro- or nanoparticles be polymeric fibers and/or a mesoporous molecular sieve having an oxide of aluminum or silicon, an aluminosilicate, or an aluminophopsphate or a mixture thereof. The micro- or nanoparticles can be a zeolite such as Zeolite A. The micro- or nanoparticles can have a negatively charged functionality, and/or be contacted with a silver salt, thereby forming a silver-impregnated micro- or nanocomposite membrane. The step of contacting the micro- or nanoparticles with a silver salt can be performed prior to the providing micro- or nanoparticles step.

A method of making a water permeable membrane can include adding nanoparticles to a mixture with one or more monomers, the nanoparticles and the one or more monomers in the mixture interacting when polymerized to form a hydrophilic polymer matrix in which the nanoparticles are dispersed and polymerizing the mixture on a porous support to form a film composite membrane. Each of the one or more monomers can be miscible in a liquid specific for each said monomer in the mixture and the nanoparticles can be selected to be dispersible in at least one of the specific liquids.

Adding the nanoparticles to the mixture can include providing a polar mixture including a polar liquid and a first monomer that is miscible with the polar liquid, providing nanoparticles dispersible in the polar liquid and providing an apolar mixture comprising an apolar liquid substantially immiscible with the polar liquid and a second monomer that is miscible with the apolar liquid. The polymerizing can include contacting the polar mixture and the apolar mixture at a temperature sufficient to react the first monomer with the second monomer. Adding the nanoparticles to the mixture can also include providing a polar mixture comprising a polar liquid and a first monomer that is miscible with the polar liquid, providing an apolar mixture including an apolar liquid substantially immiscible with the polar liquid and a second monomer miscible with the apolar liquid and providing nanoparticles dispersible in the apolar liquid. Polymerizing can include contacting the polar mixture and the apolar mixture at a temperature sufficient to react the first monomer with the second monomer.

The nanoparticles and the mixture can be selected so that the membrane is substantially more permeable to water as a result of the nanoparticles therein.

The membrane can have a pure water contact angle of less than 90° has and/or a pure water flux of at least 0.02 gallons per square foot of membrane per day per pound per square inch of applied pressure.

The nanoparticles and the mixture can be selected so that the nanoparticles form preferred paths for water permeation through the membrane.

The nanoparticles and the mixture can be selected so that the membrane is relatively impermeable to impurities in water permeating therethrough.

The nanoparticles can be porous. The nanoparticles can be selected to have a multi-dimensional interconnected open framework having a pore size in the range of about 3 to about 30 Å. The nanoparticles can function as molecular sieves. The nanoparticles can be a zeolite such as LTA.

The nanoparticles can be a dendrimer or can include silver.

The nanoparticles can be in the range of about 50 nm to about 500 nm or about 50 to about 200 nm.

The polymerization can be accomplished by an interfacial reaction and the polymer matrix can be a polyamide. The mixture includes m-phenylenediamine and trimesoyl chloride.

The nanoparticles can be dispersed in the polymer matrix function as molecular sieves permeable to molecules having a selected maximum size.

The nanoparticles and the mixture can be selected so that the membrane is more hydrophilic as a result of the nanoparticles therein.

The nanoparticles and the mixture can be selected so that the membrane has a greater negative surface charge as a result of the nanoparticles therein.

The nanoparticles can be modified to alter a characteristic of the film composite membrane, for example by ion exchange with a metallic species, such as silver ions to add a biocidal characteristic to the film composite membrane.

The mixture can be polymerized to form a film on the porous support having a thickness on the order of about the size of the nanoparticles.

A hydrophilic layer can be formed on the membrane to resist fouling.

The hydrophilic layer can be formed on the membrane by dispersing nanoparticles in the hydrophilic layer which increase the permeability of the hydrophilic layer. The nanoparticles and the mixture can be selected so that the membrane with the hydrophilic layer is at least as permeable as the membrane without the nanoparticles.

A water permeable composite membrane can include a hydrophilic polymer matrix film formed by polymerization in the presence of nanoparticles so that the nanoparticles are dispersed in the polymer matrix film and a porous support on which the film is formed.

The nanoparticles can be selected to be dispersible in a liquid present during formation by polymerization.

The nanoparticles can be selected so that the membrane is substantially more permeable to water as a result of the nanoparticles dispersed therein.

The film can have a pure water contact angle of less than 90°.

The nanoparticles can form preferred paths for water permeation through the membrane.

The membrane can be relatively impermeable to impurities in water permeating there through.

The nanoparticles can be porous and/or have a multidimensional interconnected open framework having a pore size in the range of about 3 to about 30 Å and/or be molecular sieves.

The nanoparticles can be a zeolite, such as LTA, or be a dendrimer or include silver. The nanoparticles can be in the range of about 50 nm to about 500 nm or in the range of about 50 to about 200 nm.

The membrane can be polymerized by an interfacial reaction and the film can be a polyamide formed by polymerizing m-phenylenediamine and trimesoyl chloride.

The nanoparticles can function as molecular sieves permeable to molecules having a selected maximum size, be more hydrophilic as a result of the nanoparticles therein or have a greater negative surface charge as a result of the nanoparticles therein.

The nanoparticles can be modified to alter a characteristic of the membrane by for example ion exchange with a metallic species such as silver ions.

The film can have a thickness on the order of about the size of the nanoparticles.

A hydrophilic layer can be applied on the membrane to resist fouling and can include nanoparticles dispersed in the hydrophilic layer to increase the permeability of the hydrophilic layer. The membrane with the hydrophilic layer can be at least as permeable as the membrane without the nanoparticles.

A method of water purification can include applying pressure to a water solution including at least one solute. The solution can be positioned on one side of a polymer matrix membrane, with nanoparticles dispersed therein, so that the membrane is substantially more permeable to water as a result of the nanoparticles therein. The purified water can be collected on another side of the membrane. A hydrophilic layer can be added to the membrane to resist fouling by the solute and include nanoparticles to increase permeability of the hydrophilic layer.

The nanoparticles can be molecular sieves, relatively permeable to pure water and not relatively permeable to impurities in the solution, such as a zeolite and in particular can be LTA. The polymer matrix membrane can be more permeable, hydrophilic and/or have a greater negative surface change as a result of the nanoparticles dispersed in the matrix.

The nanoparticles can be modified by ion exchange with a silver ion.

A method of water purification can include applying pressure to a water solution having a solute, the solution positioned on one side of a polymer matrix membrane having a hydrophilic layer with nanoparticles dispersed in the layer so that the layer is substantially more permeable to water as a result of the nanoparticles therein, and collecting purified water on another side of the membrane. The nanoparticles can be molecular sieves relatively permeable to pure water and not relatively permeable to impurities in the solution and/or a zeolite such as LTA and/or can be modified by ion exchange with a silver ion.

A method for preparing a nanocomposite membrane can include soaking a polysulfone membrane in an aqueous solution comprising m-phenylenediamine, and pouring onto the soaked polysulfone membrane a hexane solution comprising trimesoyl chloride and zeolite nanoparticles suspended in the hexane solution, thereby interfacially-polymerizing the m-phenylenediamine and the trimesoyl chloride to form a film, wherein the zeolite nanoparticles are dispersed within the film. The nanoparticles can be Zeolite A and can be been contacted with a silver salt.

The membrane products can be produced by the methods described above.

A method of water purification can include applying greater than about 250 psi of pressure to a water solution having at least one solute, the solution positioned on one side of a polymer matrix membrane with nanoparticles dispersed therein so that the membrane is substantially more permeable to water as a result of the nanoparticles therein; and collecting purified water on another side of the membrane, wherein the membrane exhibits less loss of flux per time than a comparable polymer matrix membrane lacking nanoparticles.

A composite membrane can include a polymer matrix film polymerized on a porous support, wherein the support has nanoparticles dispersed therein, and wherein the membrane exhibits greater compaction resistance than a comparable composite membrane lacking nanoparticles in the porous support.

A method of water purification can include applying greater than about 250 psi of pressure to a water solution having at least one solute, the solution positioned on one side of a composite membrane having a polymer matrix film polymerized on a porous support, wherein the support has nanoparticles dispersed therein; and collecting purified water on another side of the membrane, wherein the membrane exhibits less loss of flux per time than a comparable composite membrane lacking nanoparticles in the porous support.

A water permeable composite membrane can include a polymer matrix film; a porous support on which the film is formed by polymerization; and a cross-linked hydrophilic coating on the polymer matrix film with antimicrobial nanoparticles dispersed within, wherein the membrane exhibits greater fouling resistance than a comparable composite membrane lacking antimicrobial nanoparticles in the hydrophilic coating.

A method of preparing a water permeable composite membrane can include forming a porous support from a mixture of nanoparticles and a polymeric material; polymerizing a polymer matrix film onto the porous support, thereby forming a composite membrane; and coating a hydrophilic coating onto the polymer matrix film, the hydrophilic coating having antimicrobial nanoparticles dispersed within, wherein the membrane exhibits greater fouling resistance than a comparable composite membrane lacking antimicrobial nanoparticles in the hydrophilic coating.

A method of water purification can include applying pressure to a water solution having at least one solute, the solution positioned on one side of composite membrane having a polymer matrix film, a porous support on which the film is formed by polymerization, and a cross-linked hydrophilic coating on the polymer matrix film with antimicrobial nanoparticles dispersed within; and collecting purified water on another side of the membrane, wherein the membrane exhibits less flux decline (fouling) over time than a comparable composite membrane lacking antimicrobial nanoparticles in the hydrophilic coating.

A water permeable filtration membrane can include a porous support having nanoparticles dispersed therein, wherein the membrane exhibits greater fouling resistance than a comparable filtration membrane lacking nanoparticles in the polymer matrix film, and/or greater hydrophilicity than a comparable filtration membrane lacking nanoparticles in the polymer matrix film.

A method of preparing a water permeable filtration membrane can include dispersion casting a porous support from a mixture of nanoparticles and a polymeric material.

A method of water purification can include applying pressure to a water solution having at least one solute, the solution positioned on one side of a water permeable filtration membrane having nanoparticles dispersed therein; and collecting purified water on another side of the membrane.

A composite membrane can include a polymer matrix film formed from one or more monomers in the presence of surface-modified nanoparticles so that the nanoparticles are dispersed in the polymer matrix film; a porous support on which the film is formed by polymerization; and optionally, a cross-linked hydrophilic coating on the polymer matrix film, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film.

A method of preparing a water permeable composite membrane can include adding surface-modified nanoparticles to a mixture with one or more monomers, the nanoparticles and at least one of the monomers interacting when polymerized to form a hydrophilic polymer matrix in which the nanoparticles are dispersed; polymerizing the mixture on a porous support to form a composite membrane; and optionally, coating a hydrophilic coating onto the polymer matrix film, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film.

A method of water purification can include applying pressure to a water solution having at least one solute, the solution positioned on one side of a composite membrane having a polymer matrix film formed from two monomers in the presence of surface-modified nanoparticles so that the nanoparticles are dispersed in the polymer matrix film; a porous support on which the film is formed by polymerization, and, optionally, a cross-linked hydrophilic coating on the polymer matrix film; and collecting purified water on another side of the membrane, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film.

A composite membrane can include a polymer matrix film polymerized from one or more monomers upon a porous support, wherein the support has surface-modified nanoparticles dispersed therein, and, optionally, a cross-linked hydrophilic coating on the polymer matrix film, wherein the membrane exhibits greater delamination resistance than a comparable composite membrane lacking surface-modified nanoparticles in the porous support.

A method of preparing a water permeable composite membrane can include forming a porous support from a mixture of surface-modified nanoparticles and a polymeric material, and polymerizing one or more monomers to form a polymer matrix film onto the porous support, thereby forming a composite membrane; and optionally, coating a hydrophilic coating onto the polymer matrix film, wherein the membrane exhibits greater delamination resistance than a comparable composite membrane lacking surface-modified nanoparticles in the porous support.

A method of water purification can include applying pressure to a water solution having at least one solute, the solution positioned on one side of a composite membrane having a polymer matrix film polymerized from one or more monomers onto a porous support, wherein the support has surface-modified nanoparticles dispersed therein, and, optionally, a cross-linked hydrophilic coating on the polymer matrix film; and collecting purified water on another side of the membrane, wherein the membrane exhibits greater delamination resistance than a comparable composite membrane lacking surface-modified nanoparticles in the porous support.

A water permeable composite membrane can include a polymer matrix film formed in the presence of nanoparticles so that the nanoparticles are dispersed in the polymer matrix film; a porous support on which the film is formed by polymerization; and a cross-linked hydrophilic coating on the polymer matrix film with antimicrobial nanoparticles dispersed within, wherein the membrane exhibits less loss of flux per time than a comparable polymer matrix membrane lacking nanoparticles in the polymer matrix film, and wherein the membrane exhibits greater fouling resistance than a comparable composite membrane lacking antimicrobial nanoparticles in the hydrophilic coating.

A method of preparing a water permeable composite membrane can include adding nanoparticles to a mixture with one or more monomers, the nanoparticles and the monomers interacting when polymerized to form a polymer matrix film in which the nanoparticles are dispersed; polymerizing the monomers on a porous support to provide a polymer matrix film, thereby providing a composite membrane; and coating a hydrophilic coating onto the polymer matrix film, wherein the hydrophilic coating has antimicrobial nanoparticles dispersed within.

A method of water purification can include applying pressure to a water solution having at least one solute, the solution positioned on one side of composite membrane having a polymer matrix film with nanoparticles dispersed therein, a porous support on which the film is formed by polymerization, and a cross-linked hydrophilic coating on the polymer matrix film, wherein the hydrophilic coating has antimicrobial nanoparticles dispersed within; and collecting purified water on another side of the membrane.

A water permeable composite membrane can include a porous support on which a polymer matrix film is formed by polymerization, wherein the support has nanoparticles dispersed therein; and a cross-linked hydrophilic coating on the polymer matrix film with antimicrobial nanoparticles dispersed within, wherein the membrane exhibits greater compaction resistance than a comparable composite membrane lacking nanoparticles in the porous support, and wherein the membrane exhibits greater fouling resistance than a comparable composite membrane lacking antimicrobial nanoparticles in the hydrophilic coating.

A method of preparing a water permeable composite membrane can include forming a porous support from a mixture of nanoparticles and a polymeric material, polymerizing one or more monomers to provide a polymer matrix film on the porous support, thereby providing a composite membrane; and coating a hydrophilic coating onto the polymer matrix film, wherein the hydrophilic coating has antimicrobial nanoparticles dispersed within.

A method of water purification can include applying pressure to a water solution having at least one solute, the solution positioned on one side of composite membrane having a polymer matrix film polymerized on a porous support with nanoparticles dispersed within, and a cross-linked hydrophilic coating on the polymer matrix film, wherein the hydrophilic coating has antimicrobial nanoparticles dispersed within; and collecting purified water on another side of the membrane.

A water permeable composite membrane can include a polymer matrix film formed in the presence of nanoparticles so that the nanoparticles are dispersed in the polymer matrix film; a porous support on which the film is formed by polymerization, wherein the support has nanoparticles dispersed therein; and a cross-linked hydrophilic coating on the polymer matrix film, wherein the membrane exhibits less loss of flux per time than a comparable polymer matrix membrane lacking nanoparticles in the polymer matrix film, and wherein the membrane exhibits greater compaction resistance than a comparable composite membrane lacking nanoparticles in the porous support.

A method of preparing a water permeable composite membrane can include forming a porous support from a mixture of nanoparticles and a polymeric material, adding nanoparticles to a mixture with one or more monomers, the nanoparticles and the monomers interacting when polymerized to form a polymer matrix film in which the nanoparticles are dispersed; polymerizing the monomers to provide a polymer matrix film on the porous support, thereby providing a composite membrane; and coating a hydrophilic coating onto the polymer matrix film.

A method of water purification can include applying pressure to a water solution having at least one solute, the solution positioned on one side of composite membrane having a polymer matrix film with nanoparticles dispersed therein, a porous support with nanoparticles dispersed within on which the film is formed by polymerization, and a cross-linked hydrophilic coating on the polymer matrix film; and collecting purified water on another side of the membrane.

A water permeable composite membrane can include a polymer matrix film formed in the presence of nanoparticles so that the nanoparticles are dispersed in the polymer matrix film; a porous support on which the film is formed by polymerization, wherein the support has nanoparticles dispersed therein; and a cross-linked hydrophilic coating on the polymer matrix film with antimicrobial, enhanced permeability, and/or hydrophilic nanoparticles dispersed within, wherein the membrane exhibits less loss of flux per time than a comparable polymer matrix membrane lacking nanoparticles in the polymer matrix film, and/or wherein the membrane exhibits greater compaction resistance than a comparable composite membrane lacking nanoparticles in the porous support, and/or wherein the membrane exhibits greater fouling resistance than a comparable composite membrane lacking antimicrobial nanoparticles in the hydrophilic coating.

A method of preparing a water permeable composite membrane can include forming a porous support from a mixture of nanoparticles and a polymeric material, adding nanoparticles to a mixture with one or more monomers, the nanoparticles and the monomers interacting when polymerized to form a polymer matrix film in which the nanoparticles are dispersed; polymerizing the monomers to provide a polymer matrix film on the porous support, thereby providing a composite membrane; and coating a hydrophilic coating onto the polymer matrix film, wherein the hydrophilic coating has antimicrobial, enhanced permeability, and/or hydrophilic nanoparticles dispersed within.

A method of water purification can include applying pressure to a water solution having at least one solute, the solution positioned on one side of composite membrane having a polymer matrix film with nanoparticles dispersed therein, a porous support with nanoparticles dispersed within on which the film is formed by polymerization, and a cross-linked hydrophilic coating on the polymer matrix film, wherein the hydrophilic coating has antimicrobial, enhanced permeability, and/or hydrophilic nanoparticles dispersed within; and collecting purified water on another side of the membrane.

Unless otherwise expressly stated, it is in no way intended that any method or aspect set forth herein be construed as requiring that its steps be performed in a specific order. Accordingly, where a disclosed method or system does not specifically state that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Additional advantages are set forth in part in the description which follows, and in part understood from the description by a person having ordinary skill in this art, and/or can be learned by practice of the methods and apparatus disclosed herein. The advantages can also be realized and attained by means of the elements and combinations particularly pointed out in the appended claims. It is to be understood that both the foregoing general description and the following detailed description are exemplary and explanatory only and are not restrictive of the invention, the scope of which can be determined from the claims attached hereto.

### BRIEF DESCRIPTION OF THE FIGURES

The accompanying figures are incorporated in and constitute a part of this specification.

FIG. 1 shows SEM images of as synthesized Zeolite A nanoparticles.

FIG. 2 shows representative SEM images of synthesized pure polyamide and zeolite-polyamide nanocomposite membranes. A hand cast thin film composite (TFC) polyamide membrane is shown in (a) and hand cast thin film nanocomposite (TFN) membranes synthesized with increasing concentrations zeolite nanoparticles are shown in (b) through (f).

FIG. 3 shows representative TEM images of hand cast pure polyamide TFC at magnifications of (a) 48 k× and (b) 100 k× and hand cast and zeolite-polyamide TFN membranes at magnifications of (c) 48 k× and (d) 100 k×.

FIG. 4 is a schematic of a cross flow filtration system used in the testing of support membranes with nanoparticles.

FIG. 5 is an illustration of a Zeolite A (i.e., LTA) crystal structure from an image on nanoscape.de.

FIG. 6 is a graph of flux vs. time at 250 psi and 10 mM NaCl for the NF90 and NF270 membranes.

FIG. 7 is a graph of resistance vs. time for 250 psi and 10 mM NaCl for the NF90 and NF270 membranes.

FIGS. 8a and 8b are SEM images of uncompacted and compacted NF90 membranes respectively.

FIGS. 9a and 9b are SEM images of uncompacted and compacted NF270 membranes, respectively, at 250 psi compaction pressure.

FIGS. 10a and 10b are flux vs. time graphs at 250 psi and 500 psi, respectively, for all nanocomposite and pure polysulfone membranes.

FIGS. 11a and 11b are graphs of membrane resistance vs. time at 250 psi and 500 psi, respectively.

FIGS. 12a, 12b and 12c are SEM images of a thin film composite (TFC) membrane after compaction at 250 psi, 500 psi and uncompacted, respectively.

FIGS. 13a, 13b and 13c are SEM images of ST201-TFC membrane after compaction at 250 psi, 500 psi and uncompacted, respectively.

FIGS. 14a, 14b and 14c are SEM images of LTA-TFC membrane after compaction at 250 psi, 500 psi and uncompacted, respectively.

FIGS. 15a, 15b and 15c are SEM images of an M1040 membrane after compaction at 250 psi, 500 psi and uncompacted, respectively.

FIGS. 16a, 16b and 16c are SEM images of ST50-TFC membrane after compaction at 250 psi, 500 psi and uncompacted, respectively.

FIGS. 17a, 17b and 17c are SEM images of ST-ZL-TFC membrane after compaction at 250 psi, 500 psi and uncompacted, respectively.

FIGS. 18a, 18b and 13c are SEM images of OMLTA-TFC membrane after compaction at 250 psi, 500 psi and uncompacted, respectively.

FIG. 19 shows two graphs illustrating the properties and performance of thin film nanocomposite reverse osmosis membranes.

FIG. 20 shows SEM images and selected physicochemical properties, respectively, of pure and nanocomposite UF membranes. Also shown at the bottom of the table are properties of thin film composite RO membranes formed over plain and nanocomposite UF membranes.

FIG. 21 shows a model of example Zeolite A (LTA, left) and illustrates the multi-dimensional interconnected open framework of certain zeolite structures (right). The inorganic framework is shown in stick form; the interconnected pore structure is shown in solid gray.

FIG. 22 is a schematic illustration of a cross-sectional view of a conventional composite membrane, both with and without a hydrophilic layer.

FIG. 23 shows intrinsic hydraulic resistances for four different RO membranes tested at 500 psi with a 585 ppm NaCl feed solution at unadjusted pH of ˜5.8.

FIG. 24 is a schematic illustration of a cross-sectional view of a thin layer nanocomposite membrane with nanoparticles dispersed in the polymer matrix layer, both with and without a hydrophilic layer, for low flux loss high-pressure reverse osmosis membrane filtration.

FIG. 25 is a schematic illustration of a cross-sectional view of a thin film composite membrane with nanoparticles dispersed in the porous support layer for use in compaction resistant reverse osmosis membrane filtration, both with and without a hydrophilic layer.

FIG. 26 is a schematic illustration of a cross-sectional view of a thin film composite membrane with nanoparticles dispersed in the hydrophilic coating for hydrophilic and antimicrobial nanocomposite coating films.

FIG. 27 is a schematic illustration of a cross-sectional view of a filtration membrane with nanoparticles dispersed in the porous support layer for use in hydrophilic and antimicrobial filtration membranes.

FIG. 28 is a schematic illustration of a cross-sectional view of a thin film nanocomposite membrane with surface modified nanoparticles.

FIG. 29 is a schematic illustration of a cross-sectional view of a nanocomposite reverse osmosis membrane with surface modified nanoparticles.

FIG. 30 is a schematic illustration of a cross-sectional view of a nanocomposite membrane with nanoparticles dispersed in the polymer matrix film and in the hydrophilic coating.

FIG. 31 is a schematic illustration of a cross-sectional view of a nanocomposite membrane with nanoparticles dispersed in the porous support and in the hydrophilic coating.

FIG. 32 is a schematic illustration of a cross-sectional view of a nanocomposite membrane with nanoparticles dispersed in the polymer matrix film and in the porous support.

FIG. 33 is a schematic illustration of a cross-sectional view of a nanocomposite membrane with nanoparticles dispersed in the porous support, polymer matrix film, and hydrophilic coating.

FIG. 34 shows the X-ray diffraction (XRD) patterns for the crystal structure of synthesized ZA nanoparticles.

### DETAILED DESCRIPTION

The present invention can be understood more readily by reference to the following detailed description of aspects of the invention and the Examples included therein and to the Figures and their previous and following description.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### A. Reverse Osmosis and Nanofiltration Membranes

Among particularly useful membranes for reverse osmosis and nanofiltration applications are those in which the discriminating layer is a polyamide.

Composite polyamide membranes are typically prepared by coating a porous support with a polyfunctional amine monomer, most commonly coated from an aqueous solution. Although water is a preferred solvent, non-aqueous solvents can be utilized, such as acetonitrile and dimethylformamide (DMF). A polyfunctional acyl halide monomer (also referred to as acid halide) is subsequently coated on the support, typically from an organic solution. The amine solution is typically coated first on the porous support followed by the acyl halide solution. Although one or both of the polyfunctional amine and acyl halide can be applied to the porous support from a solution, they can alternatively be applied by other means such as by vapor deposition, or heat.

### B. Nanocomposite Membranes

In one aspect, the disclosed membranes can be considered to be a new class of filtration materials, for example, desalination membrane materials. In particular, these membranes can be inorganic-organic thin film nanocomposite membranes, which can result from the dispersion of inorganic nanoparticles such as zeolite or metal oxide nanoparticles in a starting monomer solution. These membranes can take advantage of inherently advantageous properties of organic membranes (such as flexibility, high packing density in spiral wound elements, ease of manufacture, and good permeability and selectivity) with those of inorganic nanoparticles (such as high surface charge density, ion-exchange capacity, hydrophilicity, and biocidal capability). These inorganic-organic nanocomposite membranes can be prepared, for example, by an interfacial polymerization reaction, as is used in forming pure polyamide thin film composite membranes. These membranes can be used in conjunction with any of a large number of available nanomaterials that offer a wide range of possible particle sizes, hydrophilicity/hydrophobicity, pore sizes, porosity, interfacial reactivity, and chemical compositions.

One advantage of the disclosed thin film nanocomposite membranes can involve independent selection and modification of nanoparticles to optimize further the selectivity, and/or other characteristics, of the membrane. As a result, the synthesized membrane structure can include inorganic nanoparticles embedded within a semi-permeable polymer film. The presence of nanoparticles, for example inorganic nanoparticles, can modify the membrane structure formed during interfacial polymerization and alter the macroscopic surface properties (e.g., surface charge, hydrophilicity, porosity, thickness, and roughness) in a favorable manner, which can lead to improved selectivity and/or other properties.

Another advantage of thin film nanocomposite membranes can involve the potential to impart active fouling resistance or passive fouling resistance or both types of fouling resistance to the formed film. Passive fouling resistance, sometimes referred to as “passivation,” describes modification of a surface of a membrane to reduce surface reactivity and promote hydrophilicity. Passive fouling resistance can prevent unwanted deposition of dissolved, colloidal, or microbial matter on the membrane surface, which tends to foul the membrane and negatively influence flux and rejection. Active fouling resistance can involve the modification of a surface of a membrane layer to promote a selective, beneficial reactivity between the surface and a dissolved, colloidal, or microbial constituent. An example is the modification of nanoparticles to possess biocidal properties, and subsequently, embedding the nanoparticles in a polyamide film to produce a reverse osmosis or nanofiltration membrane with inherent antimicrobial properties.

The disclosed “thin film nanocomposite” membranes can have improved water permeability, solute rejection, and fouling resistance over conventional polyamide thin film composite membranes. Development of more efficient, more selective, and antimicrobial desalination membranes can revolutionize water and wastewater treatment practice. An additional advantage of the nanocomposite approach is that nanoparticles can be selected and/or modified to produce practically any desired membrane surface properties. Therefore, the disclosed methods can be amenable to immediate introduction into existing commercial membrane manufacturing processes without significant process modification.

The disclosed membranes represent an entirely new class of high flux, fouling resistant nanocomposite membranes with unique structure, morphology, and performance. The size, chemistry, structure, and loading of nanomaterials are new variables in water treatment membrane design, which enable dramatically different material properties to be achieved. A wide array of nanocomposite membranes already have been synthesized and characterized in terms of physicochemical properties (e.g., structure, hydrophilicity, charge, roughness), separation performance (e.g., water flux, solute rejection), and fouling resistance (e.g., resistance to initial adhesion and ease of cleaning).

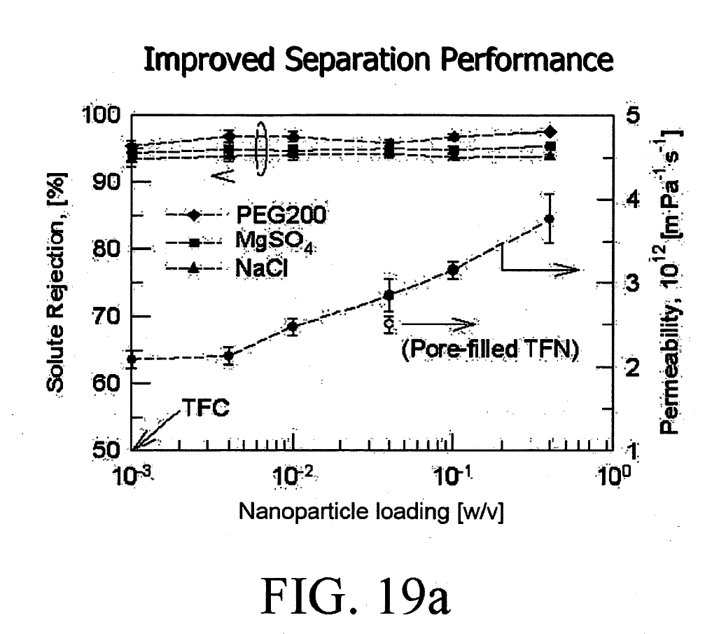

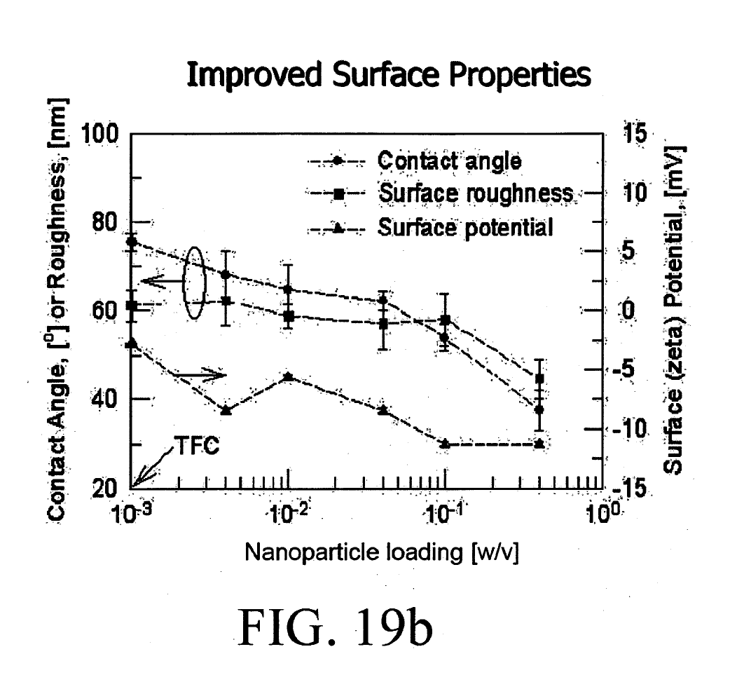

For example, thin film nanocomposite (TFN) membranes reject salt ions and low molecular weight organics as well as pure polyamide thin film composite (TFC) membranes, while exhibiting up to double the pure water permeability. Data illustrating the properties and performance of thin film nanocomposite RO membranes are provided in FIG. 19. Super-hydrophilic microporous nanoparticles can be dispersed within nano-scale thin polymer films. As nanoparticle loading increases, TFN membranes become more hydrophilic, negatively charged, and smooth, thus producing more energy efficient and potentially fouling resistant RO membranes with as good or better solute rejections than TFC membranes.

New methods of tailoring membrane structure, morphology, and performance of filtration (UF) and desalination (RO) membranes through formation of nanocomposite ultrafiltration membranes are also disclosed. Flat sheet UF membranes with dramatically different physicochemical properties can be produced by incorporating various organic and inorganic nanomaterials within porous, asymmetric polysulfone films. By varying the size, shape, chemistry, structure, and loading of nanoparticles, membranes having multiple nanoparticle-impregnated layers can be engineered to achieve different impacts on structure, morphology, surface properties, separation performance, and fouling resistance.

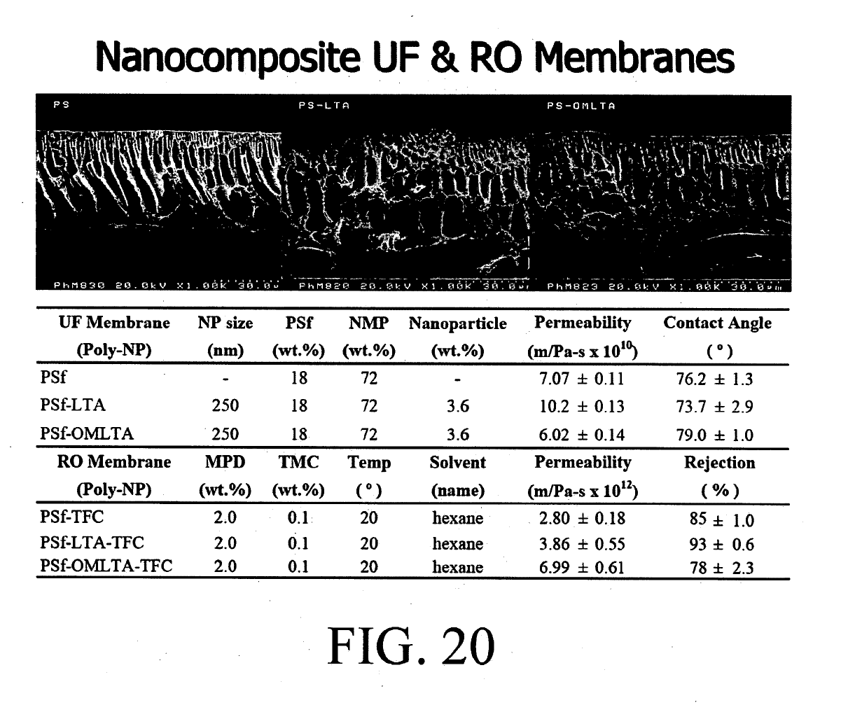

FIG. 20 presents SEM images and selected physicochemical properties of pure and nanocomposite UF membranes. Also shown at the bottom of the table are properties of thin film composite RO membranes formed over plain and nanocomposite UF membranes. Permeation tests were performed in a high-pressure dead end stirred cell using a 2,000 ppm NaCl solution at an applied pressure of 20 psi (UF) and 225 psi (RO). Using commercially available membrane polymers and nanoparticles, the properties of UF and RO membranes can be tailored to extents not possible using polymer chemistry alone. In the figure, Psf refers to a polysulfone ultrafiltration membrane. PSf-LTA refers to a polysulfone ultrafiltration membrane with LTA nanoparticles dispersed therein. PSf-OMLTA refers to a polysulfone ultrafiltration membrane with organic-modified LTA nanoparticles dispersed therein. Likewise, Psf refers to a polysulfone-supported thin film composite (TFC) membrane. PSf-LTA refers to a polysulfone-supported thin film composite (TFC) membrane with LTA nanoparticles dispersed therein. PSf-OMLTA refers to a polysulfone-supported thin film composite (TFC) membrane with organic-modified LTA nanoparticles dispersed therein.

In one aspect, a nanocomposite membrane can include a film having a polymer matrix and nanoparticles disposed within the polymer matrix, wherein the film is substantially permeable to water and substantially impermeable to impurities.

Typically, the film can have at least two surfaces or faces; one of the surfaces or faces can be proximate a porous support. In one aspect, one of the surfaces or faces can be in contact with the support. In a further aspect, the membrane can have a polysulfone, polyethersulfone, poly(ether sulfone ketone), poly(ether ethyl ketone), poly(phthalazinone ether sulfone ketone), polyacrylonitrile, polypropylene, cellulose acetate, cellulose diacetate, cellulose triacetate, or other porous polymeric support membrane.

In a further aspect, the membrane can include a film having an interfacially-polymerized polyamide matrix and zeolite nanoparticles dispersed within the polymer matrix, wherein the film is substantially permeable to water and substantially impermeable to sodium ions.

In a further aspect, the membrane can have a film having a face, wherein the film can be a polymer matrix; a hydrophilic layer proximate to the face; and nanoparticles disposed within the hydrophilic layer, wherein the film can be substantially permeable to water and substantially impermeable to impurities. In one aspect, the hydrophilic layer can be adjacent to the face. In a further aspect, the hydrophilic layer can be in contact with the face.

1. Impurities

The disclosed membranes can be prepared so as to be substantially impermeable to impurities. As used herein, “impurities” generally refers to materials dissolved, dispersed, or suspended in a liquid. The materials can be undesired; in such a case, the membranes can be used to remove the undesired impurities from the liquid, thereby purifying the liquid, and the liquid can be subsequently collected. The materials can be desired; in such a case, the membranes can be used to decrease the volume of the liquid, thereby concentrating the impurities, and the impurities can be subsequently collected.

2. Nanoparticles

The nanoparticles used in connection with the membranes disclosed herein can be selected based upon a number of criteria, including one or more of:

(1) an average particle size in the nanoscale regime (e.g. having at least one dimension of a size of from about 1 nm to about 1,000 nm, for example, from about 1 nm to about 500 nm, from about 1 nm to about 250 nm, or from about 1 nm to about 100 nm);

(2) an average hydrophilicity greater than that of the polymer matrix of the membrane, thereby enhancing the passive fouling resistance of the resulting membrane (e.g., a surface film consisting essentially of suitable nanoparticulate material would be completely wetted with a pure water contact angle less than about 5° to 10°);

(3) a nanoscale porosity with characteristic pore dimensions of from about 3 Å to about 30 Å;

(4) dispersibility in both the polar liquid and the apolar liquid and/or

(5) to impart biocidal or antimicrobial reactivity to the membrane.

a. Particle Composition

The selected nanoparticles can be a metallic species such as gold, silver, copper, zinc, titanium, iron, aluminum, zirconium, indium, tin, magnesium, or calcium or an alloy thereof or an oxide thereof or a mixture thereof.

Alternately, the selected nanoparticles can be a nonmetallic species such as Si₃N₄, SiC, BN, B₄C, or TiC or an alloy thereof or a mixture thereof.

The selected nanoparticles can be a carbon-based species such as graphite, carbon glass, a carbon cluster of at least C₂, buckminsterfullerene, a higher fullerene, a carbon nanotube, a carbon nanoparticle, or a mixture thereof. Such materials, in nanoparticulate form, can be surface modified to enable compatibility with the non-aqueous solvent as well as to promote hydrophilicity by attaching molecules containing, for example, phenethyl sulfonic acid moieties where the phenethyl group promotes compatibility with the apolar solvent and the acid group promotes compatibility with water. The relative compatibility with aqueous and non-aqueous phases can be tuned by changing the hydrocarbon chain length.

The selected nanoparticles can also be a dendrimer such as one of primary amino (PAMAM) dendrimers with amino, carboxylate, hydroxyl, succinamic acid, organisilicon or other surface groups, cyclotriphosphazene dendrimers, thiophoshphoryl-PMMH dendrimers with aldehyde surface groups, polypropylenimine dendrimers with amino surface groups, poly(vinyl alcohol)-divinylsulfone, N-isopropyl acrylamide-acrylic acid or a mixture thereof.

The selected nanoparticles can also be a natural or synthetic zeolite and/or a “molecular sieve,” that is, a material which selectively passes molecules at or below a particular size.

A zeolite structure can be referred to by a designation consisting of three capital letters used to describe and define the network of the corner sharing tetrahedrally coordinated framework atoms. Such designation follows the rules set up by an IUPAC Commission on Zeolite Nomenclature in 1978. The three letter codes are generally derived from the names of the type materials. Known synthetic zeolites that can be considered suitable porous nanoparticulate materials for passing or rejecting molecules of various sizes include: ABW, ACO, AEI, AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAN, CAS, CDO, CFI, CGF, CGS, CHA, —CHI, —CLO, CON, CZP, DAC, DDR, DFO, DFT, DOH, DON, EAB, EDI, EMT, EON, EPI, ERI, ESV, ETR, EUO, FAU, FER, FRA, GIS, GIU, GME, GON, GOO, HEU, IFR, IHW, ISV, ITE, ITH, ITW, IWR, IWW, JBW, KFI, LAU, LEV, LIO, -LIT, LOS, LOV, LTA, LTL, LTN, MAR, MAZ, MEI, MEL, MEP, MER, MFI, MFS, MON, MOR, MOZ, MSO, MTF, MTN, MTT, MTW, MWW, NAB, NAT, NES, NON, NPO, NSI, OBW, OFF, OSI, OSO, OWE, —PAR, PAU, PHI, PON, RHO, —RON, RRO, RSN, RTE, RTH, RUT, RWR, RWY, SAO, SAS, SAT, SAV, SBE, SBS, SBT, SFE, SFF, SFG, SFH, SFN, SFO, SGT, SOD, SOS, SSY, STF, STI, STT, TER, THO, TON, TSC, UEI, UFI, UOZ, USI, UTL, VET, VFI, VNI, VSV, WEI, —WEN, YUG, and ZON. An up-to-date list of known synthetic zeolites can currently be accessed at http://topaz.ethz.ch/IZA-SC/StdAtlas.htm.

In a further aspect, suitable zeolites have interconnected three-dimensional framework structures with effective pore diameters ranging from ˜3.2 to about 4.1 Angstroms. In certain aspects, synthetic zeolites that can be considered suitable porous nanoparticulate materials for use in connection with the disclosed membranes and methods include LTA, RHO, PAU, and KFI. In these aspects, each has a different Si/Al ratio, and hence, exhibits different characteristic charge and hydrophilicity.

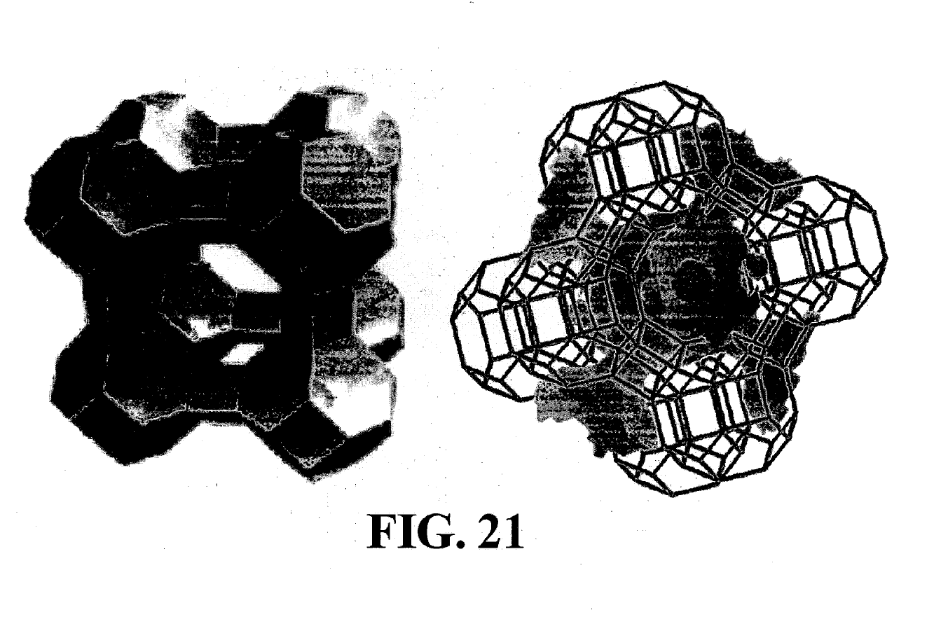

The selected nanoparticles can have a porous structure. That is, the pores of the nanoparticle can provide an open structure in one or more dimensions or directions which can result in an interconnected porous material. That is, the pores of the nanoparticle can be “linked” to provide an open structure in more than one dimension or direction. See, e.g., FIG. 21. An example of a porous material can be found in zeolitic materials. A specific example of an interconnected porous material can be found in Zeolite A. In such an aspect, the nanoparticles can provide preferential flow paths for liquids permeating the disclosed membranes.

The size of the pores in the nanoparticles can be described in terms of average pore diameter and can be expressed in angstroms (Å). In a further aspect, the nanoparticles can have a nanoscale porosity with characteristic pore dimensions of from about 3 Å to about 30 Å, for example, from about 3 Å to about 5 Å or 10 Å, from about 10 Å to about 20 Å, from about 20 Å to about 30 Å, from about 3 Å to about 20 Å, or from about 10 Å to about 30 Å. The nanoparticles can have an interconnected pore structure; that is, adjacent pores can be linked or coupled to produce a network of channels in multiple directions through the nanoparticle structure. The selected nanoparticles can be an about 1 Å to an about 50 Å porous material, an about 2 Å to an about 40 Å porous material, an about 3 Å to an about 12 Å porous material, an about 3 Å to an about 30 Å porous material, an about 1 Å to an about 20 Å porous material, an about 2 Å to an about 20 Å porous material, an about 2 Å to an about 40 Å porous material, an about 5 Å to an about 50 Å porous material, or an about 5 Å to an about 20 Å porous material.

Generally, zeolites or molecular sieves are materials with selective sorption properties capable of separating components of a mixture on the basis of a difference in molecular size, charge, and shape. Zeolites can be crystalline aluminosilicates with fully cross-linked, open framework structures made up of corner-sharing SiO₄ and AlO₄ tetrahedra. A representative empirical formula of a zeolite is M_{2/n}O.Al₂O₃.xSiO₂.yH₂O where M represents the exchangeable cation of valence n. M is generally a Group I or II ion, although other metal, non-metal, and organic cations can also balance the negative charge created by the presence of Al in the structure. The framework can contain interconnected cages and channels of discrete size, which can be occupied by water. In addition to Si⁴⁺ and Al³⁺, other elements can also be present in the zeolitic framework. They need not be isoelectronic with Si⁴⁺ or Al³⁺, but are able to occupy framework sites. Aluminosilicate zeolites typically display a net negative framework charge, but other molecular sieve frameworks can be electrically neutral.

Zeolites can also include minerals that have similar cage-like framework structures or have similar properties and/or are associated with aluminosilicates. These include the phosphates: kehoeite, pahasapaite and tiptopite; and the silicates: hsianghualite, lovdarite, viseite, partheite, prehnite, roggianite, apophyllite, gyrolite, maricopaite, okenite, tacharanite and tobermorite. Thus, zeolites can also be molecular sieves based on AlPO₄. These aluminophosphates, silicoaluminophosphates, metalloaluminophosphates and metallosilicoaluminophosphates are denoted as AlPO₄₋ₙ, SAPO-n, MeAPO-n and MeAPSO-n, respectively, where n is an integer indicating the structure type. AlPO₄ molecular sieves can have the structure of known zeolites or other structures. When Si is incorporated in an AlPO₄₋ₙ, framework, the product can be known as SAPO. MeAPO or MeAPSO sieves are can be formed by the incorporation of a metal atom (Me) into an AlPO₄₋ₙ or SAPO framework. These metal atoms include Li, Be, Mg, Co, Fe, Mn, Zn, B, Ga, Fe, Ge, Ti, and As. Most substituted AlPO₄₋ₙ's have the same structure as AlPO₄₋ₙ, but several new structures are only found in SAPO, MeAPO and MeAPSO materials. Their frameworks typically carry an electric charge.

The framework of a molecular sieve typically contains cages and channels of discrete size and generally from about 3 to about 30 Å in diameter. In certain aspects, the primary building unit of a molecular sieve is the individual tetrahedral unit, with topology described in terms of a finite number of specific combinations of tetrahedra called “secondary building units” (SBU's).

In these aspects, description of the framework topology of a molecular sieve can also involve “tertiary” building units corresponding to different arrangements of the SBU's in space. The framework can be considered in terms of large polyhedral building blocks forming characteristic cages. For example, sodalite, Zeolite A, and Zeolite Y can all be generated by the truncated octahedron known as the [[beta]]-cage. An alternative method of describing extended structures uses the two-dimensional sheet building units. Various kinds of chains can also be used as the basis for constructing a molecular sieve framework.

For example, the zeolites can be from the Analcime Family: Analcime (Hydrated Sodium Aluminum Silicate), Pollucite (Hydrated Cesium Sodium Aluminum Silicate), and Wairakite (Hydrated Calcium Sodium Aluminum Silicate); Bellbergite (Hydrated Potassium Barium Strontium Sodium Aluminum Silicate); Bikitaite (Hydrated Lithium Aluminum Silicate); Boggsite (Hydrated calcium Sodium Aluminum Silicate); Brewsterite (Hydrated Strontium Barium Sodium Calcium Aluminum Silicate); the Chabazite Family: Chabazite (Hydrated Calcium Aluminum Silicate) and Willhendersonite (Hydrated Potassium Calcium Aluminum Silicate); Cowlesite (Hydrated Calcium Aluminum Silicate); Dachiardite (Hydrated calcium Sodium Potassium Aluminum Silicate); Edingtonite (Hydrated Barium Calcium Aluminum Silicate); Epistilbite (Hydrated Calcium Aluminum Silicate); Erionite (Hydrated Sodium Potassium Calcium Aluminum Silicate); Faujasite (Hydrated Sodium Calcium Magnesium Aluminum Silicate); Ferrierite (Hydrated Sodium Potassium Magnesium Calcium Aluminum Silicate); the Gismondine Family: Amicite (Hydrated Potassium Sodium Aluminum Silicate), Garronite (Hydrated Calcium Aluminum Silicate), Gismondine (Hydrated Barium Calcium Aluminum Silicate), and Gobbinsite (Hydrated Sodium Potassium Calcium Aluminum Silicate); Gmelinite (Hydrated Sodium Calcium Aluminum Silicate); Gonnardite (Hydrated Sodium Calcium Aluminum Silicate); Goosecreekite (Hydrated Calcium Aluminum Silicate); the Harmotome Family: Harmotome (Hydrated Barium Potassium Aluminum Silicate), Phillipsite (Hydrated Potassium Sodium Calcium Aluminum Silicate), Wellsite (Hydrated Barium Calcium Potassium Aluminum Silicate); The Heulandite Family: Clinoptilolite (Hydrated Sodium Potassium Calcium Aluminum Silicate) and Heulandite (Hydrated Sodium Calcium Aluminum Silicate); Laumontite (Hydrated Calcium Aluminum Silicate); Levyne (Hydrated Calcium Sodium Potassium Aluminum Silicate); Mazzite (Hydrated Potassium Sodium Magnesium Calcium Aluminum Silicate); Merlinoite (Hydrated Potassium Sodium Calcium Barium Aluminum Silicate); Montesommaite (Hydrated Potassium Sodium Aluminum Silicate); Mordenite (Hydrated Sodium Potassium Calcium Aluminum Silicate); the Natrolite Family: Mesolite (Hydrated Sodium Calcium Aluminum Silicate), Natrolite (Hydrated Sodium Aluminum Silicate), and Scolecite (Hydrated Calcium Aluminum Silicate); Offretite (Hydrated Calcium Potassium Magnesium Aluminum Silicate); Paranatrolite (Hydrated Sodium Aluminum Silicate); Paulingite (Hydrated Potassium Calcium Sodium Barium Aluminum Silicate); Perlialite (Hydrated Potassium Sodium Calcium Strontium Aluminum Silicate); the Stilbite Family: Barrerite (Hydrated Sodium Potassium Calcium Aluminum Silicate), Stilbite (Hydrated Sodium Calcium Aluminum Silicate), and Stellerite (Hydrated Calcium Aluminum Silicate); Thomsonite (Hydrated Sodium Calcium Aluminum Silicate); Tschernichite (Hydrated Calcium Aluminum Silicate); Yugawaralite (Hydrated Calcium Aluminum Silicate) or a mixture thereof.

In one aspect, the selected nanoparticles, including for use in desalination membranes can be Zeolite A (also referred to as Linde Type A or LTA), MFI, FAU, or CLO or a mixture thereof.

The zeolite can have a negatively charged functionality, for example it can have negatively charged species within the crystalline framework, while the framework maintains an overall net neutral charge. Alternately, the zeolite can have a net charge on the crystalline framework such as Zeolite A. The negatively charged functionality can bind cations, including for example silver ions. Thus, the zeolite nanoparticles can be subject to ion-exchange with silver ions. The nanocomposite membranes can thereby acquire antimicrobial properties.

b. Particle Size

Particle size for nanoparticles is often described in terms of average hydrodynamic diameter, assuming a substantially spherical shape of the particles. The selected nanoparticles can have an average hydrodynamic diameter of from about 1 nm to about 1000 nm, from about 10 nm to about 1000 nm, from about 20 nm to about 1000 nm, from about 50 nm to about 1000 nm, from about 1 nm to about 500 nm, from about 10 nm to about 500 nm, from about 50 nm to about 250 nm, from about 200 nm to about 300 nm, or from about 50 nm to about 500 nm.

In a further aspect, the particle size of the nanoparticles can be selected to match the thickness of the film layer, that is, the hydrodynamic diameter of the selected particle can be on the order of the thickness of the film layer. For example, for a film thickness of from about 200 nm to about 300 nm, the selected nanoparticles can have a hydrodynamic diameter of from about 200 nm to about 300 nm. As another example, for a film thickness of from about 50 nm to about 200 nm, the selected nanoparticles can have a hydrodynamic diameter of from about 50 nm to about 200 nm.

3. Hydrophilic Layer

The disclosed membranes can include a film, such as a polymer matrix, which can have a hydrophilic layer proximate, adjacent or in contact to a face of the polymer matrix.

The hydrophilic layer can be a water-soluble polymer such as polyvinyl alcohol, polyvinyl pyrrole, polyvinyl pyrrolidone, hydroxypropyl cellulose, polyethylene glycol, saponified polyethylene-vinyl acetate copolymer, triethylene glycol, or diethylene glycol or a mixture thereof.

The hydrophilic layer can be a crosslinked hydrophilic polymeric material, such as a crosslinked polyvinyl alcohol. The hydrophilic layer can include selected nanoparticles disposed and/or encapsulated within the layer. For example, the film can be a cross-linked polymer with selected nanoparticles within the polymer.

4. Film

The film can be a polymer matrix, e.g. with a three-dimensional polymer network, substantially permeable to water and substantially impermeable to impurities. For example, the polymer network can be a crosslinked polymer formed from reaction of at least one polyfunctional monomer with a difunctional or polyfunctional monomer.

The selected nanoparticles can be disposed or dispersed within the polymer matrix, e.g. the nanoparticles can be mechanically entrapped within the strands of the three-dimensional polymer network. For example, the polymer matrix can be crosslinked around the nanoparticles. Such mechanical entrapment can occur during, for example, interfacial polymerization, wherein the nanoparticles are present during the polymerization reaction. Similarly, the nanoparticles can be added to a non-crosslinked polymeric material after the polymerization reaction has occurred, but a subsequent crosslinking reaction can be performed while the nanoparticles are present to entrap the nanoparticles in the polymer matrix.

At least a portion of the nanoparticles can penetrate a face of the film. That is, all or less than all of the nanoparticles can penetrate the face, e.g. a portion of each such nanoparticle which penetrates the face of the film would be positioned exterior to the surface of the film.

a. Polymer Composition

The polymer matrix file can be a three-dimensional polymer network such as an aliphatic or aromatic polyamide, aromatic polyhydrazide, poly-bensimidazolone, polyepiamine/amide, polyepiamine/urea, poly-ethyleneimine/urea, sulfonated polyfurane, polybenzimidazole, polypiperazine isophtalamide, a polyether, a polyether-urea, a polyester, or a polyimide or a copolymer thereof or a mixture thereof. Preferably, the polymer matrix film can be formed by an interfacial polymerization reaction or can be crosslinked subsequent to polymerization.

The polymer matrix film can be an aromatic or non-aromatic polyamide such as residues of a phthaloyl (e.g., isophthaloyl or terephthaloyl) halide, a trimesyl halide, or a mixture thereof. In another example, the polyamide can be residues of diaminobenzene, triaminobenzene, polyetherimine, piperazine or poly-piperazine or residues of a trimesoyl halide and residues of a diaminobenzene. The film can also be residues of trimesoyl chloride and m-phenylenediamine. Further, the film can be the reaction product of trimesoyl chloride and m-phenylenediamine.

b. Film Thickness

The polymer matrix film can have a thickness of from about 1 nm to about 1000 nm. For example, the film can have a thickness of from about 10 nm to about 1000 nm, from about 100 nm to about 1000 nm, from about 1 nm to about 500 nm, from about 10 nm to about 500 nm, from about 50 nm to about 500 nm, from about 50 nm to about 200 nm, from about 50 nm to about 250 nm, from about 50 nm to about 300 nm, or from about 200 nm to about 300 nm.

The thickness of the film layer can be selected to match the particle size of the nanoparticles. For example, for nanoparticles having an average hydrodynamic diameter of from about 200 nm to about 300 nm, the film thickness can be selected to have a film thickness of from about 200 nm to about 300 nm. As another example, for nanoparticles having an average hydrodynamic diameter of from about 50 nm to about 200 nm, the film thickness can be selected to have a film thickness of from about 50 nm to about 200 nm. As another example, for nanoparticles having an average hydrodynamic diameter of from about 1 nm to about 100 nm, the film thickness can be selected to have a film thickness of from about 1 nm to about 100 nm.

5. Properties

In various aspects, nanocomposite membranes can have various properties that provide the superior function of the membranes, including excellent flux, high hydrophilicity, negative zeta potential, surface smoothness, an excellent rejection rate, improved resistance to fouling, and the ability to be provided in various shapes.

a. Flux

The pure water flux of the membranes can be measured in a laboratory scale cross-flow membrane filtration apparatus. For example, the pure water flux can be measured in a high-pressure chemical resistant stirred cell (Sterlitech HP4750 Stirred Cell). In one aspect, the membranes can have a flux of from about 0.02 to about 0.4 GFD (gallons per square foot of membrane per day) per psi (pound per square inch) of applied pressure. For example, the flux can be from about 0.03 to about 0.1, from about 0.1 to about 0.3, from about 0.1 to about 0.2, from about 0.2 to about 0.4, from about 0.05 to about 0.1, from about 0.05 to about 0.2, from about 0.03 to about 0.2, from about 0.5 to about 0.4, from about 0.1 to about 0.4, from about 0.03 to about 0.3 gallons per square foot of membrane per day per psi of applied pressure.

It is contemplated that non-standard units (e.g., U.S. or U.K. units, including, for example, gallons and square feet) can alternatively be expressed as standard units (i.e., SI units). For example, 1 U.S. gallon can also be expressed as 3.7854118 liters. Further, 1 psi can be also expressed as 0.0689475729 bars. Further, 1 in² can also be expressed as 6.4516 cm². Thus, 1 U.S. gallons per square foot of membrane per day per psi of applied pressure is equivalent to, and can alternatively be expressed as, 0.000280932633 liters per square centimeter of membrane per day per bar of applied pressure. It is also appreciated that one of skill will readily understand both non-standard and standard units and can readily express values using either measurement convention.

b. Hydrophilicity

The hydrophilicity of the membranes can be expressed in terms of the pure water equilibrium contact angle which can be measured using a contact angle goniometer (DSA10, KRUSS GmbH). In one aspect, a membrane of the invention can have a pure water equilibrium contact angle of less than about 90°. For example, the contact angle can be less than about 75°, less than about 60°, less than about 45°, or less than about 30°. In a further aspect, the contact angle can be from about 60° to about 90°, from about 50° to about 80°, from about 40° to about 70°, from about 30° to about 60°, from about 20° to about 50°, or below 20°.

c. Zeta Potential

The surface (zeta) potential of the disclosed membranes can be measured by streaming potential analysis (BI-EKA, Brookhaven Instrument Corp). In one aspect, a membrane can have a zeta potential of from about +10 to about −50 mV depending on solution pH, type of counter-ions present, and total solution ionic strength. For example, in 10 mM NaCl solution the zeta potential can be at least as negative as about −5 mV, at least as negative as about −15 mV, at least as negative as about −30 mV, or at least as negative as about −45 mV for pHs range of from about 4 to about 10.

d. Roughness

The surface topography of the synthesized membranes can be investigated by atomic force microscopy (AFM). Such investigation allows calculation of a root mean squared (RMS) roughness value for a membrane surface. Hoek, E. M. V., S. Bhattacharjee, and M. Elimelech, “Effect of Surface Roughness on Colloid-Membrane DLVO Interactions,” Langmuir 19 (2003) 4836-4847. In one aspect, a disclosed membrane can have an RMS surface roughness of less than about 100 nm. For example, the RMS surface roughness can be less than about 65 nm, less than about 60 nm, less than about 55 nm, less than about 50 nm, less than about 45 nm, or less than about 40 nm.

e. Rejection

Salt water rejection of the disclosed membranes can be measured in the same high-pressure chemical resistant stirred cell used to measure flux, for example, using approximately 2,000 ppm NaCl. The salt concentrations in the feed and permeate water can then be measured by a digital conductivity meter and the rejection is defined as R=1−cₚ/c_{f}, where cₚ is the salt concentration in the permeated solution and c_{f} is the salt concentration in the feed solution. In one aspect, a disclosed membrane can have a salt water rejection of from about 75 to greater than about 95 percent.

f. Resistance to Fouling

The relative biofouling potentials of the disclosed membranes can be evaluated by direct microscopic observation of microbial deposition and adhesion. S. Kang, A. Subramani, E. M. V. Hoek, M. R. Matsumoto, and M. A. Deshusses, Direct observation of biofouling in cross-flow microfiltration: mechanisms of deposition and release, Journal of Membrane Science 244 (2004) 151-165. Viability of bacteria adhered to Zeolite A-polyamide (ZA-PA) and polyamide (PA) membranes can be verified with a commercial viability staining kit (e.g., LIVE/DEAD® BacLight™ Bacterial Viability Kit, Molecular Probes, Inc., Eugene Oreg.) for 2-4 minutes, followed by observation using a fluorescence microscope (e.g., BX51, Olympus America, Inc., Melville, N.Y.). Living cells can be observed as green spots and dead (inactivated) cells are seen as red spots. B. K. Li and B. E. Logan, The impact of ultraviolet light on bacterial adhesion to glass and metal oxide-coated surface, Colloids and Surfaces B-Biointerfaces 41 (2005) 153-161.

g. Shape

A variety of membrane shapes are useful and can be provided using the disclosed methods and techniques. These include spiral wound, hollow fiber, tubular, or flat sheet type membranes.

### C. Preparation of Nanocomposite Membranes

In one aspect, the disclosed membranes can be prepared by a method distinct from the conventional RO membrane preparation processes. However, many of the techniques used in conventional RO membrane preparation can be applicable to the disclosed methods.

1. Thin Film Composite Membrane Formation Techniques

Thin film composite membranes can be formed on the surface of a microporous support membrane via interfacial polymerization. See U.S. Pat. No. 6,562,266. One suitable microporous support for the composite membrane is a polysulfone “ultrafiltration” membrane with molecular cutoff value of ˜60 kDa and water permeability of ˜100-150 l/m²·h·bar. Zhang, W., G. H. He, P. Gao, and G. H. Chen, Development and characterization of composite nanofiltration membranes and their application in concentration of antibiotics, Separation and Purification Technology, 30 (2003) 27; Rao, A. P., S. V. Joshi, J. J. Trivedi, C. V. Devmurari, and V. J. Shah, Structure-performance correlation of polyamide thin film composite membranes: Effect of coating conditions on film formation, Journal of Membrane Science, 211 (2003) 13. The support membrane can be immersed in an aqueous solution containing a first reactant (e.g., 1,3-diaminobenzene or “MPD” monomer). The substrate can then be put in contact with an organic solution containing a second reactant (e.g., trimesoyl chloride or “TMC” initiator). Typically, the organic or apolar liquid is immiscible with the polar or aqueous liquid, so that the reaction occurs at the interface between the two solutions to form a dense polymer layer on the support membrane surface.

The standard conditions for the reaction of MPD and TMC to form a fully aromatic, polyamide thin film composite membrane include an MPD to TMC concentration ratio of ˜20 with MPD at about 1 to 3 percent by weight in the polar phase. The reaction can be carried out at room temperature in an open environment, but the temperature of either the polar or the apolar liquid or both can be controlled. Once formed, the dense polymer layer can act as a barrier to inhibit the contact between reactants and to slow down the reaction; hence, the selective dense layer so formed is typically very thin and permeable to water, but relatively impermeable to dissolved, dispersed, or suspended solids. This type of membrane is conventionally described as a reverse osmosis (RO) membrane.

2. Nanofiltration Membrane Formation Techniques

Unlike conventional RO membranes, nanofiltration (NF) membranes typically have the ability to selectively separate divalent and monovalent ions. A nanofiltration membrane exhibits a preferential removal of divalents over monovalents, while a conventional reverse osmosis membrane typically does not exhibit significant selectivity. A thin film composite nanofiltration (NF) membrane can be made as follows. Piperazine, together with a hydrophilic monomer or polymer containing amine groups (e.g., tri-ethylamine or “TEA” catalyst), is dissolved in water. The microporous support membrane can then be immersed in the aqueous solution with a piperazine concentration of ˜1-2 wt % at room temperature for a desired amount of time. Next, the membrane is put in contact with the organic solution containing ˜0.1-1 wt % of TMC at room temperature for about a minute after the excess solution on the membrane surface is removed. Other changes to water flux and solute rejection can be accomplished by using different monomers and initiators, changing the structure of the microporous support membrane, altering the ratio of monomer to initiator in the reaction solutions, blending multiple monomers and initiators, changing structure of the organic solvent or using blends of different organic solvents, controlling reaction temperature and time, or adding catalysts (e.g., metals, acids, bases, or chelators). In general, polyfunctional amines are dissolved in water and polyfunctional acid chlorides are dissolved in a suitable nonpolar solvent, which is immiscible with water like, for example, hexane, heptane, naptha, cyclohexane, or isoparaffin based hydrocarbon oil. While not wishing to be bound by theory, it is believed that the interfacial polycondensation reaction does not take place in the water phase, because a highly unfavorable partition coefficient for acid chloride limits its availability in the aqueous phase. For film thickness to build up, the amine monomer crosses the water-organic solvent interface, diffuses through the polyamide layer already formed, and then comes into contact with acid chloride on the organic solvent side of the polyamide layer. Thus, new polymer forms on the organic solvent side of the polyamide film. While not wishing to be bound by theory, it is believed that the thickness of the thin film formed at the interface is primarily determined by the rate of diffusion of the amine to the organic phase via water-organic media interface.

3. Post-Treatment Techniques

Various post-treatments can be employed to enhance water permeability, solute rejection, or fouling resistance of a formed TFC membrane. For example, a membrane can be immersed in an acidic and/or basic solution to remove residual, unreacted acid chlorides and diamines which can improve the flux of the formed composite membrane. Additionally, heat treatment, or curing, can also be applied to promote contact between the polyamide film and polysulfone support (e.g., at low temperature) or to promote cross-linking within the formed polyamide film. Generally, curing increases solute rejection, but often at the cost of lower water permeability. Finally, a membrane can be exposed to an oxidant such as chlorine by filtering a 10-20 ppm solution of, for example, sodium hypochlorite through the membrane for 30-60 minutes. Post-chlorination of a fully aromatic polyamide thin film composites forms chloramines as free chlorine reacts with pendant amine functional groups within the polyamide film. This can increase the negative charge density, by neutralizing positively-charged pendant amine groups, and the result is a more hydrophilic, negatively charged RO membrane with higher flux, salt rejection, and fouling resistance.

Membrane surface properties, such as hydrophilicity, charge, and roughness, typically correlate with RO/NF membrane fouling. Generally, membranes with highly hydrophilic, negatively charged, and smooth surfaces yield good permeability, rejection, and fouling behavior. However, important surface attributes of RO and NF membranes—to promote fouling resistance—include hydrophilicity and smoothness. Membrane surface charge can also be a factor when solution ionic strength is significantly less than 100 mM because at or above this ionic strength electrical double layer interactions are negligible. Since many RO and NF applications involve highly saline waters, one cannot always rely on electrostatic interactions to inhibit foulant deposition. Moreover, it has been demonstrated that polyamide composite membrane fouling by natural organic matter (NOM) is typically mediated by calcium complexation reactions occurring between carboxylic acid functional groups of the NOM macromolecules and pendant carboxylic acid functional groups on the membrane surface.

4. Hydrophilic Layer Formation Techniques

Creation of a non-reactive, hydrophilic, smooth composite membrane surface can be accomplished conventionally applying an additional coating layer comprised of a water-soluble (super-hydrophilic) polymer such as polyvinyl alcohol (PVA), polyvinyl pyrrole (PVP), or polyethylene glycol (PEG) on the surface of a polyamide composite RO membrane. In recent years, several methods of composite membrane surface modification have been introduced in membrane preparation beyond simple dip-coating and interfacial polymerization methods of the past. These advanced methods include plasma, photochemical, and redox initiated graft polymerization, drying-leaching (two-step), electrostatically self-assembled multi-layers. Advantages of these surface modification approaches include well-controlled coating layer thickness, permeability, charge, functionality, smoothness, and hydrophilicity. However, a drawback of all of these conventional surface modification methods is the inability to economically incorporate them into existing commercial manufacturing systems.

Currently, one preferred approach to surface modification of thin film composite membranes remains the simple dip coating-drying approach. In addition, polyvinyl alcohol can be an attractive option for modification of composite membranes because of its high water solubility and good film-forming properties. It is known that polyvinyl alcohol is little affected by grease, hydrocarbons, and animal or vegetable oils; it has outstanding physical and chemical stability against organic solvents. Thus, polyvinyl alcohol can be used as a protective skin layer in the formation of thin-film composite membranes for many reverse osmosis applications, as well as an ultra-thin selective layer in many pervaporation applications.

A PVA coating layer can be formed on the surface of a polyamide composite membrane as follows. An aqueous PVA solution with ˜0.1-1 wt % PVA with molecular weight ranging from 2,000 to over 70,000 can be prepared by dissolving the polymer in distilled/deionized water. PVA powder is easily dissolved in water by stirring at ˜90° C. for ˜5 hours. The already formed polyamide composite membrane is contacted with the PVA solution and the deposited film is dried overnight. Subsequently, the membrane can be brought into contact (e.g., from the PVA side) with a solution containing a cross-linking agent (e.g., dialdehydes and dibasic acids) and catalyst (e.g., ˜2.4 wt % acetic acid) for about 1 second. The membrane can then be heated in an oven at a predetermined temperature for a predetermined period. Various cross-linking agents (glutaraldehyde, PVA-glutaraldehyde mixture, paraformaldehyde, formaldehyde, glyoxal) and additives in the PVA solution (formaldehyde, ethyl alcohol, tetrahydrofuran, manganese chloride, and cyclohexane) can be used to prepare PVA films cast over existing membranes in combination with heat treatment of prepared PVA films to modify film properties.

5. Nanocomposite Membrane Formation

A method for preparing a nanocomposite membrane can include providing a polar mixture including a polar liquid and a first monomer that is miscible with the polar liquid; providing an apolar mixture including an apolar liquid substantially immiscible with the polar liquid and a second monomer that is miscible with the apolar liquid; providing nanoparticles in either the polar mixture or the apolar mixture, wherein the nanoparticles can be miscible with the apolar liquid and/or miscible with the polar liquid; and contacting the polar mixture and the apolar mixture at a temperature sufficient to react the first monomer with the second monomer, thereby interfacially-polymerizing the first monomer and the second monomer to form a polymer matrix, wherein the nanoparticles can be disposed, dispersed or entrapped within the polymer matrix.

By “miscible,” it is meant that the respective phases can mix and form a homogeneous mixture or dispersion at the relevant temperature and pressure. Unless otherwise specified, the relevant temperature and pressure are at room temperature and at atmospheric pressure. Particles can be termed miscible in a liquid if the particles can form a uniform and stable dispersion in the liquid. An example of a particle being miscible in an apolar liquid is Zeolite A nanoparticles in hexane. A further example of a particle being miscible in a polar liquid is Zeolite A nanoparticles in water. By “immiscible,” it is meant that the respective phases do not appreciably mix and do not appreciably form a homogeneous mixture at the relevant temperature and pressure. Two liquids can be termed immiscible if neither liquid is appreciably soluble in the other liquid. An example of two immiscible liquids is hexane and water.

a. Apolar Liquid

The apolar liquid can be selected so that it is immiscible with a particular polar liquid and/or miscible with the selected nanoparticles. For example, if the particular polar liquid is water and the particular nanoparticles are Zeolite A, the apolar liquid can be selected to be hexane.

In one aspect, the apolar liquid can include at least one of a C₅ to C₂₄ hydrocarbon. The hydrocarbon can be an alkane, an alkene, or an alkyne. The hydrocarbon can be cyclic or acyclic. The hydrocarbon can be straight chain or branched. The hydrocarbon can be substituted or unsubstituted. In further aspects, the apolar liquid can include at least one of a linear hydrocarbon, a branched hydrocarbon, a cyclic hydrocarbon, naptha, heavy naptha, paraffin, or isoparaffin or a mixture thereof and can be hexane.

The nanoparticles can be provided as part of the apolar mixture. For example, the nanoparticles can be dispersed within the apolar liquid.

b. Polar Liquid

The polar liquid can be selected to be immiscible with a particular apolar liquid and/or miscible with particular nanoparticles of the invention. For example, if the particular apolar liquid is hexane and the particular nanoparticles are Zeolite A, the polar liquid can be selected to be water.

In one aspect, the polar liquid can include at least one of a C₅ to C₂₄ alcohol such as an alkane, an alkene, or an alkyne. The alcohol can be cyclic or acyclic. The alcohol can be straight chain or branched. The alcohol can be substituted or unsubstituted. In a further aspect, the polar liquid comprises water.

It is understood that the nanoparticles can, in one aspect, be provided as part of the polar mixture. For example, the nanoparticles can be dispersed within the polar liquid.

In one aspect, the polar mixture can be adsorbed upon a substantially insoluble support membrane prior to the contacting step. The support membrane may, for example, be a polysulfone or polyethersulfone webbing.

c. Monomers

Generally, the polymer matrix can be prepared by reaction of two or more monomers. In one aspect, the first monomer can be a dinucleophilic or a polynucleophilic monomer and the second monomer can be a dielectrophilic or a polyelectrophilic monomer. That is, each monomer can have two or more reactive (e.g., nucleophilic or electrophilic) groups. Both nucleophiles and electrophiles are well known in the art, and one of skill in the art can select suitable monomers for this use. In one aspect, the first and second monomers can be chosen so as to be capable of undergoing an interfacial polymerization reaction to form a polymer matrix (i.e., a three-dimensional polymer network) when brought into contact. In a further aspect, the first and second monomers can be chosen so as to be capable of undergoing a polymerization reaction when brought into contact to form a polymer product that is capable of subsequent crosslinking by, for example, exposure to heat, light radiation, or a chemical crosslinking agent.

In one aspect, a first monomer can be selected so as to be miscible with a polar liquid and, with the polar liquid, can form a polar mixture. The first monomer can optionally also be selected so as to be immiscible with an apolar liquid. Typically, the first monomer can be a dinucleophilic or a polynucleophilic monomer. In a further aspect, the first monomer can be a diaminobenzene. For example, the first monomer can be m-phenylenediamine. As a further example, the first monomer can be a triaminobenzene. In a yet further aspect, the polar liquid and the first monomer can be the same compound; that is, the first monomer can provided and not dissolved in a separate polar liquid.

In one aspect, a second monomer can be selected so as to be miscible with an apolar liquid and, with the apolar liquid, can form an apolar mixture. The second monomer can optionally also be selected so as to be immiscible with a polar liquid. Typically, the second monomer can be a dielectrophilic or a polyelectrophilic monomer. In a further aspect, the second monomer can be a trimesoyl halide. For example, the second monomer can be trimesoyl chloride. As a further example, the second monomer can be a phthaloyl halide. In a yet further aspect, the apolar liquid and the second monomer can be the same compound; that is, the second monomer can provided and not dissolved in a separate apolar liquid.

Generally, the difunctional or polyfunctional nucleophilic monomer can have primary or secondary amino groups and can be aromatic (e.g., m-phenylenediamine, p-phenyenediamine, 1,3,5-triaminobenzene, 1,3,4-triaminobenzene, 3,5-diaminobenzoic acid, 2,4-diaminotoluene, 2,4-diaminoanisole, and xylylenediamine) or aliphatic (e.g., ethylenediamine, propylenediamine, and tris(2-diaminoethyl)amine). Examples of suitable amine species include primary aromatic amines having two or three amino groups, for example m-phenylene diamine, and secondary aliphatic amines having two amino groups, for example piperazine. The amine can typically be applied to the microporous support as a solution in a polar liquid, for example water. The resulting polar mixture typically includes from about 0.1 to about 20 weight percent, for example from about 0.5 to about 6 weight percent, amine. Once coated on the microporous support, excess polar mixture can be optionally removed. The polar mixture need not be aqueous but can be immiscible with the apolar liquid.

Generally, difunctional or polyfunctional electrophilic monomer is preferably coated from an apolar liquid, although the monomer can be optionally be delivered from a vapor phase (for monomers having sufficient vapor pressure). The electrophilic monomer can be aromatic in nature and can contain two or more, for example three, electrophilic groups per molecule. In the case of acyl halide electrophilic monomers, because of the relatively lower cost and greater availability, acyl chlorides are generally more suitable than the corresponding bromides or iodides. A suitable polyfunctional acyl halide is trimesoyl chloride (TMC). The polyfunctional acyl halide can be dissolved in an apolar organic liquid in a range of, for example, from about 0.01 to about 10.0 weight percent or from about 0.05 to about 3 weight percent, and delivered as part of a continuous coating operation. Suitable apolar liquids are those which are capable of dissolving the electrophilic monomers, for example polyfunctional acyl halides, and which are immiscible with a polar liquid, for example water. In particular, suitable polar and apolar liquids can include those which do not pose a threat to the ozone layer and yet are sufficiently safe in terms of their flashpoints and flammability to undergo routine processing without having to undertake extreme precautions. Higher boiling hydrocarbons, i.e., those with boiling points greater than about 90° C., such as C₈-C₂₄ hydrocarbons and mixtures thereof, have more suitable flashpoints than their C₅-C₇ counterparts, but they are less volatile.

Once brought into contact with one another, the electrophilic monomer and nucleophilic monomer react at the surface interface between the polar mixture and the apolar mixture to form a polymer, for example polyamide, discriminating layer. The reaction time is typically less than one second, but contact time is often longer, for example from one to sixty seconds, after which excess liquid can optionally be removed, e.g., by way of an air knife, water bath(s), dryer, and the like. The removal of the excess polar mixture and/or apolar mixture can be conveniently achieved by drying at elevated temperatures, e.g., from about 40° C. to about 120° C., although air drying at ambient temperatures can be used.

Through routine experimentation, those skilled in the art will appreciate the optimum concentration of the monomers, given the specific nature and concentration of the other monomer, nanoparticles, reaction conditions, and desired membrane performance.

In a further aspect, the method of making the film can include soaking a polysulfone membrane in an aqueous solution comprising m-phenylenediamine, and pouring onto the soaked polysulfone membrane a hexane solution comprising trimesoyl chloride and zeolite nanoparticles suspended in the hexane solution, thereby interfacially-polymerizing the m-phenylenediamine and the trimesoyl chloride to form a film, wherein the zeolite nanoparticles are dispersed within the film. In a yet further aspect, the nanoparticles can comprise Zeolite A. In a yet further aspect, the method can further include contacting the zeolite nanoparticles with a silver salt. For example, the zeolite can be contacted with a silver salt prior to interfacially polymerizing a first monomer (e.g., m-phenylenediamine) and a second monomer (e.g., trimesoyl chloride) to form a film, thereby producing silver-exchanged zeolite nanoparticles dispersed within the film.

d. Nanoparticles

In one aspect, nanoparticles used in connection with the membranes disclosed herein can be provided as part of the polar mixture and/or as part of the apolar mixture. In one aspect, the nanoparticles can be selected so as to be miscible with both the polar liquid and the apolar liquid.

Through routine experimentation, those skilled in the art will appreciate the optimum concentration of the nanoparticles, given the specific nature and concentration of the first monomer, second monomer, reaction conditions, and desired membrane performance.

6. Nanocomposite Membrane with Hydrophilic Layer

In a further aspect, an aqueous mixture such as water, a hydrophilic polymer, nanoparticles, and optionally, at least one crosslinking agent can be provided and contacted with; a polymer film that is substantially permeable to water and substantially impermeable to impurities, thereby forming a hydrophilic nanocomposite layer in contact with the film; and at least a portion of the water from the hydrophilic nanocomposite layer can then be evaporated. In a yet further aspect, the layer can be heated to a temperature sufficient to crosslink the crosslinking agent.

a. Aqueous Mixture

In one aspect, the method can involve providing an aqueous mixture such as water, a hydrophilic polymer, nanoparticles, and optionally, at least one crosslinking agent. The components can be combined in any order; however, in one aspect, the nanoparticles can be added to a mixture of the hydrophilic polymer and water. In one aspect, the crosslinking agent can be added after the other three components have been combined.

Typically, the water is fresh water; however, in one aspect, the water can be salt water. Similarly, the water can include other dissolved materials.

The polymer, in one aspect, can include at least one of polyvinyl alcohol, polyvinyl pyrrole, polyvinyl pyrrolidone, hydroxypropyl cellulose, acrylic acids, poly(acrylic acids), polyethylene glycol, saponified polyethylene-vinyl acetate copolymer, triethylene glycol, or diethylene glycol or a mixture thereof. In one aspect, the hydrophilic polymer can be a crosslinked polyvinyl alcohol.

The hydrophilic polymer can include selected nanoparticles disposed, dispersed and/or substantially encapsulated within the hydrophilic polymer. For example, the film can be a crosslinked polymer, and the nanoparticles can be substantially encapsulated within the polymer matrix of the polymer.

At least one crosslinking agent can optionally be provided in the method. That is, in one aspect, the hydrophilic polymer can be a crosslinked hydrophilic polymer. In a further aspect, the hydrophilic layer can be a non-crosslinked hydrophilic polymer.

b. Polymer Film

In one aspect, the method can involve providing a polymer film that is substantially permeable to water and substantially impermeable to impurities include including thin film composite membranes, nanofiltration membranes, as well as nanocomposite membranes.

That is, it is contemplated that nanoparticles can be optionally provided with the polymer film so that, in one aspect, the polymer film can have the components and properties of nanocomposite membranes. In a further aspect, the nanoparticles can be absent from the polymer film of the invention, and the polymer film can have the components and properties of known thin film composite membranes or nanofiltration membranes.

c. Contacting Step

In one aspect, nanoparticles can be dispersed in a stirred polyvinyl alcohol (PVA) aqueous solution to form a PVA-nanoparticle aqueous suspension. Ultrasonication can be used to ensure complete dispersion of the nanoparticles. A given amount of cross-linking agent (CL) (e.g., fumaric acid, maleic anhydride, or malic acid) can be dissolved in the aqueous suspension with stirring at 50° C. overnight, and then cooled and degassed.

Next, a thin film nanocomposite membrane or a nano-filtration membrane can be contacted with the PVA-nanoparticle-CL aqueous suspension, allowing water to evaporate at room temperature, and then cross-linking PVA at increased temperature over approximately 5 to 10 minutes. The resulting thin film nanocomposite membranes possess superior flux, rejection, and fouling resistance.

### D. Methods of Using the Membranes

In certain aspects, the membranes disclosed herein can be used in conventional filtration methods for example to purify a liquid by removing impurities dissolved, suspended, or dispersed within the liquid as it is passed through the membrane. In a further example, the membranes can be used to concentrate impurities by retaining the impurities dissolved, suspended, or dispersed within a liquid as the liquid is passed through the membrane.

1. Purifying Liquids

In one aspect, the membranes disclosed herein can be used for reverse osmosis separations including seawater desalination, brackish water desalination, surface and ground water purification, cooling tower water hardness removal, drinking water softening, and ultra-pure water production.

The feasibility of a membrane separation process is typically determined by stability in water flux and solute retention with time. Fouling, and in particular biological fouling, can alter the selectivity of a membrane and causes membrane degradation either directly by microbial action or indirectly through increased cleaning requirements. These characteristics can have a direct effect on the size of the membrane filtration plant, the overall investment costs, and operating and maintenance expenses. By applying the membranes and methods disclosed herein to commercial membrane and desalination processes, the overall costs can be significantly reduced due to the improved selectivity and fouling resistance of the nanocomposite membranes of the invention. Due to antibiotic properties of the nanoparticles, in particular silver-exchanged Zeolite A nanoparticles, disposed within the nanocomposite membranes, less frequent chemical cleanings and lower operating pressures are typically required, thereby offering additional savings to owners and operators of these processes.

The membranes can have a first face and a second face. The first face of the membrane can be contacted with a first solution of a first volume having a first salt concentration at a first pressure; and the second face of the membrane can be contacted with a second solution of a second volume having a second salt concentration at a second pressure. The first solution can be in fluid communication with the second solution through the membrane. The first salt concentration can then be higher than the second salt concentration, thereby creating an osmotic pressure across the membrane. The first pressure can be sufficiently higher than the second pressure to overcome the osmotic pressure, thereby increasing the second volume and decreasing the first volume.

In further aspects, the membranes disclosed herein can be used for reverse osmosis separations including liquids other than water. For example, the membranes can be used to remove impurities from alcohols, including methanol, ethanol, n-propanol, isopropanol, or butanol. Typically, suitable liquids are selected from among liquids that do not substantially react with or solvate the membranes.

2. Concentrating Impurities

In one aspect, the membranes and films disclosed herein can be used in isolation techniques for recovering an impurity—for example a valuable product—from a liquid, for example water or one or more alcohols. The impurities thereby collected can be the product of a chemical or biological reaction, screening assay, or isolation technique, for example, a pharmaceutically active agent, or a biologically active agent or a mixture thereof.

In one aspect, the membranes can be used for concentrating an impurity by providing a including selected nanoparticles. The membrane has a first face and a second face; the first face of the membrane can be contacted with a first mixture of a first volume having a first impurity concentration at a first pressure; the second face of the membrane can be contacted with a second mixture of a second volume having a second impurity concentration at a second pressure; and the impurity can be collected. The first mixture can be in fluid communication with the second solution through the membrane, wherein the first impurity concentration is higher than the second impurity concentration, thereby creating an osmotic pressure across the membrane, and wherein the first pressure is sufficiently higher than the second pressure to overcome the osmotic pressure, thereby increasing the second volume and decreasing the first volume.

### E. Experimental

The following examples are put forth so as to provide those of ordinary skill in the art with a complete disclosure and description of how the compounds, compositions, articles, devices and/or methods disclosed herein can be made and evaluated, and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. and is at ambient temperature, and pressure is at or near atmospheric.

1. Preparation of Nanoparticles

Zeolite A (ZA) nanoparticles were synthesized by hydrothermal synthesis from a clear solution with a molar composition of 1.00 Al₂O₃: 6.12 SiO₂: 7.17 (TMA)₂O: 0.16 Na₂O: 345H₂O. H. Wang et al., Homogeneous Polymer-zeolite Nanocomposite Membranes by Incorporating Dispersible Template-removed Zeolite Nanocrystals, J. Mater. Chem., 12 (2002) 3640. First, aluminum isopropoxide (+98%, Aldrich) was dissolved in a solution made from 25 wt. % aqueous tetramethylammonium hydroxide (TMA, Aldrich), 97 wt. % sodium hydroxide (Aldrich) and distilled water. Once the solution became clear, Ludox HS-30 colloidal silica (Aldrich) was added to begin a two-day aging process. The solution was then heated with stirring at 100° C. for 1 day. The colloidal ZA-water suspension was obtained by centrifugation, careful decanting, and ultrasonic re-dispersion in water.

In order to remove TMA without inducing nanoparticle aggregation, a polymer network was introduced into the colloidal ZA-water suspension. An acrylamide monomer (AM, 97%, Aldrich), crosslinker N,N′-methylenebiscarylamide (MBAM, 99%, Aldrich), and diaminosulfate initiator (NH₄)₂S₂O₈, (AS, +98%, Aldrich) were added to the nanoparticle suspension in water. After the monomer had dissolved, the mixture was ultrasonicated for 30 minutes to ensure complete dispersion of ZA nanoparticles. The monomer aqueous solution was then heated to 50° C. for 2 hours and 12 hours, respectively, at a heating rate of 2° C. per minute. Template-removed ZA nanoparticles can be given their antibacterial property by an ion exchange process with silver salt. This was carried out by adding ZA nanoparticles to a gently stirred 0.1 M solution of A_{g}NO₃ at room temperature for 12 h. A. M. P. McDonnell et al., Hydrophilic and antimicrobial zeolite coatings for gravity-independent water separation, Adv. Functional Mater. 15 (2005) 336.

2. Preparation of Nanocomposite Membrane

a. Synthesis

ZA-PA thin film nanocomposite membranes were cast on pre-formed polysulfone ultrafiltration (UF) membranes through an interfacial polymerization reaction. The UF membranes were placed in aqueous solution of 2% (w/v) m-phenylenediamine (MPD, 99%, Aldrich) for approximately 10 minutes and the MPD soaked support membranes were then placed on a paper towel and rolled with a soft rubber roller to remove excess solution. For the interfacial polymerization reaction, a hexane solution consisting of 0.1% (w/v) trimesoly chloride (TMC, 98%, Aldrich) was poured on top. A. P. Rao et al., Structure-performance Correlation of Polyamide Thin Film Composite Membranes: Effect of Coating Conditions on Film Formation, Journal of Membrane Science, 211 (2003) 13. For the ZA-PA nanocomposite membranes, a measured amount of ZA nanoparticles were added to the TMC-hexane solution, and the resultant suspension was ultrasonicated for 1 hour in order to ensure good dispersion of the ZA nanoparticles. The MPD-water soaked UF support membrane as then contacted with the ZA-TMC-hexane solution. After 1 minute of reaction, the TMC solution was poured off, and the resulting membranes were then rinsed with 18 M-ohm de-ionized water. In some cases, the formed membranes can be contacted with a 0.2 wt % sodium carbonate solution for about 3 hours. The membranes were then thoroughly washed with and stored in a sterile container of deionized water.

b. Characterization

X-ray diffraction and energy dispersive X-ray spectroscopy (EDX) were used to confirm the crystalline structure, the Si/Al ratio, and the degree of silver exchanged into ZA nanoparticles. Morphological characterization of synthesized nanoparticles and membranes was carried out using scanning electron microscopy (SEM). Zeta potential of the nanoparticles was measured by particle electrophoresis. The surface (zeta) potential and the (sessile drop) contact angles of the synthesized membranes were measured by streaming potential analyzer and contact angle goniometer, respectively. Surface topography of synthesized membranes was determined by atomic force microscopy (AFM).

c. Performance

The PA and ZA-PA nanocomposite membranes were evaluated for pure water permeability and solute rejection. The pure water flux was measured using a high-pressure chemical resistant dead-end stirred cell (Sterlitech HP4750 Stirred Cell). Circular membrane samples with a diameter of 49 mm were placed in the test cell with the active separation layer facing the cell reservoir. The membrane was supported on the porous stainless steel membrane disc with a Buna-N O-ring around it to ensure leak-free operation. The effective membrane area for water and solute permeation was approximately 14.6 cm². One distinction is that the dead-end filtration configuration leads to higher concentration in the feed reservoir as water permeated through the membrane, and hence, flux decreases with time as the feed reservoir solute concentration (and resulting trans-membrane osmotic pressure) increases. Without wishing to be bound by theory, since solute rejection is known to decrease as feed concentration increases and as water flux decreases, it is believed that the values of solute rejection are substantially lower than those that would be achieved in a hydrodynamically optimized spiral wound element.

Pure water flux experiments were performed using 18 M-ohm de-ionized water. The operating pressure was set at 180 psi and the flow of water was measured volumetrically and by mass determination on a calibrated electronic balance. Solute rejection tests were performed using separate 2,000 mg/L solutions of NaCl, MgSO₄, and poly(ethylene glycol) (PEG). Salt concentrations in the feed and permeate water measured by a digital conductivity meter that was calibrated daily. PEG concentrations in the feed and permeate were determined by total organic carbon analysis. Solute rejections were determined from 1−Cₚ/(C_{f,0}−C_{f,e}), where Cₚ is the permeate (filtered) water concentration, C_{f,0} is the initial feed water concentration, and C_{f,e} is the final feed water concentration. During the entire test, a high rate of stirring was maintained using a Teflon-coated magnetic stir bar to reduce concentration polarization.

An experimental system designed to facilitate visual quantification of microbial cell deposition onto synthesized membranes was employed. S. Kang et al., Direct Observation of Biofouling in Cross-flow Microfiltration: Mechanisms of Deposition and Release, Journal of Membrane Science, 244 (2004) 151-165. The experimental system described in Kang et al., was operated without flux through the membrane in order to determine the rate and extent of heterogeneous adsorption of bacteria cells onto the synthesized membranes. S. Wang et al., Direct Observation of Microbial Adhesion to Membranes, Environmental Science & Technology 39 (2005) 6461-6469. Without wishing to be bound by theory, it is believed that visual confirmation of cell deposition onto membranes provides a more direct quantification of the propensity of a membrane to foul than simple measurements of flux decline while filtering a suspension of fouling material. Without wishing to be bound by theory, it is also believed that flux decline is an indirect and misleading measure of fouling because it can be biased by various factors such as membrane hydraulic resistance, salt rejection, and concentration polarization. E. M. V. Hoek and M. Elimelech, Cake-Enhanced Concentration Polarization: A New Mechanism of Fouling for Salt Rejecting Membranes 37 (2003) 5581-5588.

In selected experiments, as synthesized and silver exchanged (AgX) Zeolite A nanoparticles were convectively deposited onto the surfaces of pure polyamide composite membrane samples in order to quantify (visually) the antimicrobial efficacy of the silver exchanged nanoparticles. Live bacteria cell, Pseudomonas putida, suspension in water with NaCl concentration of 10 mM (58.5 mg/L) and unadjusted pH were pumped through the direct microscopic observation filtration cell in three separate experiments. In the first experiment, a sample of pure PA composite membrane was tested. In the second experiment, a sample of ZA-PA nanocomposite membrane was tested. In the third experiment, a sample of AgX-ZA-PA nanocomposite membrane was tested. The cell suspension was filtered through the system for 30 minutes, at which time the experiment was stopped and the membrane samples were stained using the Live/Dead BacLight bacterial viability kit. B. K. Li and B. E. Logan, The impact of ultraviolet light on bacterial adhesion to glass and metal oxide-coated surface, Colloids and Surfaces B-Biointerfaces 41 (2005) 153-161.

d. Results

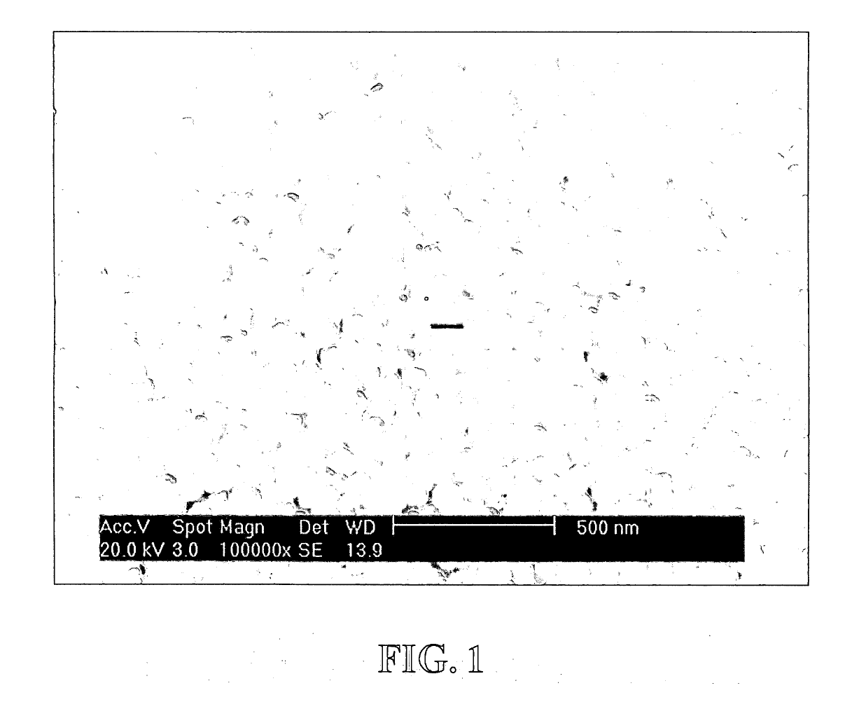

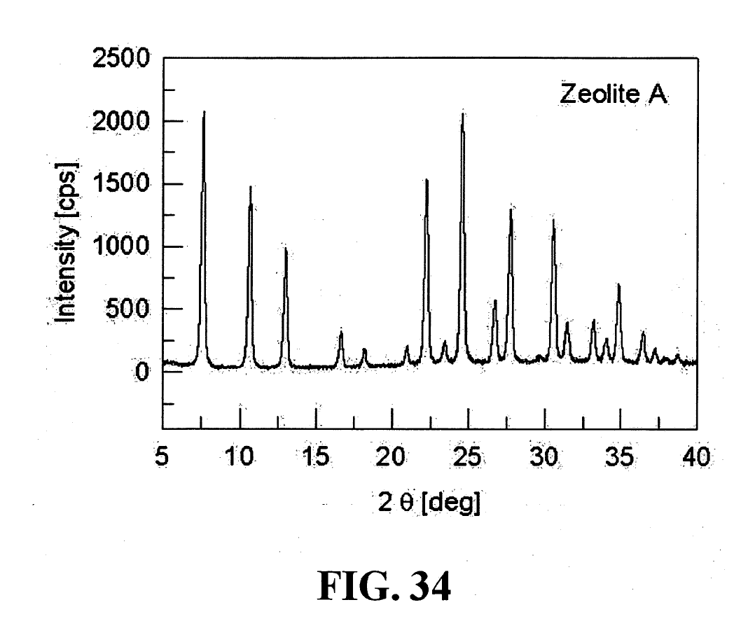

The crystal structure of synthesized ZA nanoparticles was confirmed by matching the X-ray diffraction (XRD) patterns (FIG. 34) with the Joint Committee on Powder Diffraction Standards (JCPDS) files. FIG. 1 shows that as formed LTA-type zeolite nanoparticles exhibit particles sizes ranging from about 50 to about 200 nm in this example. According to energy dispersive X-ray spectroscopic analysis, the Si/Al ratio of as synthesized Zeolite A was 1.5 and the degree of silver ion exchange was 90%. Additional characterization data is provided in Table 1. Dynamic light scattering confirmed the average hydrodynamic radius in de-ionized water to be 140 nm, thus, indicating good dispersability of ZA nanoparticles in water. Zeta potential of the nanoparticles determined from measured electrophoretic mobility was −45±2 mV, when dispersed in an aqueous 10 mM NaCl electrolyte at unadjusted pH of 6.

TABLE 1
Properties of synthesized ZA nanoparticles

| | Particle | DLS | Zeta |
|---|---|---|---|
| Crystal | size by SEM | datum | potential |
| Structure | [nm] | [nm] | [mV] |
| A | 50-200 | 140 | −45 ± 2 |

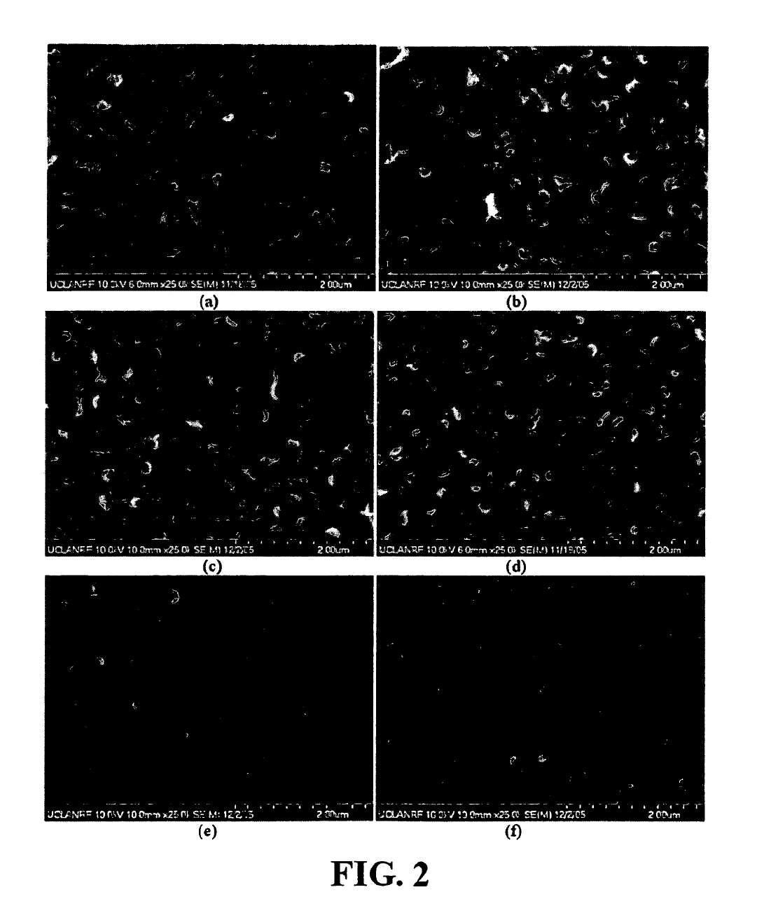

FIG. 2(a) and (b) show representative SEM images of PA and ZA-PA nanocomposite membranes, respectively. Also generally shown are TEM images of TFC/TFN—0.04% membranes. XYZ indicates the concentration (w/v) of zeolite dispersed in the hexane-TMC initiator solution: (a) XYZ=0.000%, (b) XYZ=0.004%, (c) XYZ=0.010%, (d) XYZ=0.040%, (e) XYZ=0.100%, and (f) XYZ=0.400%. The surface of the PA membrane exhibited the familiar “hill and valley” structure of conventional membranes without nanoparticles dispersed therein. For the ZA-PA membrane, however, nanoparticles appeared well dispersed in the polyamide film and the typical surface structure of an interfacially polymerized RO membrane was not found. Furthermore, at high magnification, no voids were observed between nanoparticles and the polyamide matrix, indicating good zeolite-polymer contact.

Table 2 shows three key properties that can be representative of PA and ZA-PA membranes. Pure water contact angle and surface (zeta) potential for the ZA-PA membrane were 10 degrees lower and 4 mV more negative, respectively, indicating a more hydrophilic surface. There was a decrease in the surface roughness (R_{RMS}, z-data standard deviation) for the ZA-PA membrane compared to the pure PA membrane, indicating that the surface of the ZA-PA membrane is much smoother. Thus, ZA-PA membranes provide improved energy efficiency, separation performance, and fouling resistance in water purification processes.

TABLE 2
Surface Properties of Synthesized Membranes.

| | Pure Water | Surface (zeta) potential | Surface roughness |
|---|---|---|---|
| Membrane | Contact angle [°] | @ pH 7 [mV] | R[nm] |
| PA | 77.6 ± 0.4 | −13.1 | 73.0 |
| ZA-PA | 62.2 ± 0.8 | −17.4 | 65.6 |

TFC and TFN membranes were evaluated for pure water flux and solute rejection in a high-pressure chemical resistant stirred cell (HP4750 Stirred Cell, Sterlitech Corp., Kent, Wash.). The concentration of Zeolite A nanoparticles in TFN were varied from 0.0 to 0.4% (w/v). Rejection was determined using 2,000 ppm solutions of NaCl, MgSO₄, and PEG 200 (poly-ethylene glycol with 200 Da nominal molecular weight). Three coupons from each membrane were evaluated for the flux and solute rejection, and the obtained results were summarized in Table 1. The membrane designation of TFC refers to pure MPD-TMC polyamide thin film composite membranes, whereas TFN-XYZ refers to Zeolite A-polyamide thin film nanocomposite membranes made with 0.XYZ % (w/v) of Zeolite A nanoparticles dispersed in the hexane-TMC solution prior to the interfacial polymerization reaction used to coat the thin film layer on the polysulfone porous support.

The data of Table 3 indicate that the TFN membrane performance is superior to the TFC membrane performance with respect to both pure water permeability and solute rejection and for all three solutes. In addition, with increasing nanoparticle loading, the permeability increases, the pure water contact angle decreases (i.e., the membranes become more hydrophilic), and certain key surface roughness parameters decrease (i.e., the membranes become smoother).

TABLE 3
Performance and Properties of Synthesized Membranes

| | | | | Solute | | | | |
|---|---|---|---|---|---|---|---|---|
| | NP | | | Rejection | | | AFM Roughness | |
| Membrane | Loading | Permeability | | [%] | | Contact | Ra | SAD |
| Designation | (% w/v) | (m/Pa-s) × 10¹² | NaCl* | MgSO₄* | PEG200* | Angle (°) | [nm] | [%] |
| TFC | 0.001 | 2.1 ± 0.1 | 90.4 ± 1.5 | 91.7 ± 1.6 | 93.1 ± 1.4 | 75.4 ± 2.1 | 43.3 ± 2.2 | 31.5 ± 0.8 |
| TFN-004 | 0.004 | 2.1 ± 0.1 | 91.0 ± 1.1 | 92.5 ± 1.3 | 95.4 ± 1.4 | 64.4 ± 6.3 | 63.6 ± 9.6 | 72.4 ± 7.6 |
| TFN-010 | 0.010 | 2.4 ± 0.1 | 91.4 ± 1.1 | 92.3 ± 1.1 | 95.3 ± 1.0 | 52.7 ± 7.4 | 58.7 ± 2.6 | 68.3 ± 8.9 |
| TFN-040 | 0.040 | 2.8 ± 0.2 | 91.6 ± 0.9 | 92.6 ± 0.6 | 93.8 ± 0.7 | 42.1 ± 1.4 | 44.3 ± 2.7 | 26.6 ± 3.6 |
| TFN-100 | 0.100 | 3.1 ± 0.1 | 90.8 ± 0.6 | 92.5 ± 0.6 | 95.3 ± 0.6 | 35.9 ± 2.3 | 58.9 ± 10 | 46.2 ± 7.7 |
| TFN-400 | 0.400 | 3.7 ± 0.3 | 91.2 ± 0.5 | 93.2 ± 0.4 | 96.4 ± 0.3 | 33.1 ± 8.2 | 44.3 ± 6.8 | 39.3 ± 4.0 |

*2,000 mg/L feed concentration, 180 psi applied pressure

Fractional surface coverages of bacteria cells at different cross-flow velocities (15, 25, 40 and 200 mm s⁻¹) are listed in Table 4. The net deposition rate was lower for the ZA-PA nanocomposite membrane, especially as cross-flow was increased, indicating that the nanocomposite membranes is easier to clean than pure polyamide membranes. Without wishing to be bound by theory, it is believed that the difference in cell deposition and adhesion can be attributed to the increased hydrophilicity and smoothness seen in the data of Tables 2 and 3.

TABLE 4
Impact of cross-flow velocity on deposition rate.

Cross-flow velocity [mm s⁻¹]

| Membrane | 15 | 25 | 40 | 200 |
|---|---|---|---|---|
| PA | 23.1% | 22.7% | 21.5% | 14.6% |
| ZA-PA | 16.0% | 16.6% | 17.1% | 6.3% |

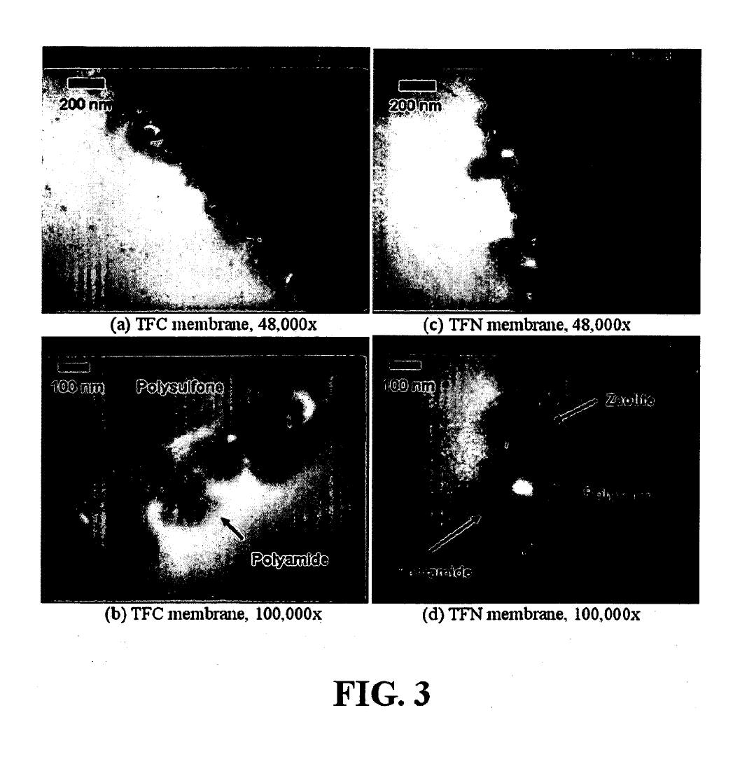

FIG. 3 shows representative TEM images of synthesized pure polyamide [(a) and (b)] and zeolite-polyamide nanocomposite [(c) and (d)] membranes. The polysulfone support, which contains relatively heavy sulfur atoms, appears darker than the polyamide polymer matrix and can thus be easily distinguished from it. The characteristic porous texture of polysulfone also aids in distinguishing between polyamide polymer matrix and polysulfone. All membranes were relatively rough, which can be a general feature of interfacially polymerized polyamide composite membranes, and thus the thickness of polyamide layer was in the range of 100-300 nm in this example. As can be seen from SEM images for TFN membranes, zeolite nanoparticles, which appear considerably darker than the polyamide layer, were located in the polyamide polymer matrix layer. Without wishing to be bound by theory, it is believed that higher flux of pure water for TFN membranes is due to the introduction of zeolite nanoparticles into the polyamide polymer matrix layer.

3. Preparation of Nanocomposite Membrane with Hydrophilic Layer

a. Thin Film Nanocomposite (TFN) Membrane Formation

TFN membranes can be formed on microporous polysulfone support membranes through an interfacial polymerization reaction. The microporous support is immersed in an aqueous solution of 2 wt % MPD for approximately two minutes. Next, the MPD soaked support membranes can be placed on a rubber sheet and rolled with a rubber roller to remove excess MPD solution. The support membrane can then be contacted with a hexane solution consisting of 0.1 wt % TMC and 0.001 to 1.0 wt % as-synthesized Zeolite A (ZA) nanoparticles. The nanoparticles can be dispersed in the TMC solution by ultra-sonication for 20-60 minutes prior to the reaction. After 1 minute of reaction, the TMC-ZA solution is poured off, and the resulting membranes rinsed with an aqueous solution of 0.2 wt % sodium carbonate. Modifications to the formation conditions, as well as post-treatments described herein, can be applied to formation of thin film nanocomposite membranes.

b. Surface Modification of TFN Membranes

Zeolite A nanoparticles can be dispersed in 0.1-1.0 wt % PVA aqueous solutions under vigorous stirring for ˜5 hours to make the PVA-ZA aqueous suspensions at various weight ratios ranging from 99:1 to 50:50 (PVA:ZA). Ultrasonication can be further required (as described above) to ensure complete dispersion. A given amount of cross-linking (CL) agent (e.g., fumaric acid, maleic anhydride, or malic acid) can be dissolved in the aqueous suspension with stirring at 50° C. overnight, and then cooled and degassed. A TFC or TFN membrane can be contacted with the PVA-ZA-CL aqueous suspension, allowing water to evaporate at room temperature, and then cross-linking PVA at 80°-120° C. for 5-10 minutes. The resulting PA-PVA/ZA or PA/ZA-PVA/ZA thin film nanocomposite membrane possesses superior flux, rejection, and fouling resistance.

4. Purification of Water Using Nanocomposite Membrane

Basic procedures for purification of water using polymeric membranes are well-known to those of skill in the art. A simple procedure for the purification of water using a membrane and for determining pure water flux, salt rejection, concentration polarization, and fouling phenomena has been described in E. M. V. Hoek et al., “Influence of cross-flow membrane filter geometry and shear rate on colloidal fouling in reverse osmosis and nanofiltration separations,” Environmental Engineering Science 19 (2002) 357-372 and is summarized below. Simple characterization of a membrane's ability to purify a particular water sample is described in step (d), below.

a. Laboratory-Scale Cross-Flow Membrane Filter

Suitable membrane filtration units include a modified or unmodified version of a commercially available stainless steel cross-flow membrane filtration (CMF) unit (Sepa CF, Osmonics, Inc.; Minnetonka, Minn.) rated for operating pressures up to 6895 kPa (1000 psi). Applied pressure (ΔP) should be maintained constant and monitored by a pressure gage (Cole-Parmer) and flux should be monitored in real time by a digital flow meter (Optiflow 1000, Humonics; Rancho Cordova, Calif.) or by directly measuring the volume of water permeated per unit time.

b. Measuring Membrane Hydraulic Resistance

A different membrane coupon is typically used for each filtration experiment to determine a membrane's intrinsic hydraulic resistance. First, deionized (DI) water is circulated at about 250 psi (1724 kPa) for up to 24 hours to dissociate any flux decline due to membrane compaction (and other unknown causes inherent of lab-scale recirculation systems). Flux can be monitored continuously for the duration of the experiment. After DI equilibration, the pressure can be changed in increments of 50 psi (345 kPa), from a high of 250 psi to a low of 50 psi and flux recorded at a feed flow rate of 0.95 liters per minute (Lpm). At each pressure, flux is typically monitored for at least 30 minutes to ensure stable performance. The cross-flow can then be increased to 1.90 Lpm and flux recorded at 50 psi increments from 50 psi to 250 psi. Finally, feed flow rate can be set to 3.79 Lpm and the flux recorded at 50 psi increments from 250 psi down to 50 psi. At each cross-flow and pressure, the average of all of the stable flux measurements can then be plotted against applied pressure. The slope of a line fitted to pure water flux versus pressure data by a least squares linear regression provides the membrane hydraulic resistance, Rₘ. There is typically no measured influence of feed flow rate on pure water flux, but the procedure provides extra data points for the regression analysis. The pH, turbidity, and conductivity of feed is typically monitored throughout the pure water flux experiments to ensure constant feed conditions.

c. Measuring CP Modulus and Initial Osmotic Pressure Drop

After the membrane pure water hydraulic resistance is determined, concentration polarization effects can be quantified using the velocity variation techniques. The concentration polarization modulus is the ratio of rejected solute concentration at the membrane surface divided by the bulk solute concentration. An appropriate volume of 1 M stock NaCl solution is typically added to the feed tank to provide the desired experimental ionic strength. The sequence of varying applied pressure and feed flow rate is typically repeated, as described above. The effective osmotic pressure drop across the membrane (Δπ) for each combination of feed velocity and applied pressure is typically determined from J=A(Δp−Δπ) where J is the water flux, Δp is the applied pressure, and A=1/Rₘ. Since the feed and permeate salt concentrations can be directly measured, the membrane concentration is obtained from Δπ=fₒₛ(cₘ−cₚ), where cₘ and cₚ are the salt concentrations at the membrane surface and in the permeate and fos is a coefficient that converts molar salt concentration to osmotic pressure (˜2RT for NaCl at dilute concentrations; R=8.324 J/mol·K, T=absolute temperature, K). Once cₚ, is known, the concentration polarization modulus (cₘ/cₚ) is directly calculated.

d. Measuring Decline in Flux Due to Fouling

After the salt water experiments are finished, pressure and cross-flow are typically adjusted to produce the desired initial flux and wall shear for the fouling experiment. After stable performance (water flux and salt rejection) are achieved for a minimum of about 60 minutes, a dose of model foulant materials (e.g., organics, bacteria, colloids) are added to the feed tank to provide the appropriate foulant feed concentration. If real waters (e.g., “natural” water from environmental or industrial samples) are to be tested, then the feed tank and system are typically completely emptied, rinsed, and drained prior to filling the feed tank with a volume of the test water. A “real water” is a sample of water from a water utility or water source that is being considered for purification via a membrane filtration process. The concentration of foulant materials should be monitored in the feed, retentate, and permeate throughout the duration of the experiment by an appropriate analytical technique such as, for example, turbidity, color, TOC, or particle counts depending on the nature foulant material. In addition, conductivity and pH measurements are typically made at the start, end, and at several points during the fouling experiment to monitor salt rejection and to ensure the feed solution ionic strength and pH are not changing throughout the test. The transient flux at constant pressure is typically recorded in real-time while maintaining constant flux.

5. Preparation of Porous Support Membrane with Nanoparticles

a. Laboratory Scale Cross Flow Membrane Filter

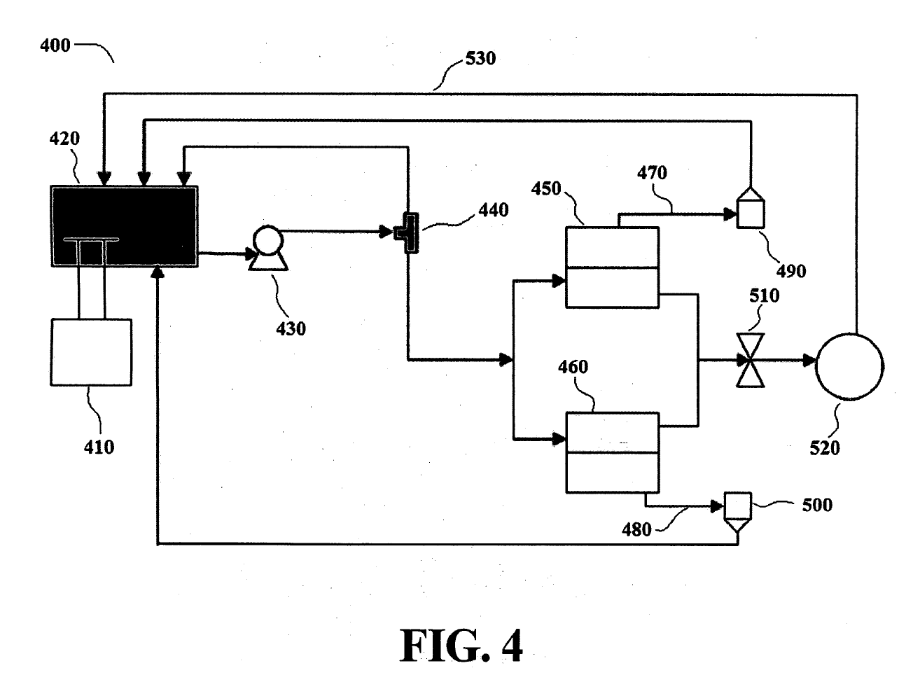

Referring now generally to FIGS. 4-18, tests were conducted of porous support membranes in which selected nanoparticles were, disbursed during polymerization. A total of nine membranes were tested in a cross flow membrane filtration system 400 using a 10 mM NaCl electrolyte as the feed solution. The system was designed to simultaneously test two membranes in parallel as shown in particular in FIG. 4. To meet this design requirement, two identical cross flow membrane filtration units were used.

With reference to FIG. 4, the cross flow membrane filtration system 400 comprises a feed tank 420 which holds the feed solution, and which is in fluid communication with a recirculating heater/chiller 410. The feed solution is passed to a pump 430 and then to a by-pass valve 440 which can pass the solution to the next filtration stage or recirculate the solution back to the feed tank 420. From the by-pass valve 440, the solution is passed to two membrane filters 450, 460. The permeate remaining (470, 480) after filtration is then passed to a digital flow meter which can optionally recirculate the permeate back to the feed tank. The membrane filters 450, 460 are in fluid communication with a back-pressure regulator 510 to control the permeate flow rate and a floating disk rotameter 520 to control the cross flow rate.

Both of the individual units shown in FIG. 4 have dimensions of 76.2 and 25.4 mm for the channel length and width, respectively, while the channel height is 3.0 mm. These channel dimensions give an effective membrane area of 0.0019 m² for each unit. The applied pressure (ΔP) and cross flow velocity were kept constant and monitored by a pressure gauge (Ashcroft Duralife 0-1000 psig) and rotameter (King Instrument Company, USA), respectively. Flux was monitored both in real-time by a digital flow meter (Agilent Optiflow 1000) and by measuring permeate volume during a two minute time interval. A recirculating heater chiller (Neslab RTE-211) was used to help offset heating due to the pump and to keep the temperature constant.

b. Membrane Properties

Referring now again in particular to FIG. 4, the membranes tested were both commercially available polyamide thin film composites (PA-TFC) and hand-cut membranes fabricated in our lab. The two commercial membranes were NF90 and NF270. NF90 is intended for use as a loose brackish water reverse osmosis membrane, while NF270 is intended for use as a nanofiltration membrane. The hand-cut membranes were polyamide thin film composites (PA-TFC) formed over nanocomposite and pure polysulfone supports.

c. Commercial Membranes

Two nanofiltration membranes, NF90 and NF270, supplied by Filmtec Corp. were characterized. Both membranes were made through a process called interfacial polymerization and are polyamide thin-film composite membranes formed on polysulfone support membranes. While both of these membranes contain benzenetricarbonyl trichloride (TMC) as a starting material, NF90 uses 1,3 phenylene diamine (MPD) to complete the polymerization and NF270 uses a piperazine derivative. Despite this difference, both have similar operating conditions with a maximum operating temperature of 113° F. or 45° C. The maximum recommended operating pressure is 600 psi. The recommended pH range for continuous operation is 3-10, while that for short-term cleaning is 1-3. There is a measurable difference in the contact angle, roughness, and zeta potential of the two membranes.

Pure water contact angles were measured using a contact angle goniometer (DSAI OMk2, Kruss, USA) and three probe liquids, one apolar and two polar. At least twelve equilibrium contact angles were determined for each membrane with the highest and lowest values discarded. The average of left and right contact angles was taken as the equilibrium contact angle. Surface morphology of membranes was characterized by atomic force microscopy, AFM (Autoprobe CP, Park Scientific Instruments, USA) using tapping mode and scanning electron microscopy, SEM (XL30 FEG SEM, FEI Company, Hillsboro, USA). Membrane surface (zeta) potentials were determined by a streaming potential analyzer (EKA, Anton Paar, USA) following previously described methods.

d. Hand Cast Membranes

Seven different membranes were fabricated for testing in our lab. One membrane was made from pure polysulfone, while the other six contained various nanoparticles to be discussed later in the section, described herein as nanocomposite support membranes. The preparation of the support membrane was started by the addition of N-methylpyrrolidone (NMP) solvent (Acros Organics, USA) to a polysulfone polymer (M,-26,000 from Aldrich, USA) in transparent bead form in airtight glass bottles. In the case of the nanocomposite support membranes, various nanoparticles were dispersed in the NMP before its addition to the polysulfone polymer. The solution was then agitated for several hours until complete dissolution was achieved, forming the dope solution. The dope solution was then spread over a non-woven fabric (SepRO, Oceanside, Calif.) that was attached to a glass plate via a knife-edge. The glass plate was immediately immersed into demineralized water, which had been maintained at the desired temperature. Immediately, phase inversion begins and after several minutes, the non-woven support fabric supported polysulfone membrane is separated from the glass plate. The membrane is then washed thoroughly with deionized water and stored in cold conditions until usage.

Thin-film composite membranes, cast on pure polysulfone and nanocomposite support membranes were prepared as described above and were made via interfacial polymerization. Polymerization occurs at the interface of two immiscible solvents that contain the reactant. For the membranes tested, the polymerization was between m-phenylenediamine (MPD) and trimesoyl chloride (TMC) (Sigma-Aldrich, City, State, USA), on the non-woven fabric supported polysulfone or nanocomposite support membranes. The support membrane was immersed is an aqueous solution of MPD for 15 seconds. The excess MPD solution was then removed from the skin surface of the support membrane via an air knife. The support membrane was then immersed into an organic solution, isoparaffin based hydrocarbon oil (ExxonMobil Isopar G, Gallade Chemical, Inc., Santa Ana, Calif.), of TMC (Aldrich, USA) for 15 seconds, resulting in the formation of an ultra-thin film of polyamide over the surface of the support membrane. The resulting composite was heat cured for 10 minutes, washed thoroughly with deionized water, and stored in deionized water before performance testing.

Four of the nanocomposite support membranes (M1040, ST50, ST20L, ST-ZL) made used non-porous, amorphous silica nanoparticles provided by the Nissan Chemical Co, Japan. Size and mobility characteristics of these particles were measured in our lab using Zeta Pals' Particle Size Software and Zeta Potential Analyzer, respectively (Brookhaven Instrument Corporation). The size of the particle was determined using the dynamic light scattering technique. Before measurements, the pH was adjusted to 6 using HCl and NaOH and the particles were dispersed in a 10 mM NaCl solution. Three measurements were taken for both size and mobility and then averaged.

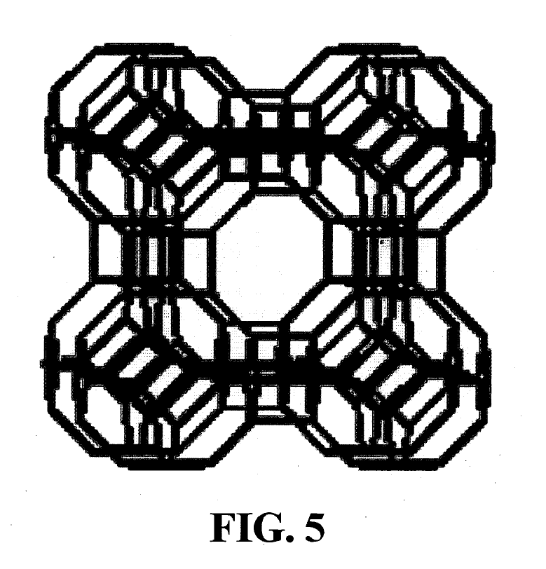

Referring now to FIG. 5, the other nanocomposite support membranes were prepared using zeolite nanoparticles provided by NanoScape, Germany. A zeolite is crystalline aluminosilicate with a tetrahedral framework enclosing cavities that are occupied by large ions and water molecules, which are both free to move. Hence, a zeolite has a connected framework, extra framework cations, an adsorbed phase, and an open structure with pores and voids for molecular movement. The particular zeolites used in these membranes, LTA and OMLTA, have channel sizes on the order of about 4 Angstroms. The size and mobility characteristics of these two particles were measured using the same procedures as described above. The major difference between these two zeolites is that OMLTA has been modified with organic matter to potentially prevent or reduce fouling.

e. Compaction Experiments

The membranes under investigation were cut into areas of 0.0019 m² and hydrostatically compacted with a 10 mM NaCl feed solution at pressures of 0, 250, and 500 psi. The cross flow membrane filtration apparatus was run continuously at 25° C. and 0.2 gpm until a steady-state flux was obtained for both membranes in the flow channels, after which the membranes were removed and stored in a desiccator. Flux measurements were recorded every half hour and used to calculate the membrane resistances as shown in the following equation 2.1.

$${R}_{m} = \frac{Δ P - Δ π}{μ \times J} \qquad ( 2.1 )$$

Here, ΔP is the applied pressure, Δπ is the trans-membrane osmotic pressure, μ is the solution viscosity, and J is the permeate flux. The osmotic pressure term in equation 2.1 was calculated using equation 2.2, below. Since concentration polarization is an important factor in nanofiltration and reverse osmosis operation, it was considered. The concentration polarization factor was calculated using equation 2.3, below.

Δπ=2RT[(CP*C_{f})−Cₚ] (2.2)

In equation 2.2, R is the universal gas constant, T is the temperature, CP is the concentration polarization factor, C_{f} is the feed concentration, and Cₚ, the permeate concentration.

$$CP = 1 - {R}_{s} + {R}_{s} \cdot exp ( \frac{J}{k} ) \qquad ( 2.3 )$$

In equation 2.3, R is the membrane rejection and k is the mass transfer coefficient. The value of k was calculated using equation 2.4 and the calculation of membrane rejection is discussed in the following paragraph.

$$k = 1. .85 {( Re Sc )}^{1 / 3} \frac{D}{{d}_{k}} \qquad ( 2.4 )$$

In equation 2.4, Rₑ is the Reynolds numbers, Sc is the Schmidt number, D is the diffusivity of sodium chloride, and dₕ is the double the channel height.

Conductivity, pH, color, and turbidity measurements of the feed and permeate streams were taken at the beginning and end of each experiment. Feed samples were taken directly from the feed tank and permeate samples were collected through tubes which otherwise fed back into the feed tank. Conductivity and pH measurements were taken using a Fisher scientific AR50, while color and turbidity measurements were done with a Hach 2100AN Turbidimeter. The conductivity values from this were then used to calculate the membrane rejection via equation 2.5 below.

$${R}_{s} = 1 - \frac{{C}_{f}}{{C}_{p}} \qquad ( 2.5 )$$

Here, Rₛ is the conductivity rejection, C_{f} is the feed stream conductivity, and C, is the permeate stream conductivity.

f. Scanning Electron Microscopy

Scanning electron microscopy (SEM) was used to investigate support membrane structure and thin film surface morphology. Preparation of the membrane samples for SEM usage is very important. SEM usage requires that samples be electrically conductive. Since these membranes are not conductive, conductivity is achieved with a sputter coater, which uses argon gas and an electric field. The sample is placed in a chamber at a vacuum and then argon gas is introduced. An electric field is then used to remove an electron from argon, making it positively charged. It is then attracted to a negative gold foil, knocking gold atoms from the surface of the foil. The gold atoms then settle onto the surface of the sample, producing a gold coating and giving it conductance. Samples also must be free from strain. If this requirement is not met, the cleavage does not represent the primary structure of the membrane sample. This can be done by freezing the sample and breaking it in liquid nitrogen.

6. Commercial Membrane Results

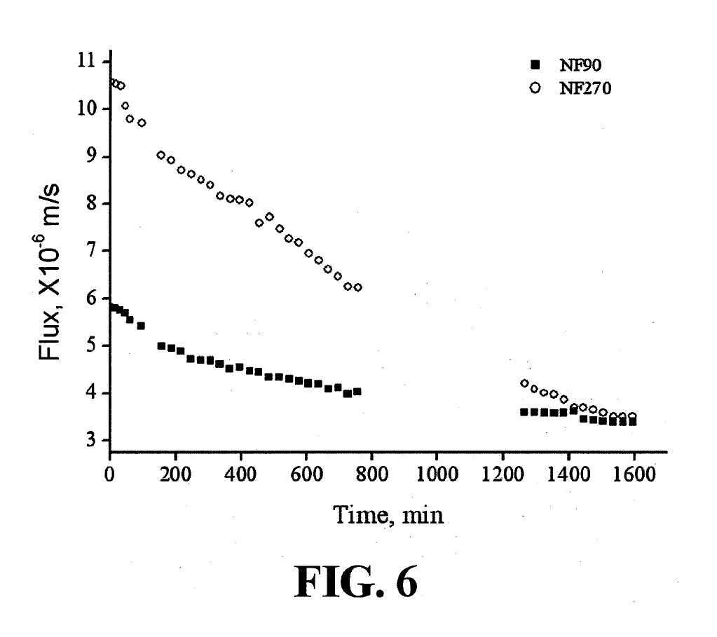

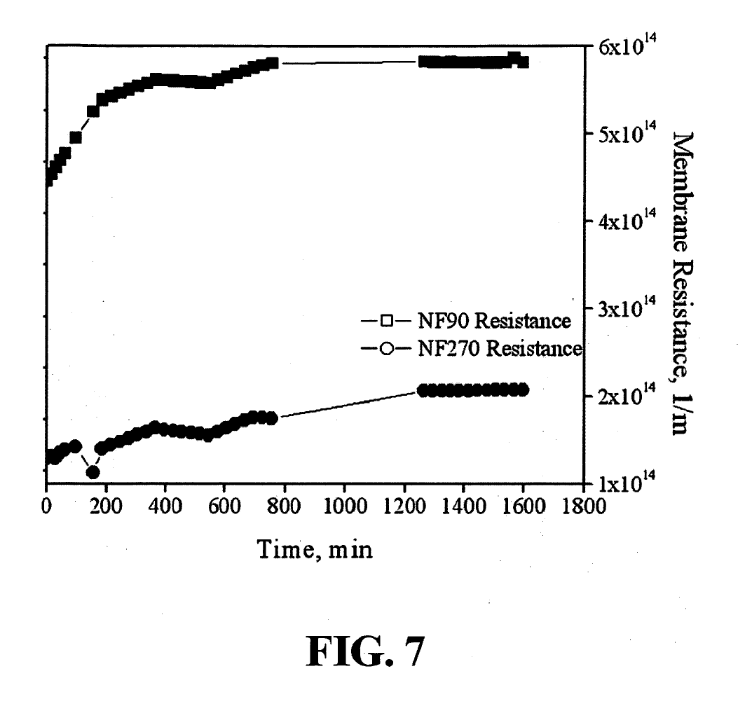

Referring now also to FIGS. 6 and 7, the NF90 and NF270 membranes were characterized in a lab. Contact angle, root mean square (RMS), surface area difference (SAD), and zeta potential data were taken using a 10 nM NaCl solution. These values are given below in Table 3.1 below. The pure water contact angle for NF90 is about 1.5 times larger than that of NF270, meaning it is much more hydrophobic. The more hydrophobic a membrane, the smaller the flow will be. Therefore, it is expected that NF90 will have a much smaller initial flux than NF270. The RMS and SAD values for NF90 are both much greater than for NF270. This indicates that NF270 has a much smoother membrane surface than NF90 and, hence, less propensity for surface fouling. NF90 has a smaller absolute zeta potential than NF270. This indicates that NF270 membranes have more charge, resulting in a stronger electrostatic repulsion force and greater Donan exclusion influence.

TABLE 3.1
Summary of NF90 and NF270 characteristics as determined in our lab

| | ⊖_{water} | I | RMS | SAD | ζₘ |
|---|---|---|---|---|---|
| | (°) | (mm) | (nm) | (%) | (mV) |
| NF90 | 67.5 ± 0.3 | 0.01 | 40 | 19 | −12 |
| NF270 | 39.7 ± 0.4 | 0.01 | 4 | 0.4 | −20 |

Still referring now to FIGS. 6 and 7, the NF90 and NF270 membranes were tested at 250 psi using a 10 mM NaCl feed solution. The initial flux of NF270 was almost double that of NF90. This can be attributed to the porosity of each membrane. Since NF270 is intended for use as a nanofiltration membrane, it has a greater porosity than a NF90 membrane, which is intended for use as a brackish water reverse osmosis membrane. The flux reduction is clearly much greater for NF270 membranes than NF90 membranes, as seen in FIG. 6, and can be explained in two ways. First, the materials used to make each membrane differ. As described earlier, NF270 membranes are piperazine based polyamides, while NF90 membranes are made of 1,3-diaminobenzene based polyamides. Therefore, NF90 membranes are made of fully aromatic thin films, while NF270 membranes are made of partially aromatic thin films and azide rings. In general, aromatic rings are more rigid than aliphatic and azide compounds; hence, NF90 can be inherently more rigid due to its fully aromatic thin film structure. Therefore, NF90 will experience less compaction and less flux decline. Secondly, flux decline is observed due to compaction occurring within the support membrane. As the membrane is subjected to high pressures, the support membrane begins to change structure and the mean pore diameter decreases, restricting flow through the membrane. The flux reaches a steady-state value when the support membrane structure has been fully compacted at that pressure.

Referring now in particular to FIG. 7, resistance for each sample time is plotted. Resistance values were calculated using a standard Darcy resistance in series model given described above. NF90 membranes have an initial membrane resistance about 1.5 times larger than NF270 membranes, however, the membrane resistance increases much more drastically with NF270 membranes. This trend can be explained both mathematically and physically. Seen in equation 3.1, membrane resistance is inversely proportional to flux. As discussed above, membrane flux for NF270 is greater initially, thus, it has a lower initial resistance. Following these same lines, NF270 has a much more drastic change in flux, so it will have a greater change in resistance. Physically, there are two possible reasons for the displayed behavior, but both deal with internal fouling. First, as explained above, the materials of the two membranes are different. The NF90 membrane, due to its fully aromatic materials, is more rigid and, hence, compacts less. Therefore, the flow path is not as restricted over time and there is a smaller change in flux, translating to a smaller change in membrane resistance. Secondly, the porosity of NF270 membranes is greater. This provides more spots for compaction to occur over time. More compaction results in less flux through the membrane and a larger membrane resistance.

The structural changes of the membrane and the pores are visibly seen in the following SEM images.

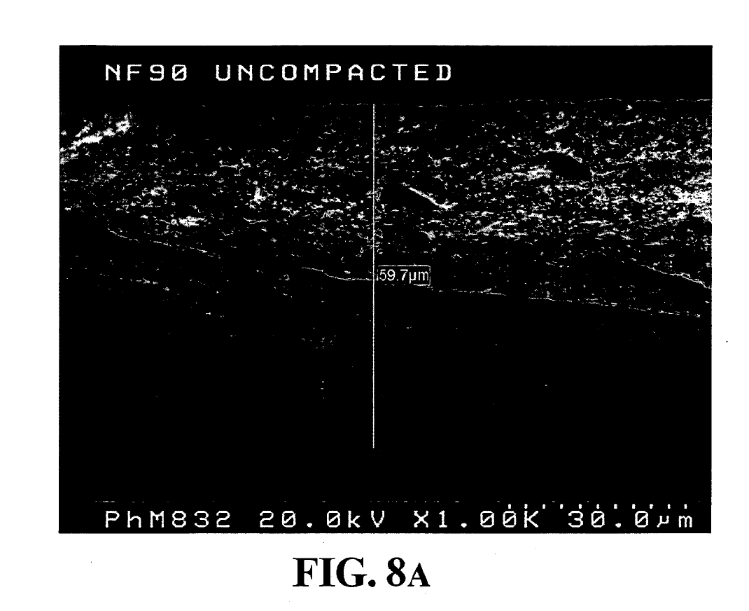

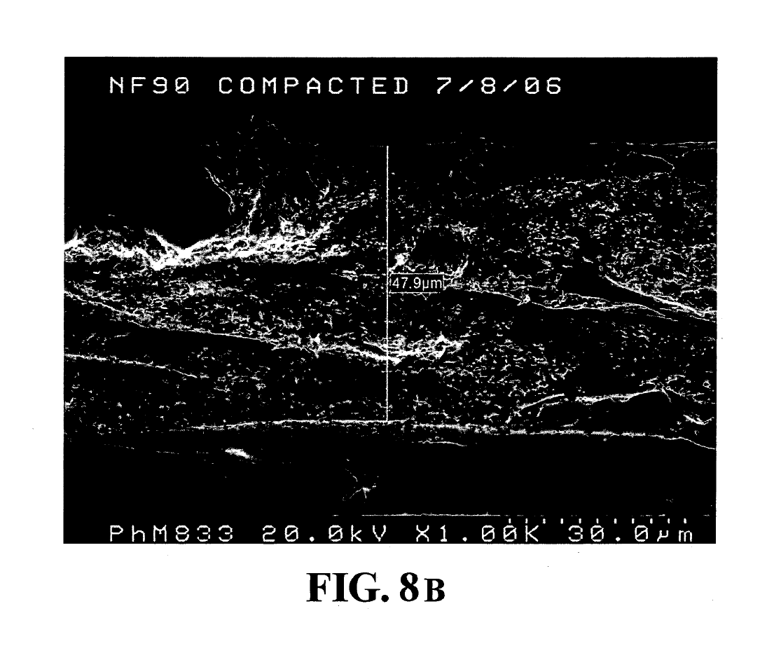

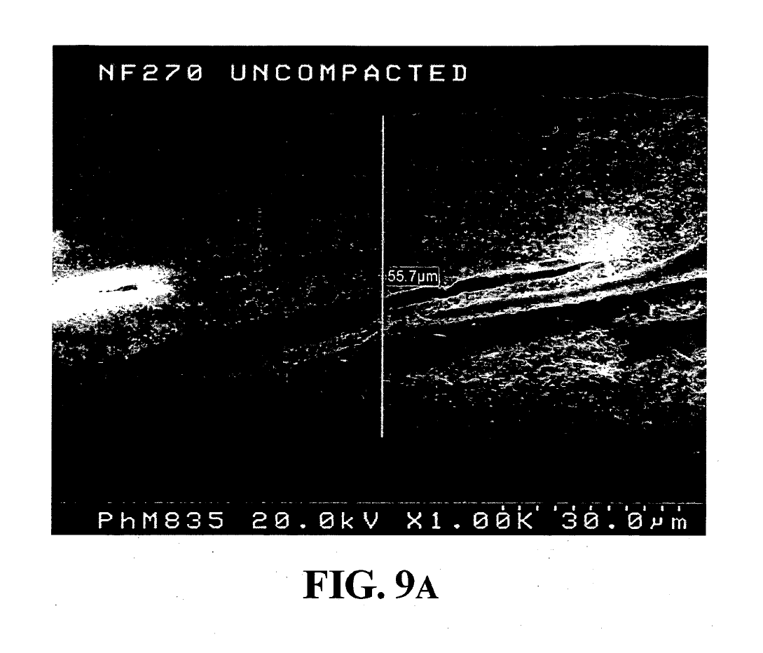

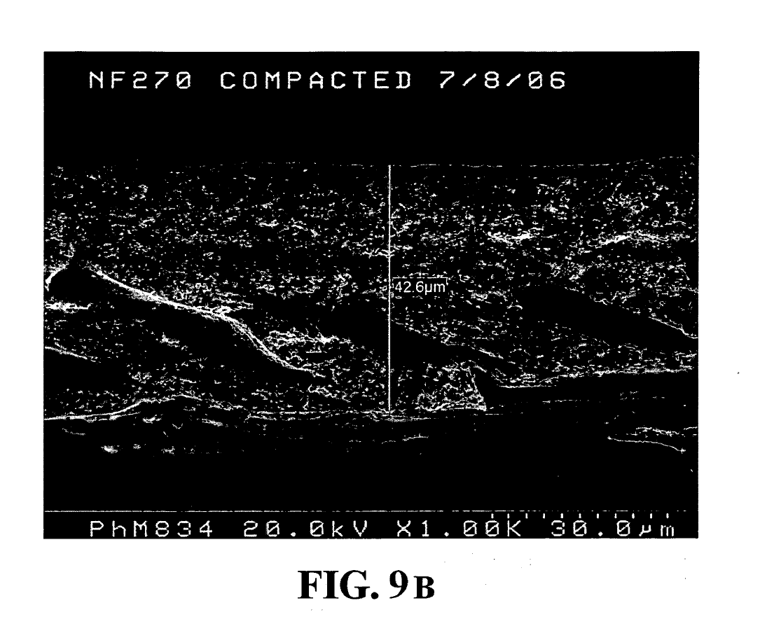

Referring now to FIGS. 8 and 9, cross-section SEM images were taken of both virgin and compacted NF9Q and NF270 membranes. As can be seen for both membranes, the polysulfone support layer of the virgin membranes is much thicker than the corresponding compacted membranes. The support layer is physically becoming smaller, and, therefore, denser and less permeable to water. NF270 appears to have experienced a greater change in thickness (from 55.7 to 42.6 μm) than NF90 (from 59.7 to 47.9 μm), but the quantitative change in thickness is dependent upon where the membranes were sampled. This brings to attention the limitations of the SEM process used. There are two big sources of uncertainty in this analysis. First, the backing material on which the membranes were cast does not freeze fracture cleanly. This makes it difficult to produce clean SEM images. Secondly, the exact location of the SEM picture is fairly arbitrary and was chosen to give the clearest image. Since each position on the membrane has a slightly different thickness, the location of the measurement will affect the result. Therefore, SEM images should only be used for qualitative analysis.

Table 3.2 below summarizes the above discussions. Change in resistance and thickness is given by a percentage. These values were calculated using the standard equation of final minus initial divided by final. The change in both calculated membrane resistance is greater for NF270 than it is for NF90. The change in resistance can be explained by internal fouling of the support membrane. As the membrane undergoes compaction, the structure of the support membrane changes and the pores undergo constriction. This inhibits the flux of water through the membrane and, in turn, results in a larger membrane resistance.

TABLE 3.2
Change in membrane resistance and thickness before and after 24-
hour compaction at 250 psi

| | Rₘ Initial | Rₘ Final | ΔRₘ | δₘ Initial | δₘ Final | Δδₘ |
|---|---|---|---|---|---|---|
| Membrane | (1/m) | (1/m) | (%) | (μm) | (μm) | (%) |
| NF90 | 3.24E+14 | 5.52E+14 | 41 | 59.7 | 47.9 | −25 |
| NF270 | 1.83E+14 | 5.47E+14 | 67 | 55.7 | 42.6 | −31 |

a. Nanocomposite Membrane Results

Size and mobility characteristics of the nanoparticles used to make the nanocomposite membranes in the lab are given below in Table 3.3. The silica particles range in size from approximately 34 nm to 130 nm. The zeolite particles are much larger and are approximately 250-300 nm. Since the membranes were cast based on a mass scale and the zeolite particles are much larger, it is expected that there will be less zeolite particles throughout the porous layer of the support membrane. The zeta potential of the silica particles ranges from −8.9 mV to −27 mV, while both zeolite particles have a zeta potential of around −13 mV. Since ST50 particles have the smallest zeta potential measurements, it would be expected that a membrane doped with ST50 nanoparticles would be the least negatively charged. The other silica particles all have zeta potentials around −26 or −27 mV, but ST-ZL is largest in size so it will have the least charge density, followed by M1040 and then ST20L. The larger the charge density, the more charge per area of particle, and consequently, the more charge that is added to the membrane. Thus, the addition of ST20L nanoparticles should result in a more negatively charged membrane than the addition of M1040 or ST-ZL. Since the OMLTA and LTA zeolites have approximately the same zeta potential, the organic modifications to the LTA did not significantly alter the charge of the particle. The addition of these two particles produces membranes with similar charge.

TABLE 3.3
Nanoparticle Characteristics at a pH of 6 and 10 mM NaCl

| | DLS Diameter | Zeta Potential |
|---|---|---|
| Particle | (nm) | (mV) |
| ST50 | 34 | −8.9 |
| ST20L | 69 | −26 |
| ST-ZL | 130 | −26 |
| M1040 | 120 | −27 |
| LTA | 275 | −15 |
| OMLTA | 275 | −13 |

All of the thin film composite (TFC) membranes with nanocomposite support membranes, except the ST5O-TFC membrane, have a slightly smaller water contact angle than the pure TFC membrane, that is, than the TFC membrane with a pure polysulfone support membrane. This means they are slightly more hydrophilic and should exhibit a higher initial flux. The ST5O-TFC membrane has a little larger contact angle than a TFC membrane on a pure or undoped polysulfone support membrane and, therefore, is more hydrophobic and should have an initial flux that is lower. The zeta potential is smaller for the LTA-TFC than the TFC and only slightly larger with the addition of ST20L particles, but is much larger with the addition of all other particles. Since the nanoparticles themselves are negatively charged, it would follow that with their addition, the membranes become more negatively charged. Since the zeolite particle (LTA) is much bigger than the others, it experiences larger interfacial interactions with the polysulfone. These interfacial interactions can alter the behavior of both the LTA and polysulfone, resulting in a membrane with a smaller electrochemical potential. However, this does not occur with the OMLTA particles that are also large in size. The organic modifications used to create the OMLTA particle appear to be surface modifications. The addition of organic material onto the surface would alter the surface chemistry and its reaction when in contact with polysulfone, explaining the radically different zeta potentials of the OMLTA-TFC and the LTA-TFC.

TABLE 3.4
Nanocomposite thin-film membrane characteristics

| | Contact Angle | Zeta Potential |
|---|---|---|
| Membrane | Pure Water (°) | ζ_{membrane} (mV) |
| TFC | 71 | −8.3 |
| LTA-TFC | 67 | −5.6 |
| OMLTA-TFC | 69 | −14 |
| M1040 | 69 | −12 |
| ST-ZL | 70 | −13 |
| ST20L-TFC | 70.4 | −8.9 |
| ST50-TFC | 72 | −11 |

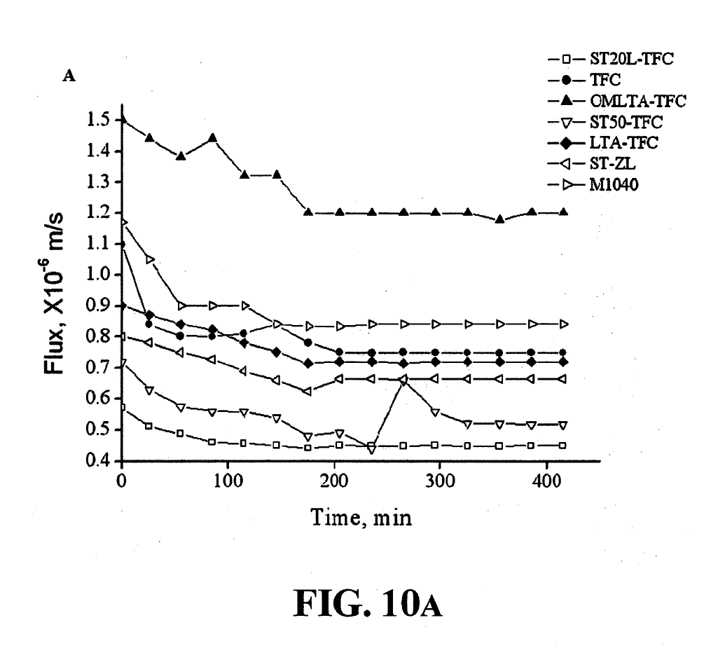

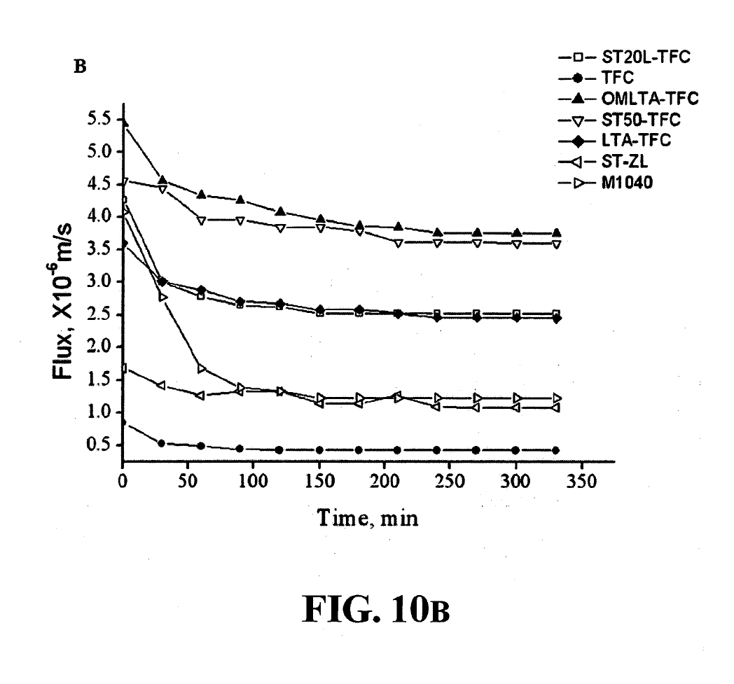

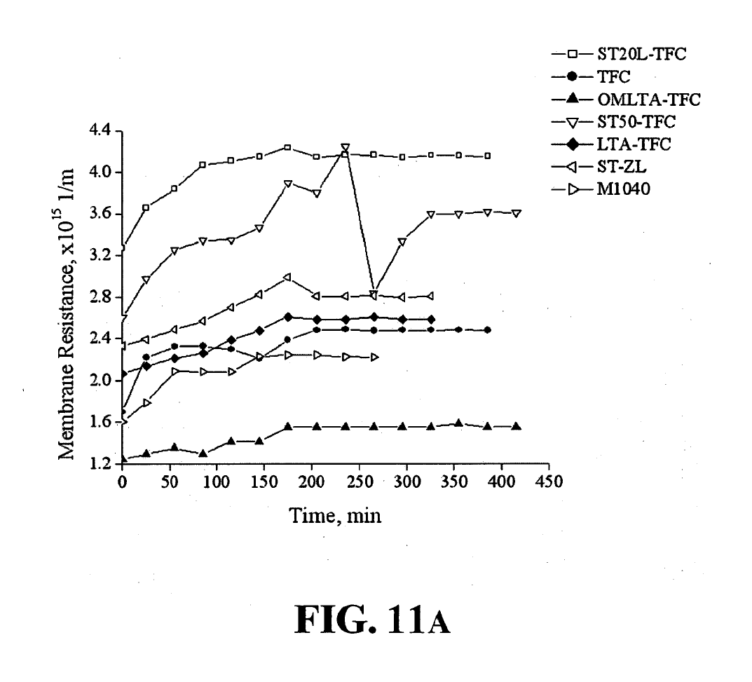

Referring now to FIGS. 10a and 10b, all seven membranes manufactured in the lab were tested under 250 and 500 psi with a feed solution of 10 mM NaCl. At 250 psi, only the OMLTA-TFC and M1040 based nanocomposite RO membranes had larger flows and were more permeable than the pure polysulfone support based RO membrane as shown in FIG. 10a. At 500 psi, however, all 7 nanocomposite membranes exhibit a larger flow and higher permeability as shown in FIG. 10b. As stated above, the membranes made in the lab are typically considered reverse osmosis membranes and typically meant to operate at high pressures. Addition of nanoparticles to the membranes alters support membrane void structure such that the flux performance of the resulting RO membrane (cast over the nanocomposite support) tends to be less than a conventional TFC RO membrane when operating at relatively low pressures. However, at higher pressures, the voids within the support membrane collapse and restrict water flow. Addition of nanoparticles combats this by reducing the number and size of the macrovoids within the support membrane and by filling space with hard, incompressible material, thereby, providing greater overall resistance to compaction. This results in reduced flux decline.

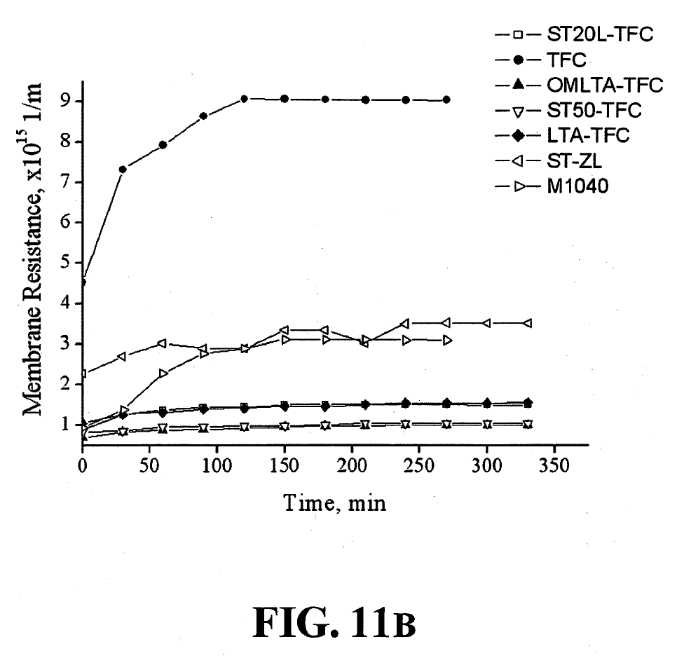

Referring now to FIGS. 11a and 11b, membrane resistance increases with time at both 250 and 500 psi. At 250 psi, resistance varies from highest to lowest in the following manner: ST20L-TFC, ST50-TFC, ST-ZL, LTA-TFC, TFC, M1040, and OMLTA-TFC. The resistance at 500 psi showed a slightly different trend with resistance varying from highest to lowest as follows: TFC, ST-EL, M1040, ST20L-TFC, LTA-TFC, OMLTA-TFC, and ST50-TFC. There was little or no correlation found to exist between measured resistance, or change in resistance, versus the hydrophilicity/hydrophobicity of the membrane or membrane surface charge. Also, there was no correlation found between membrane resistance and size of the nanoparticle added. However, membrane resistance was found to be inversely proportional to permeability. As with the commercial membranes, this can be explained both mathematically and physically. Equation 3.1 shows membrane resistance is inversely related to flux, which is directly related to permeability. Physically, membranes that are more permeable contain more numerous or larger macrovoids. This means a greater possibility of internal fouling and, hence, a larger membrane resistance.

The poor performance at 250 psi, in terms of a higher membrane resistance, of many of the nanocomposites compared to the pure polysulfone TFC can be due to the way the membranes were cast. SEM images show that many of the nanoparticles form clusters within the membrane surface. It has been reported that clustered nanoparticles can exhibit properties even worse than conventional polymer systems. Therefore, one way to lower the membrane resistance of the nanocomposite membranes is to disperse the particles throughout the surface and avoid any clustering.

It should be noted that at 500 psi, all nanocomposites performed better, in terms of having a lower membrane resistance, than the TFC membrane. At higher pressures, voids within the membrane can begin to collapse and restrict water flow. Nanoparticle addition combats this by reducing the size and number of macrovoids within the membrane structure and, thereby, providing it with more strength. Ultimately, this results in less collapsing within the membrane structure, a less restricted pathway for water flow, and a smaller membrane resistance.

At both 250 and 500 psi, rejection increases from the beginning to end of the run time as shown in FIGS. 11a and 11b. The one exception to this trend is the LTA-TFC at 250 psi, in which the membrane was damaged. The rejection performance of the membranes differs, however, between 250 and 500 psi. At 250 psi, the order from highest to lowest rejection is: LTA-TFC, ST-ZL, TFC, OMLTA-TFC, ST5O-TFC, ST20L-TFC, and M1040. At 500 psi, the initial rejection, in order from highest to lowest is: ST50-TFC, TFC, OMLTA-TFC, LTA-TFC, ST20L-TFC, ST-ZL, and M1040. The rejection of M1040 at 500 psi increases much more drastically from the initial to final measurement than any other membrane. SEM images of the M1040 particles show that these particles tend to form more aggregates than any other nanoparticle within the polymer matrix. At a high pressure, the membrane pores collapse, but since the MI040 particles are less disperse, there are more pores to collapse and larger areas of rigid regions than with other particles. The salt cannot pass through the restricted pores of the membrane or through the M1040 particles so rejection is increased. There was little or no correlation found to exist between rejection, or change in rejection, versus membrane surface charge or contact angle. Also, there was no correlation found between rejection and size of the nanoparticle added. There is, however, a very strong linear correlation between the change in membrane resistance, change in flux, and change in membrane rejection as shown in Table 3.5. As the flux decreases and membrane resistance increases, the membrane rejection increases. This trend can be explained mechanistically. As previously discussed, under pressure, both the thin film and support layers compact, restricting the pores. It is this restriction that causes a decrease in flux and increase in resistance. Similarly, as the pore size becomes smaller, the membrane rejection improves.

TABLE 3.5
Correlation factors of membrane rejection versus resistance and
flux at both (a) 250 and (b) 500 psi
(a)

| | Rm, 1/m | | ΔRₘ | | | ΔJ |
|---|---|---|---|---|---|---|
| Membrane | Start | End | (%) | Start | End | (%) |
| ST20L- | 3.32E+15 | 4.22E+15 | 27 | 5.73E−07 | 4.49E−07 | −28 |
| TFC | | | | | | |
| TFC | 1.73E+15 | 2.52E+15 | 46 | 1.10E−06 | 7.50E−07 | −47 |
| OMLTA- | 1.26E+15 | 1.57E+15 | 24 | 1.50E−06 | 1.20E−06 | −25 |
| TFC | | | | | | |
| ST50-TFC | 2.63E+15 | 3.65E+15 | 39 | 7.21E−07 | 5.19E−07 | −39 |
| LTA-TFC | 2.09E+15 | 2.62E+15 | 25 | 9.01E−07 | 7.21E−07 | −25 |
| ST-ZL | 2.36E+15 | 2.84E+15 | 20 | 8.01E−07 | 6.65E−07 | −21 |
| M1040 | 1.63E+15 | 2.26E+15 | 39 | | | |

(b)

| | Rm, 1/m | | ΔRₘ | J, m/s | | ΔJ |
|---|---|---|---|---|---|---|
| Membrane | Start | End | (%) | Start | End | (%) |
| ST20L- | 8.98E+14 | 1.51E+15 | 41 | 4.27E−06 | 2.52E−06 | −69 |
| TFC | | | | | | |
| TFC | 4.57E+15 | 9.10E+15 | 50 | 8.42E−07 | 4.21E−07 | −100 |
| OMLTA- | 7.02E+14 | 1.01E+15 | 31 | 5.44E−06 | 3.76E−06 | −45 |
| TFC | | | | | | |
| ST50-TFC | 8.36E+14 | 1.06E+15 | 21 | 4.56E−06 | 3.60E−06 | −27 |
| LTA-TFC | 1.06E+15 | 1.56E+15 | 32 | 3.60E−06 | 2.45E−06 | −47 |

The above tables show that the addition of nanoparticles aide in flux reduction at higher pressures, but the question still remains as to if this improvement is a result of increased stability. Cross-section SEM images of virgin and compacted membranes are shown in the following figures. Although the exact measured thickness is dependent upon the location the SEM image was taken, these images clearly demonstrate that membranes containing nanoparticles remain at relatively the same thickness after compaction, while the pure polysulfone membrane experiences a much more drastic change in thickness. Hence, the addition of amorphous silica and zeolite nanoparticles results in increased mechanical stability and, therefore, less physical compaction of the membrane.

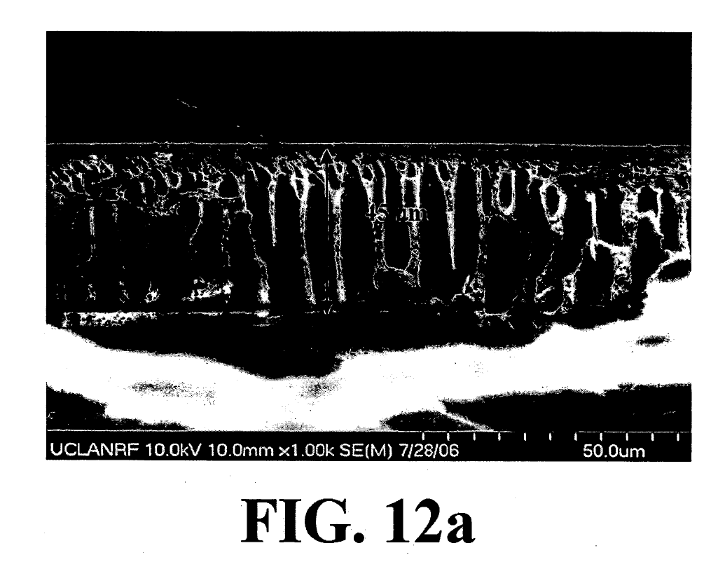

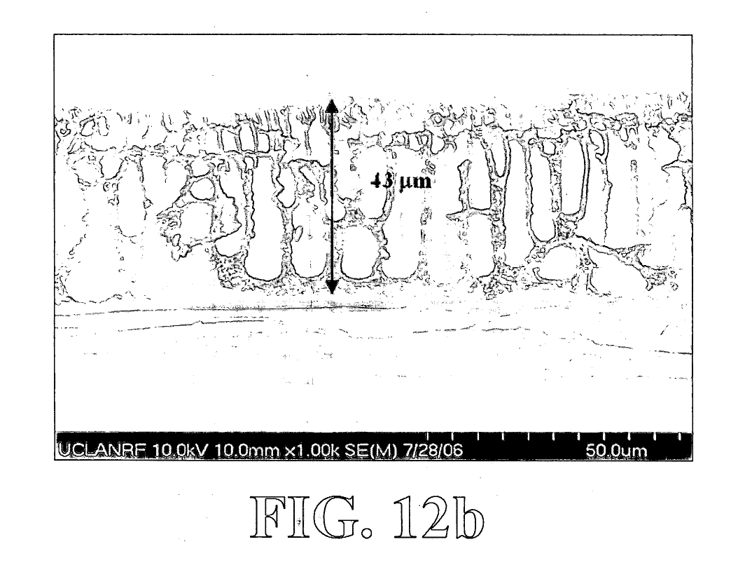

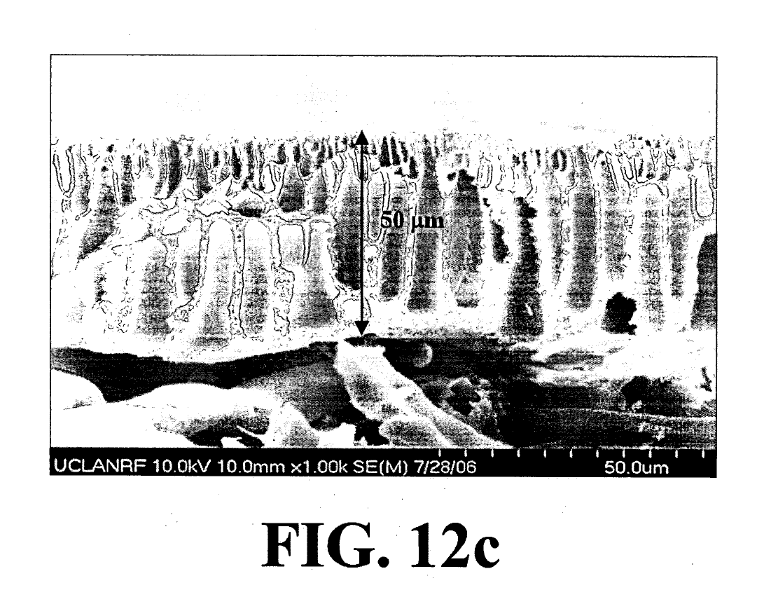

Referring now generally to FIGS. 12a-c through 18a-c, and in particular to FIGS. 12a-c, SEM images of the pure polysulfone TFC membrane are shown. The uncompacted SEM image, as expected, shows a membrane with many straight-through, asymmetric pores. Although the freeze-fracture for the membrane tested at 250 psi was not completely clean, this membrane is still visibly thinner than the uncompacted TFC membrane. The pore structure at 250 psi is not noticeably different from the uncompacted membrane, but the membrane compacted at 500 psi has a porous structure which is visibly more narrow than the virgin membrane.

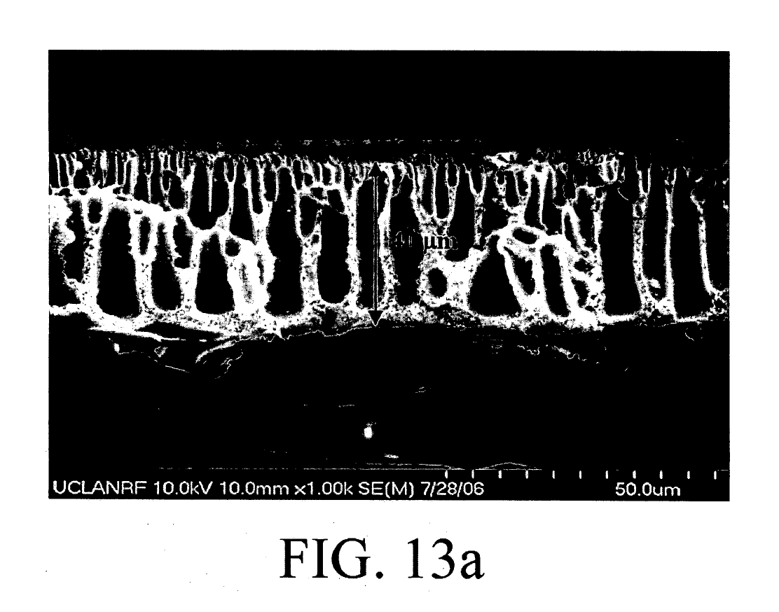

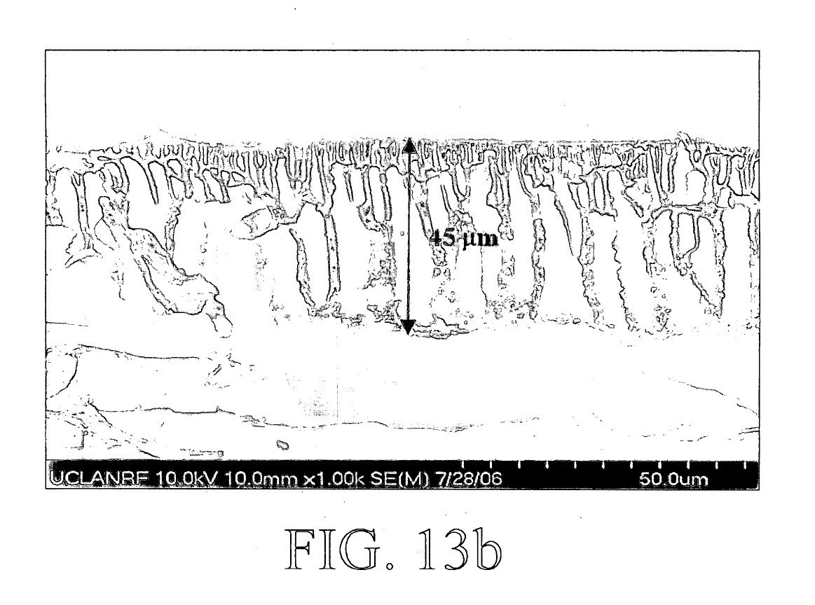

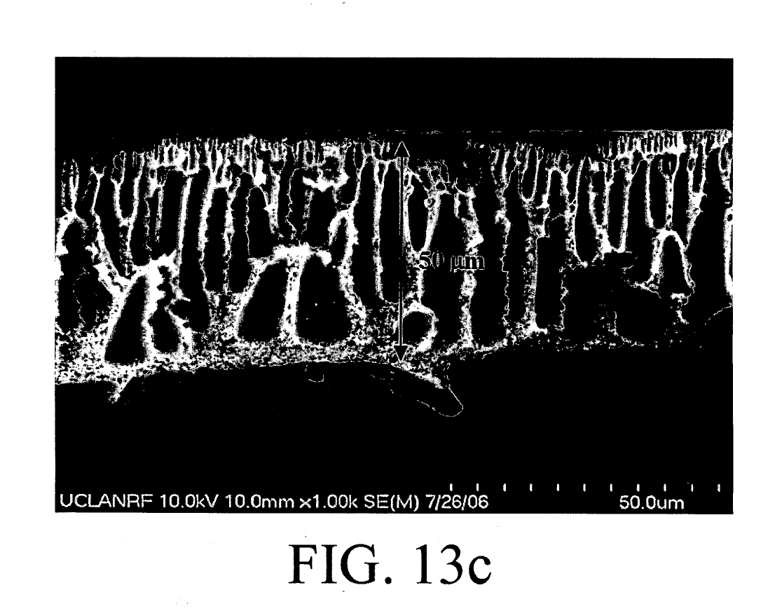

Referring now in particular to FIG. 13, the uncompacted ST20L-TFC has a structure similar to that of the uncompacted TFC. After both an applied pressure of 250 and 500 psi, there is no real noticeable difference between the structure of the pure and the compacted membranes.

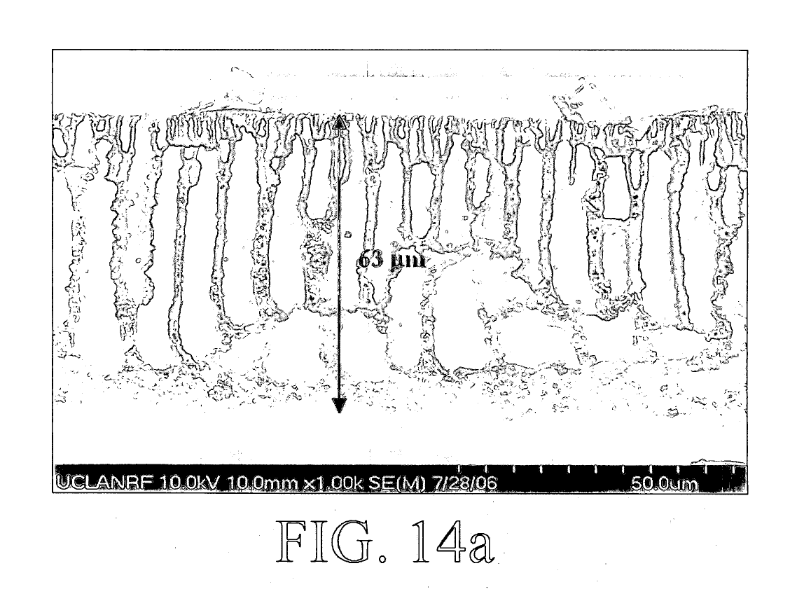

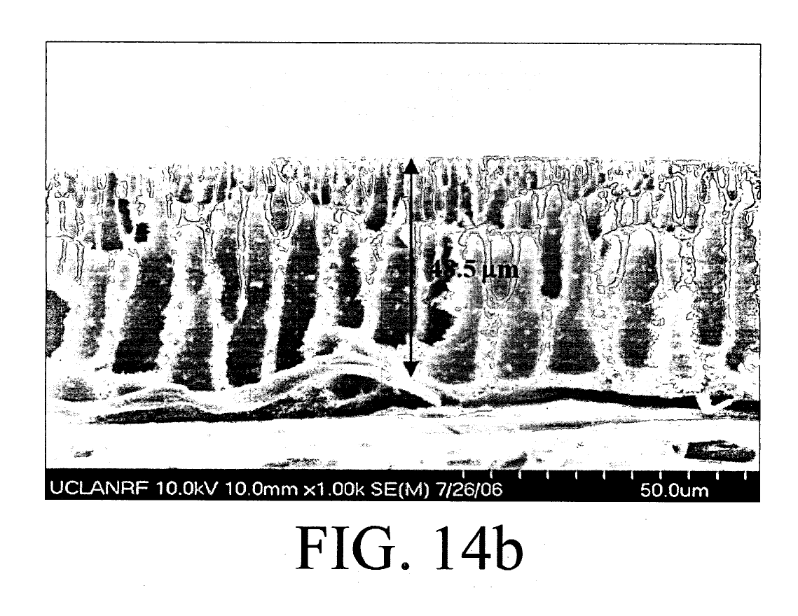

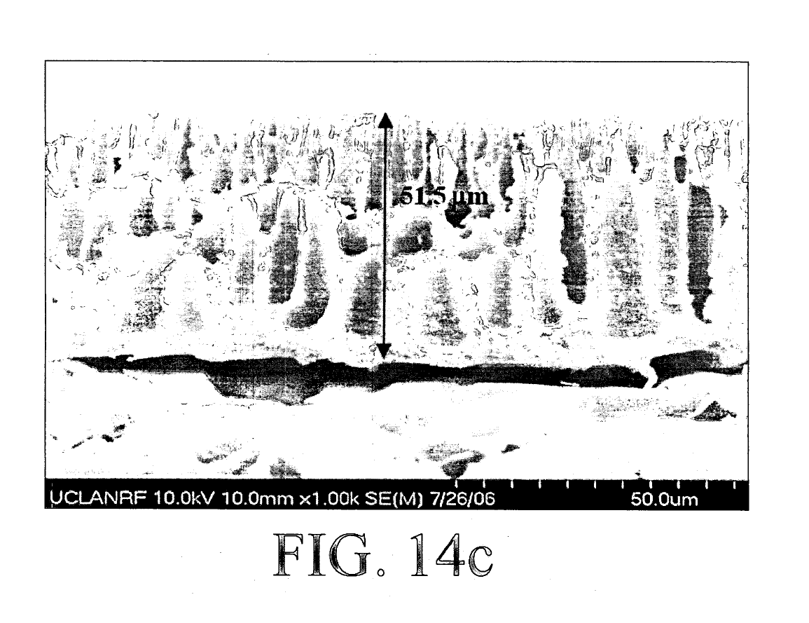

Referring now to FIG. 14, the LTA particles are fairly large and can be seen dispersed throughout the support structure as shown. Although the support membrane appears larger after 500 psi of pressure, this is a function of the location of the SEM image and not a special phenomena. All three images in FIG. 14 appear to have similar structures, supporting the hypothesis that the addition of nanoparticles will limit the change in membrane structure caused by compaction. Once again, the problem of the support material and its inability to freeze-fracture cleanly is evident in these images.

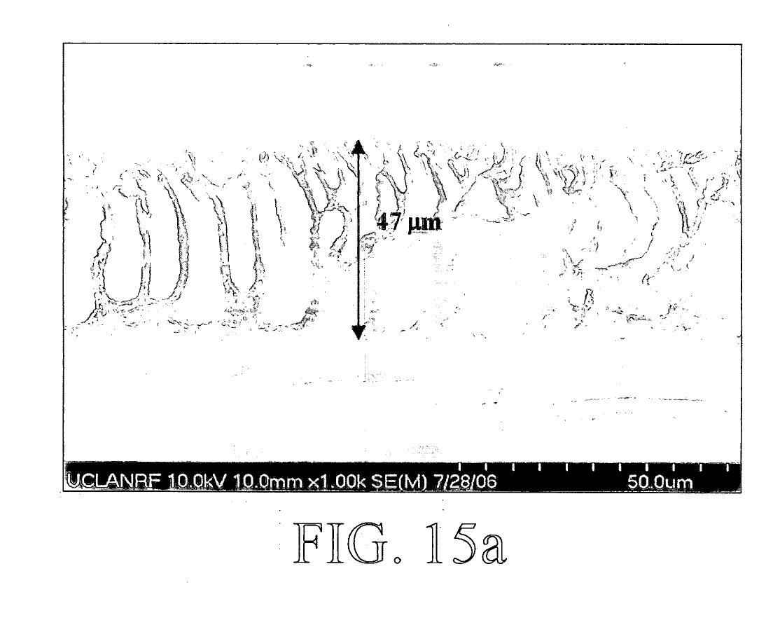

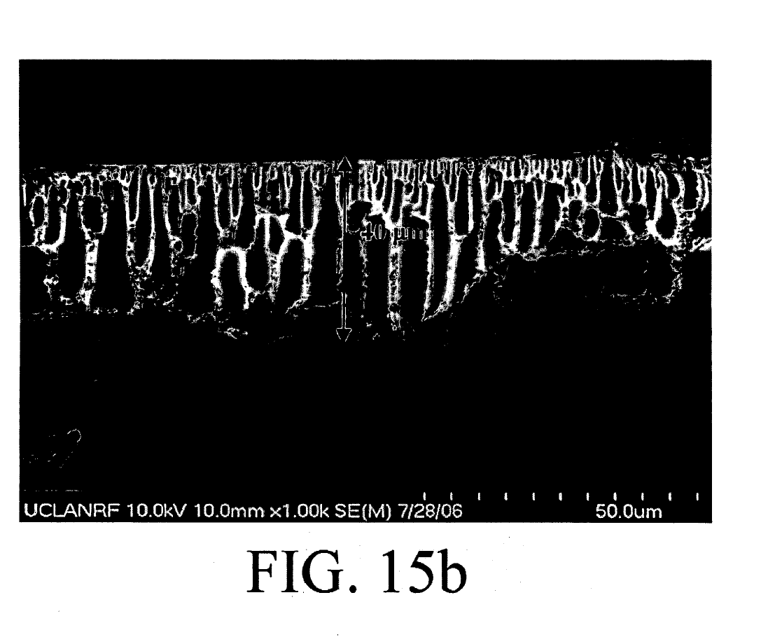

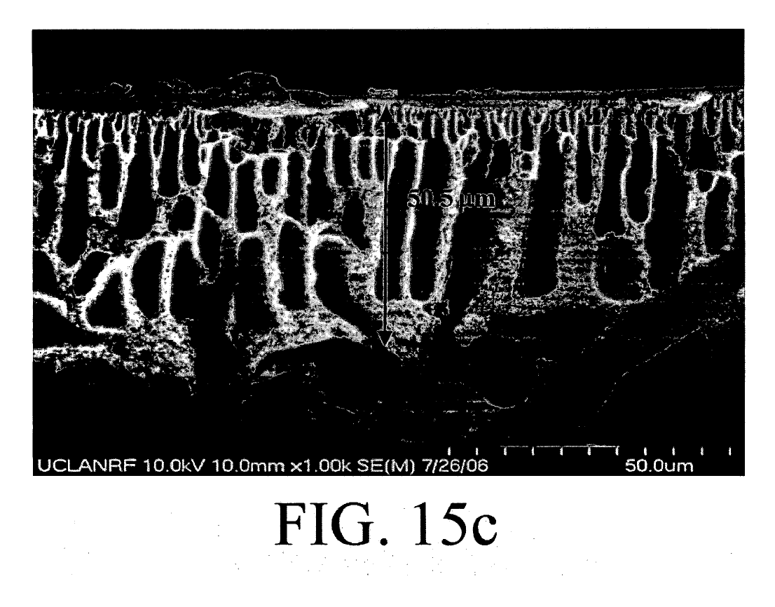

Referring now to FIGS. 15a-c, the figures show that after operation at 250 psi, the M1040 membrane has a porous structure that is curved and no longer straight. This is not the case at 500 psi, however. The M1040 particles formed aggregates inside the membrane that was tested at 250 psi. As discussed above, this can weaken the membrane structure and, hence, cause more structural damages than the pure TFC membrane. Aggregation was not a problem in the membrane tested at 500 psi and it performed just as well as the other nanoparticles.

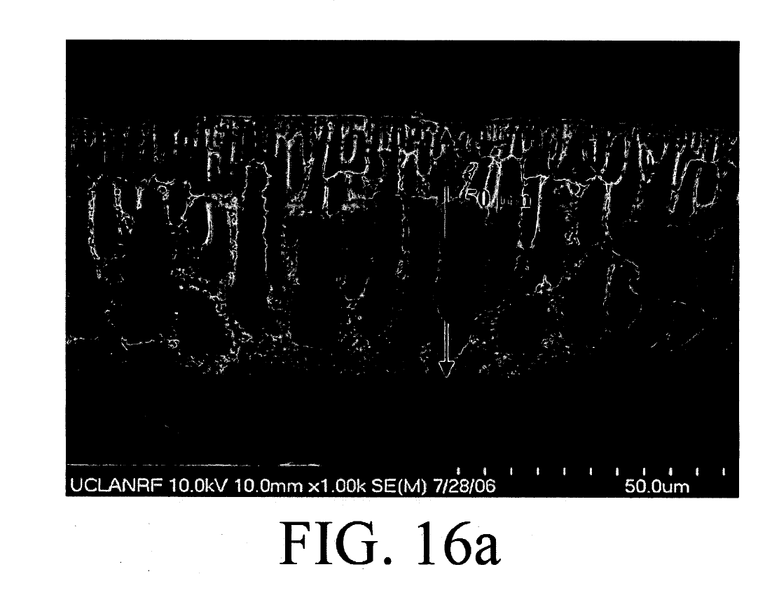

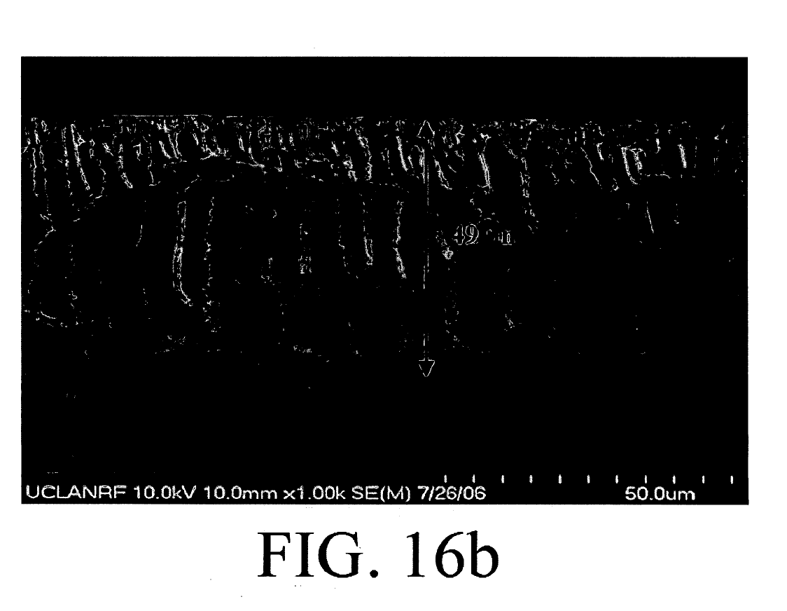

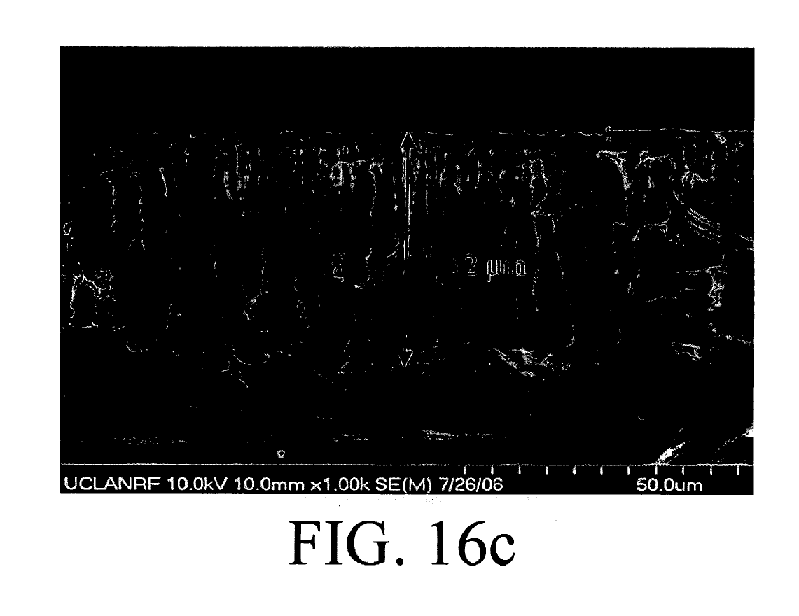

Referring now to FIG. 16 the SEM images of the ST50L-TFC membrane are shown. All three support structures look very similar, supporting that hypothesis that adding nanoparticles helps limit the effect of compaction. The nanoparticles can be seen in the images and are well dispersed throughout the support layer.

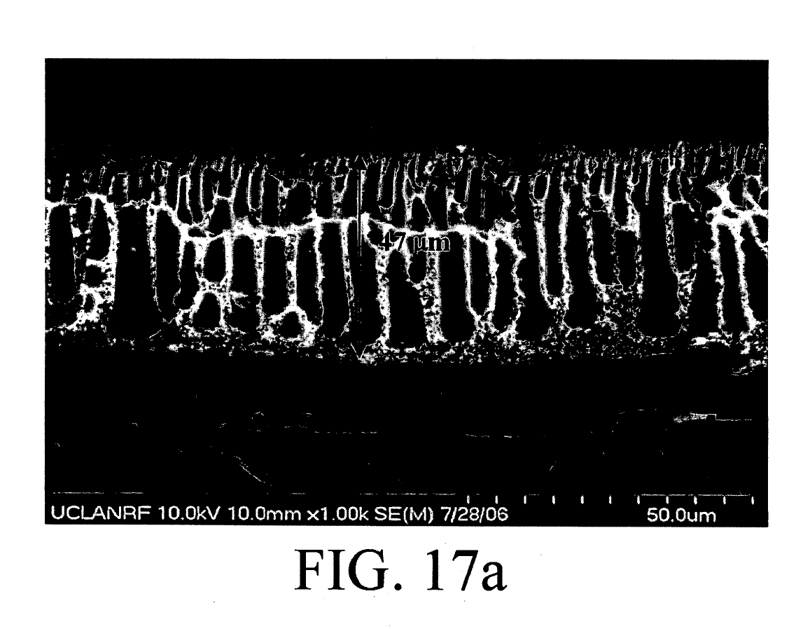

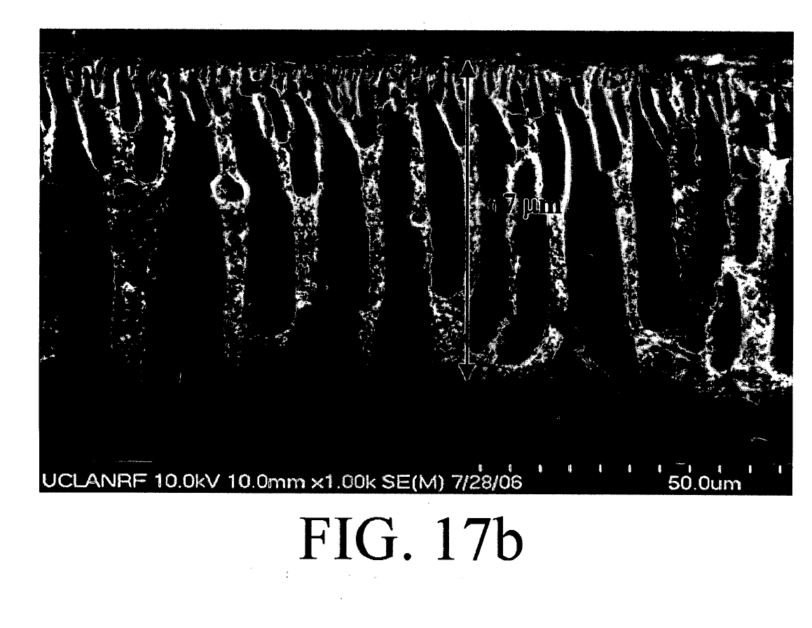

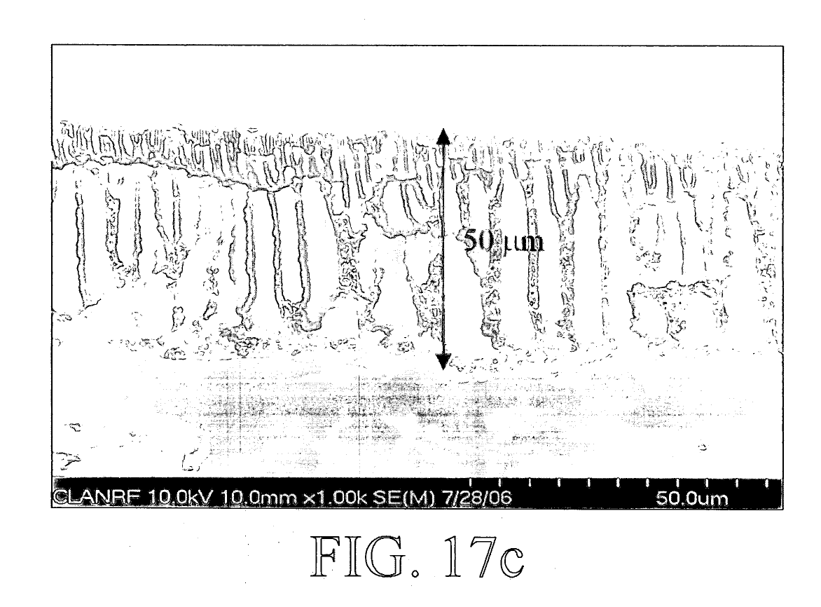

Referring now to FIG. 17, the ST-ZL membranes appear to maintain similar structures before and after compaction. The pores in both the virgin and compacted membranes are straight-through pores. The larger measured thickness in part b is function of where the image was taken on the membrane.

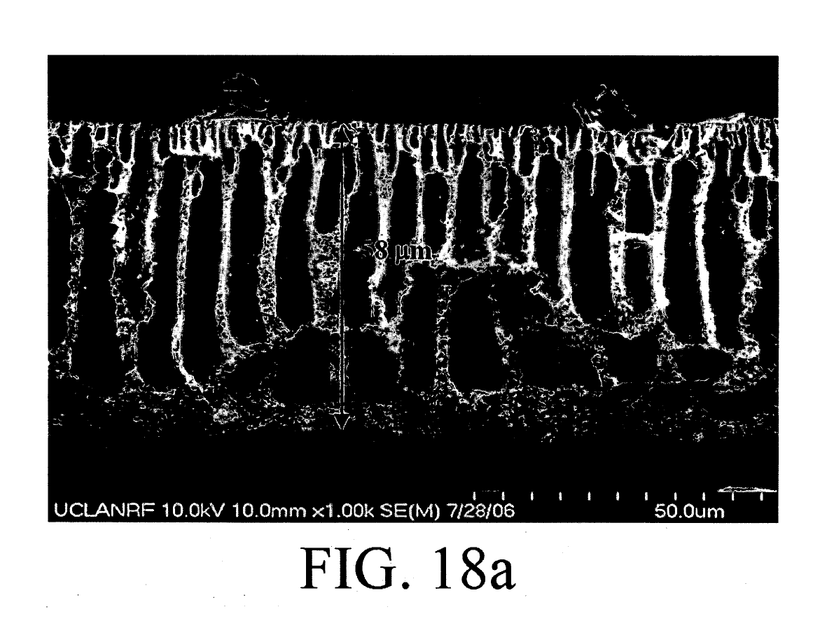

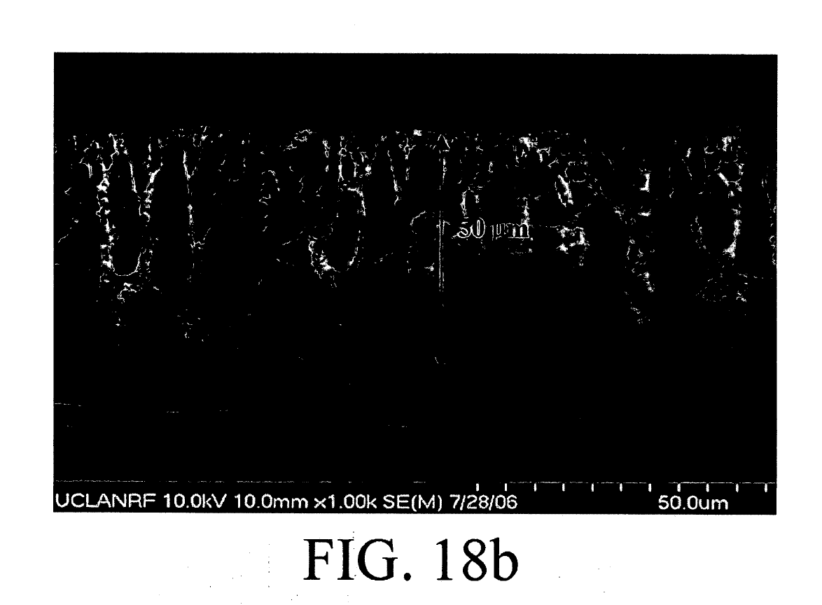

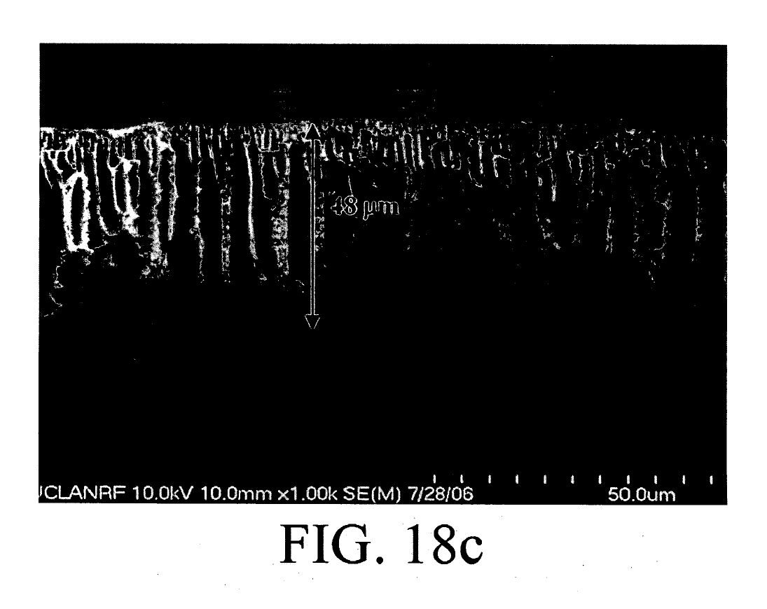

Referring now to FIG. 18, SEM images of OMLTA-TFCs are shown. Similarly to the LTA images, the OMLTA particles can be seen within the support structure due to their vast size. The 250 psi and uncompacted membranes have the same structure. The membrane compacted under 500 psi has the same membrane structure, but appears slightly different because the structure was damaged during preparation for SEM imaging.

All the membranes containing nanoparticles appear to have similar structures before and after compaction, while the TFC images show a noticeably smaller porous structure. This supports the hypothesis that addition of nanoparticles helps to reduce compaction.

b. Conclusions

Reverse osmosis is a process with the potential to address current and future water shortages. It would allow for the treatment and usage of untapped water sources. However, certain limitations, such as concentration polarization, surface fouling, and internal fouling, prevent the wide-scale economical usage of this technology. This study uses innovative nanoparticles added to the support membrane to create thin-film nanocomposite membranes to attempt at reducing the effect of internal fouling. The following conclusions were made based on membrane testing in a cross-flow, two cells in parallel system:
1) Addition of dispersed nanoparticles to the support membrane results in less flux decrease after pressurization when compared to a pure polysulfone membrane.
2) Cross-section SEM images strongly support the hypothesis that addition of nanoparticles to the support membrane leads to increased resistance to physical compaction and combats long-term, irreversible fouling.
3) Cross-section SEM of pure polysulfone support membranes before and after compaction shows changes in the void structure, while the thin-film nanocomposites maintain their original structure. Since the nanoparticles fill the macrovoids of pure polysulfone membranes, the hypothesis that compaction occurs due to the collapse of macrovoids within the membrane structure is supported.

The conclusions of this study have many implications. The first major effect this study can have on the membrane community is in the membrane material design and manufacturing. To minimize the effects of compaction, materials that are rigid should be used to design future membranes. During the manufacturing and production of these membranes, a process should be used which creates the least amount of micro/macro voids. Altering the chemistry and composition in which the membranes are cast has a major effect on the amount of voids produced and, hence, on the extent of compaction.

Secondly, this study indicates that the present membrane process design can not be ideal. Currently, as flux declines, pressure is increased, causing greater internal fouling and an even greater requirement for more pressure. This further damages the membrane and decreases its life. Since membrane compaction levels off at a given pressure, a better solution can be to operate at constant pressure and allow the flux to decline but add additional membrane area online as the internal fouling progresses until it reaches its steady-state value. Also, as the cost of energy increases, it can be a more economical to add more membrane area over constantly increasing the pressure.

A major drawback of seawater desalination is its cost. The use of nanocomposite TFC membranes, that is, TFC membranes with nanocomposite support layers can help to significantly reduce this cost. The largest factor contributing to cost in membrane processes is energy usage. Since nanocomposite in support layers in TFC membranes appear to reduce compaction, less energy is required, hence reducing cost. Nanocomposite support layers in TFC membranes can revolutionize water treatment processes by making it economical for seawater desalination.

### F. Enhanced Nanocomposite Membranes

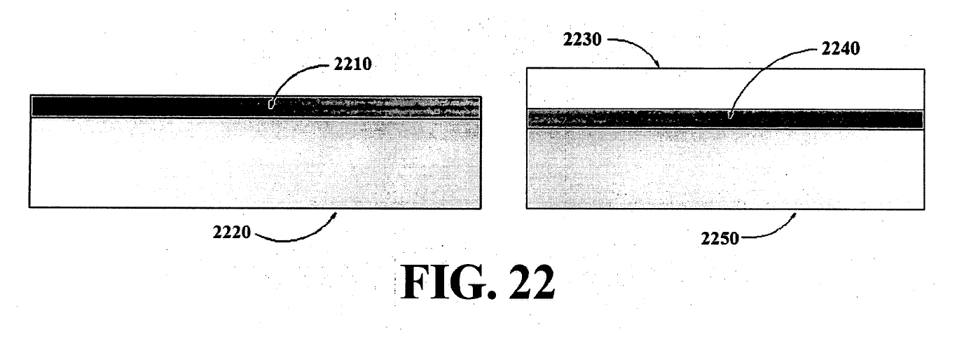

While conventional composite membranes, such as TFC membranes, typically have a support layer and a polymer matrix layer, and, optionally, a hydrophilic layer, such membranes lack nanoparticles. Thus, conventional composite membranes lack at least one of the features of the disclosed membranes. With reference to FIG. 22, for example, a conventional composite membrane typically comprises a support layer 2200 with a polymer matrix film thereon. A conventional composite membrane can also comprise a coating later. Referring again to FIG. 22, a composite membrane can comprise a support layer 2250 with a polymer matrix 2240 thereon, further comprising a coating layer 2230 on the polymer matrix. In contrast, the disclosed membranes are augmented by the selection and the addition of nanoparticles to achieve, for example, flux enhancement, selectivity control, compaction resistance, and/or fouling resistance.

1. Low Flux Loss High-Pressure Reverse Osmosis Membrane Filtration

Permeability can be defined as water flux at a given applied pressure. Conventional reverse osmosis membranes are known to lose permeability when exposed to hydraulic pressures greater than 10 bars (approximately 145 psi). It has been observed that hydraulic pressure, over time, measurably reduces the support membrane thickness, and that the relative decrease in thickness and permeability loss are directly proportional to the applied pressure. Thus, it is generally believed that this pressure leads to physical compaction of macro-voids and micro-voids throughout the skin layer of the support membrane, thereby decreasing permeability in a composite membrane.

Irreversible, internal fouling of reverse osmosis (RO) and nanofiltration (NF) composite membranes by physical compaction is of major concern in membrane processes because of the sponge-like morphology of the porous supports on which they are cast. While not wishing to be bound by theory, it is believed that membrane compaction occurs when macrovoids collapse in the porous support layer due to excessive applied pressures; this pressure drop then causes a reduction in size of the support layer voids, thereby reducing the net permeability through the entire membrane cross-section.

At elevated feed water pressures, polymeric membranes can be damaged internally by physical compaction, which can be referred to as “internal fouling.” Elevated pressures can become necessary for RO and NF membrane processes and can increase with time due to fouling, which occurs on the membrane surface. Surface fouling, and the resulting higher operating pressures, leads to additional physical compaction of the membrane. Compaction, in turn, can require even higher operating pressures to achieve a desired flux. Although surface deposits that lead to elevated operating pressure can be removed by physical and chemical cleaning methods, internal fouling at high pressures cannot be reversed. Such irreversible fouling of NF or RO membranes can also lead to higher long-term operating pressures, and thus, higher operating cost and more fossil fuel consumption.

The disclosed membranes, in contrast to conventional composite membranes, can reduce operating costs and environmental impact of membrane desalination processes through minimization of both short term (surface) and long term (internal) fouling of NF and RO membranes. This can be achieved by using nanoparticles, dispersed for example in the support layer, to minimize the loss of intrinsic water permeability through a reverse osmosis (RO) membrane by minimizing physical compaction of the support membrane structure by the high hydraulic pressures applied in desalination processes. An advantage of the disclosed membranes is the ability to maintain high permeability (energy efficiency) at high-applied pressures, such as can be used in reverse osmosis membrane based seawater desalination processes.

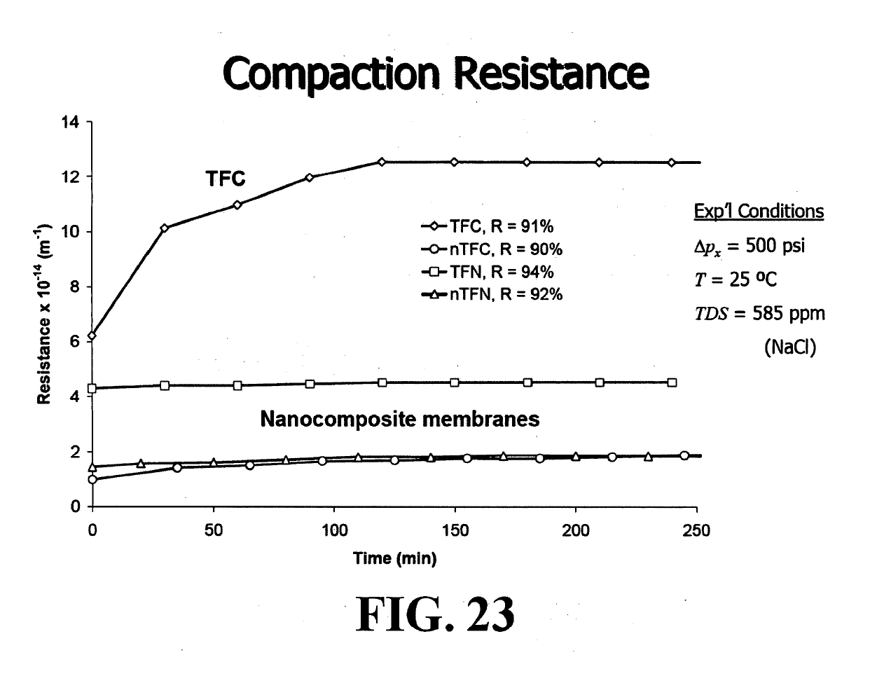

If a membrane material is compressible, the flux will decline with time when filtering pure water or a simple salt solution. In experiments, the flux decline with time for a constant applied pressure was measured, but the data is presented in the form of increasing membrane resistance, assume no change in viscosity. See FIG. 23. In the figure, TFC refers to thin film composite; nTFC refers to TFC coated over nanocomposite PSf support; TFN refers to thin film nanocomposite membrane (nanoparticles are part of the polyamide thin film); nTFN refers to TFN coated over nanocomposite PSf support

All three nanocomposite membranes have small intrinsic hydraulic resistance at time zero. This is desirable, because lower resistance indicates less pressure to achieve a desired flux. The TFC membrane (pure polymer, no nanoparticles) resistance increases exponentially over a few hours, finally leveling off at a value that is double its initial resistance. The membrane is then half as permeable as it was at time zero; thus, the energy required to force water through the membrane is doubled.

The nanocomposite membranes suffer very little (nTFC) or no (TFN/nTFN) increase in hydraulic resistance. This observation is significant because it is conventionally assumed that the bulk of the increased resistance comes from compaction of the porous support membrane matrix. Clearly, nTFC membranes (normal thin film coated over a nanocomposite support) suffer much less compaction than TFC membranes, but there is a small amount of compaction (increase in resistance) still observed. However, TFN and nTFN membranes suffer no increased resistance due to compaction. This is contrary to generally accepted theory and indicates that compaction is also related to the thin film.

Plotted in FIG. 23 are intrinsic hydraulic resistances for four different RO membranes tested at 500 psi with a 585 ppm NaCl feed solution at unadjusted pH of ˜5.8. Observed rejections are all greater than 90 percent, which indicates they can function as RO membranes. The intrinsic hydraulic resistance is the inverse of a Darcy permeability coefficient, where Darcy's law is given as

$$u = \frac{k}{μ} \frac{d p}{d x}$$

where u is a velocity, k is the Darcy permeability, μ is the solution viscosity, dp is the differential hydraulic pressure, and dx is the distance of fluid transport (or the active membrane thickness). For a membrane, this Darcy's law relationship is typically written as

$${J}_{v} = \frac{Δ p}{μ {R}_{m}}$$

where Jv is a volumetric flux (m³-water/m²-membrane/s, which is a velocity; m³/m²·s=m/s) and Rm represents the combination of a Darcy permeability and membrane active layer thickness.

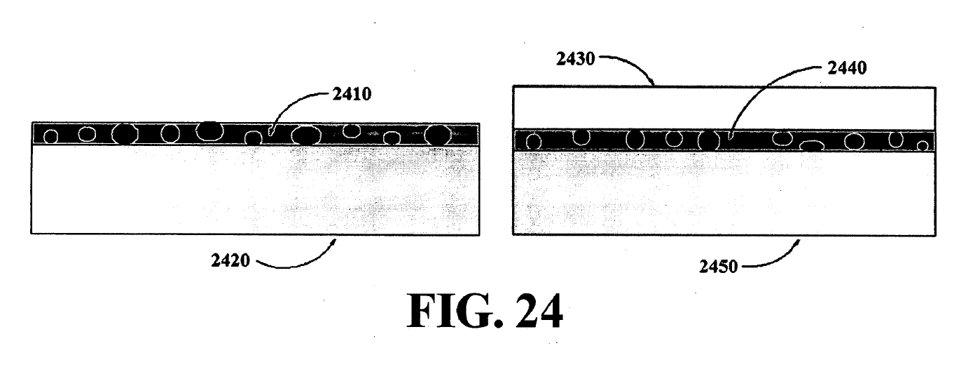

Thus, flux loss due to “fouling” or “compaction” can be addressed by including nanoparticles in the polymer matrix layer. Thus, disclosed are polymer matrix membranes with nanoparticles dispersed therein, wherein the membrane exhibits less loss of flux per time than a comparable polymer matrix membrane lacking nanoparticles. With reference to FIG. 24, for example, a polymer matrix membrane can comprise a support layer 2420 with a polymer matrix film 2410 with nanoparticles dispersed therein. The membrane can have a pure water contact angle of less than 90°. The membrane can have a pure water flux of at least 0.02 gallons per square foot of membrane per day per pound per square inch of applied pressure.

In one aspect, the membrane is prepared by adding nanoparticles to a mixture with one or more monomers, the nanoparticles and the one or more monomers in the mixture interacting when polymerized to form a hydrophilic polymer matrix in which the nanoparticles are dispersed; and polymerizing the mixture on a porous support to form a film composite membrane.

The nanoparticles used in the membrane can be selected from nanoparticles known by those of skill in the art and, in particular, can be selected from the nanoparticles disclosed herein. Suitable nanoparticles include metals and metal oxides, amorphous or crystalline inorganic particles, including silica, alumina, clay, and zeolites, carbon nanotubes, and carbon black. Further suitable nanoparticles include zeolites LTA, RHO, PAU, and KFI for addition to the thin film if an RO membrane with good salt rejection is desired (generally, zeolites comprised of 8-member ring structures, but with three-dimensional framework structures that give pore dimensions of 3-5 Angstroms), whereas a nanofiltration membrane can be made from numerous zeolites such as MFI and FAU comprised of 10-member, 12-member, or greater rings structures that give pore dimensions larger than 3-5 Angstroms. Mixtures of nanoparticles can also be used, for example, where the nanoparticles are selected independently for their individual ability to impart different performance enhancements or where the nanoparticles are selected collectively for synergistic performance improvements.

In one aspect, the nanoparticles and the mixture are selected so that the membrane is substantially more permeable to water as a result of the nanoparticles therein. For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein. In a further aspect, the nanoparticles are selected so that the membrane has less negative surface charge as a result of the nanoparticles therein.

The membrane can optionally have a cross-linked hydrophilic coating on the polymer matrix film. Typically, the composite membrane with the optional hydrophilic coating is at least as permeable as a comparable composite membrane with a hydrophilic coating and without the nanoparticles. As disclosed herein, the hydrophilic layer can be, for example, a cross-linked hydrogel or a covalently-bonded hydrophilic polymer, such as polyvinyl alcohol. The optional hydrophilic coating can be at least one of polyvinyl alcohol, polyvinyl pyrrole, polyvinyl pyrrolidone, hydroxypropyl cellulose, polyethylene glycol, saponified polyethylene-vinyl acetate copolymer, triethylene glycol, or diethylene glycol or a mixture thereof. Particularly suitable is crosslinked polyvinyl alcohol.

In one aspect, the hydrophilic coating is present and the nanoparticles in the polymer matrix film are hydrophobic nanoparticles, thereby providing the membrane having a greater solute rejection than a comparable composite membrane lacking nanoparticles in the polymer matrix film or a comparable composite membrane having hydrophilic nanoparticles in the polymer matrix film. The solute can be, for example, a salt or its constituent ions.

As disclosed herein, the polymer matrix layer can be provided by interfacial polymerization, to provide, for example a polyamide. Suitable monomers include m-phenylenediamine and trimesoyl chloride. The film can be provided by polymerizing on the porous support having a thickness on the order of about the size of the selected nanoparticles.

The disclosed membranes can be used in a method of water purification by applying greater than about 250 psi of pressure to a water solution having at least one solute, the solution positioned on one side of a polymer matrix membrane with nanoparticles dispersed therein so that the membrane is substantially more permeable to water as a result of the nanoparticles therein; and collecting purified water on another side of the membrane, wherein the membrane exhibits less loss of flux per time than a comparable polymer matrix membrane lacking nanoparticles. The pressure can be, for example, greater than about 300 psi, about 400 psi, about 500 psi, or about 600 psi. In one aspect, the pressure can be up to about 1200 psi.

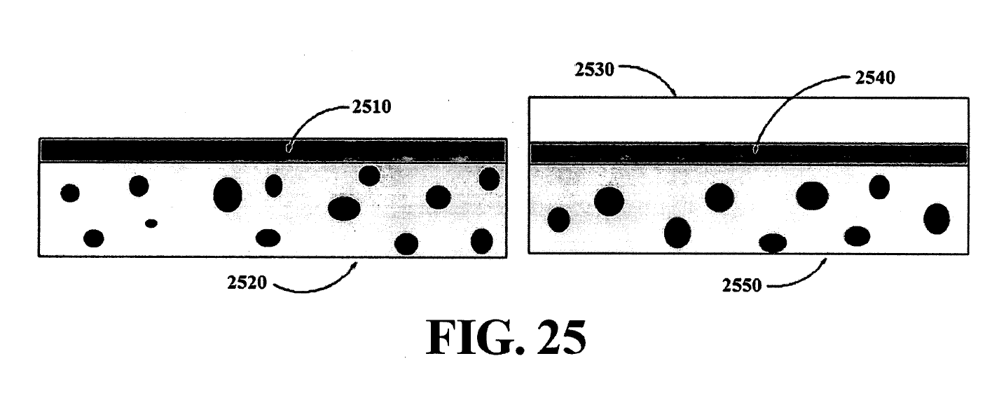

Additionally, flux loss due to “fouling” or “compaction” can be addressed by including nanoparticles in the support layer. Thus, disclosed are composite membranes having a polymer matrix film polymerized on a porous support, wherein the support has nanoparticles dispersed therein, and wherein the membrane exhibits greater compaction resistance than a comparable composite membrane lacking nanoparticles in the porous support. With reference to FIG. 25, for example, a composite membrane can have a support layer 2520 with nanoparticles dispersed therein and a polymer matrix film 2510 thereon. As shown in FIGS. 10 and 11, these membranes are more permeable than conventional membranes, using either porous or nonporous nanoparticles. Without wishing to be bound by theory, it is believed that the compaction resistance due to the inclusion of nonporous nanoparticles is due to preventing “instantaneous compaction” occurring upon initial applied pressure.

A disclosed membrane can have a pure water contact angle of less than 90°. The membrane can have a pure water flux of at least 0.02 gallons per square foot of membrane per day per pound per square inch of applied pressure.

Typically, nanoparticles selected for use in this aspect are hard and/or inorganic; inclusion of such nanoparticles can result in less reduced flux over time and/or less reduction in membrane thickness.

The nanoparticles used in the membrane can be selected from nanoparticles known by those of skill in the art and, in particular, can be selected from the nanoparticles disclosed herein. Suitable nanoparticles include metals and metal oxides, amorphous or crystalline inorganic particles, including silica, alumina, clay, and zeolites, and carbon black. Further suitable nanoparticles include zeolites LTA, RHO, PAU, and KFI for addition to the thin film if an RO membrane with good salt rejection is desired (generally, zeolites comprised of 8-member ring structures, but with three-dimensional framework structures that give pore dimensions of 3-5 Angstroms), whereas a nanofiltration membrane can be made from numerous zeolites such as MFI and FAU comprised of 10-member, 12-member, or greater rings structures that give pore dimensions larger than 3-5 Angstroms. Mixtures of nanoparticles can also be used, for example, where the nanoparticles are selected independently for their individual ability to impart different performance enhancements or where the nanoparticles are selected collectively for synergistic performance improvements.

In one aspect, the membrane is prepared by forming a porous support from a mixture of nanoparticles and a polymeric material and polymerizing a polymer matrix film on the porous support to form a composite membrane. The porous support can be provided by dispersion casting a layer from a dispersion of selected nanoparticles in a polymer “solution” of support polymers disclosed herein, for example, polysulfone. Typically, the dispersion is prepared by selecting nanoparticles and polymer at a concentration in a liquid wherein the dispersion shows substantially no precipitation of the polymer and substantially no aggregation of the nanoparticles. This can be evaluated by measuring the turbidity of the dispersion and/or by measuring the average particles size of the nanoparticles in the dispersion. The measurements can then be compared to the turbidity of a solvent without polymer and/or nanoparticles.

Preparation of a support layer by dispersion casting (alternatively, immersion-precipitation or non-solvent-induced phase inversion) can be accomplished by pouring an aliquot of the polymer-nanoparticle-solvent dispersion onto a surface and removing the solvent. Increased temperature and/or reduced pressure can facilitate removal. The use of a non-solvent (a solvent with low affinity for the polymer) can be particularly effective in providing the support layer.

As disclosed herein, the polymer matrix layer can be provided by interfacial polymerization, to provide, for example a polyamide. Suitable monomers include m-phenylenediamine and trimesoyl chloride. The film can be provided by polymerizing on the porous support having a thickness on the order of about the size of the selected nanoparticles.

The membrane can optionally have a cross-linked hydrophilic coating on the polymer matrix film. Typically, the composite membrane with the optional hydrophilic coating is at least as permeable as a comparable composite membrane with a hydrophilic coating and without the nanoparticles. As disclosed herein, the hydrophilic layer can be, for example, a cross-linked hydrogel or a covalently-bonded hydrophilic polymer, such as polyvinyl alcohol. The optional hydrophilic coating can be at least one of polyvinyl alcohol, polyvinyl pyrrole, polyvinyl pyrrolidone, hydroxypropyl cellulose, polyethylene glycol, saponified polyethylene-vinyl acetate copolymer, triethylene glycol, or diethylene glycol or a mixture thereof. Particularly suitable is crosslinked polyvinyl alcohol.

In one aspect, the hydrophilic coating is present and the nanoparticles in the polymer matrix film are hydrophobic nanoparticles, thereby providing the membrane having a greater solute rejection than a comparable composite membrane lacking nanoparticles in the polymer matrix film or a comparable composite membrane having hydrophilic nanoparticles in the polymer matrix film.

The disclosed membranes can be used in a method of water purification by applying greater than about 250 psi of pressure to a water solution having at least one solute, the solution positioned on one side of a composite membrane having a polymer matrix film polymerized on a porous support, wherein the support has nanoparticles dispersed therein; and collecting purified water on another side of the membrane, wherein the membrane exhibits less loss of flux per time than a comparable composite membrane lacking nanoparticles in the porous support. The pressure can be, for example, greater than about 300 psi, about 400 psi, about 500 psi, or about 600 psi. In one aspect, the pressure can be up to about 1200 psi.

2. Hydrophilic and Antimicrobial Nanocomposite Coating Films

Antimicrobial coating films can be included as a layer on the disclosed membranes by dispersing antimicrobial nanoparticles within cross-linked hydrophilic coating polymer films, where the nanocomposite coating film imparts fouling and/or infection resistance to the membrane.

While membrane processes are among the most important and versatile treatment technologies available to environmental engineers, biofouling can limit use and increase the cost of water treatment membrane processes when conventional composite membranes are employed. From the analysis of factors affecting the biofouling process, interference with initial attachment is potentially the most promising, economic, and environmentally benign option. Hydrophilic and smooth interfaces best resist adhesion, especially where hydrophilicity derives from uncharged, monopolar electron-donor functionality. However, no conventional membrane surface can completely resist bacterial adhesion forever. Once attached, bacteria grow, exude protective biopolymers, replicate, and coordinate phenotype transformations. Therefore, in addition to resisting initial bacterial adhesion, membranes should be designed to inhibit biological activity at their interface.

A non-reactive, hydrophilic, smooth composite membrane surface can be achieved by applying an additional coating layer including a water soluble polymer such as polyvinyl alcohol (PVA), polyvinyl pyrrolidone (PVP), or polyethylene glycol (PEG) on the surface of a polyamide composite RO membrane. In recent years, several methods of composite membrane surface modification have been introduced in membrane preparation beyond simple dip-coating and interfacial polymerization methods of the past. These advanced methods include plasma, photochemical, and redox initiated graft polymerization, drying-leaching (two-step), electrostatically self-assembled multi-layers. Advantages of these surface modification approaches include well-controlled coating layer thickness, permeability, smoothness, and hydrophilicity. However, a drawback of all of these sophisticated surface modification methods is the inability to economically incorporate them into existing manufacturing systems.

Currently, the preferred approach to surface modification of thin film composite membranes remains the simple dip coating-drying approach. In addition, polyvinyl alcohol (PVA) is most attractive for modification of composite membranes because of its high water solubility and good film-forming properties. Polyvinyl alcohol is little affected by grease, hydrocarbons, and animal or vegetable oils; it has outstanding physical and chemical stability against organic solvents. Thus, polyvinyl alcohol can be used as a protective skin layer coated over membranes for many water purification applications, as well as for coatings on many biomedical and dental implant materials.

One advantage of the disclosed membranes with nanocomposite hydrophilic coatings is the integration of antimicrobial surfaces such as can be used in membrane-based separation of microorganisms, purification of wastewater, or filtration of surface waters in drinking water production. Alternatively coating films can be cast onto any substrate requiring infection or fouling resistance.

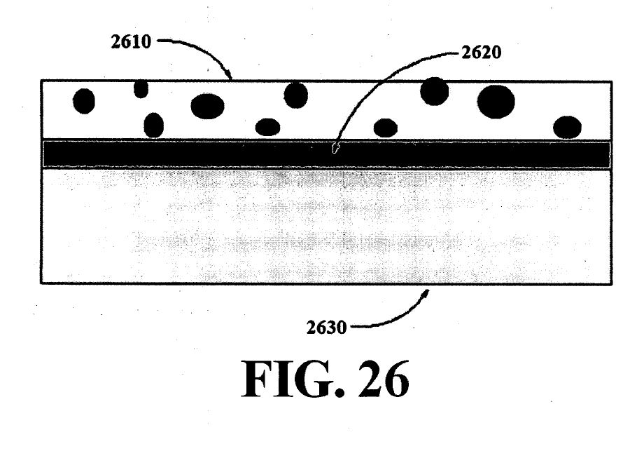

Thus, flux loss due to fouling can be addressed by including nanoparticles in a hydrophilic layer. See FIG. 26. Thus, disclosed are water permeable composite membranes having a polymer matrix film; a porous support on which the film is formed by polymerization; and a cross-linked hydrophilic coating on the polymer matrix film with antimicrobial nanoparticles dispersed within, wherein the membrane exhibits greater fouling resistance than a comparable composite membrane lacking antimicrobial nanoparticles in the hydrophilic coating. With reference to FIG. 26, for example, a water permeable composite membrane can have a porous support layer 2630 with a polymer matrix film layer 2620 formed thereon by polymerization. A permeable composite membrane can further comprise a cross-linked hydrophillic coating layer 2610 on the polymer matrix film layer 2620 with antimicrobial nanoparticles dispersed therein. It is understood that nanoparticles can also be included within the support layer or within the polymer matrix film by polymerization in the presence of nanoparticles.

The membrane can have a pure water contact angle of less than 90°. The membrane can have a pure water flux of at least 0.02 gallons per square foot of membrane per day per pound per square inch of applied pressure.

The membrane can optionally have a cross-linked hydrophilic coating on the polymer matrix film. Typically, the composite membrane with the optional hydrophilic coating is at least as permeable as a comparable composite membrane with a hydrophilic coating and without the nanoparticles. As disclosed herein, the hydrophilic layer can be, for example, a cross-linked hydrogel or a covalently-bonded hydrophilic polymer, such as polyvinyl alcohol. The optional hydrophilic coating can be at least one of polyvinyl alcohol, polyvinyl pyrrole, polyvinyl pyrrolidone, hydroxypropyl cellulose, polyethylene glycol, saponified polyethylene-vinyl acetate copolymer, triethylene glycol, or diethylene glycol or a mixture thereof. Particularly suitable is crosslinked polyvinyl alcohol.

In one aspect, the hydrophilic coating is present and the nanoparticles in the polymer matrix film are hydrophobic nanoparticles, thereby providing the membrane having a greater solute rejection than a comparable composite membrane lacking nanoparticles in the polymer matrix film or a comparable composite membrane having hydrophilic nanoparticles in the polymer matrix film. The solute can be, for example, a salt or its constituent ions.

In one aspect, the nanoparticles and the mixture are selected so that the membrane is substantially more antimicrobial. Numerous known nanoparticles exhibit antimicrobial reactivity, including silver nanoparticles, plain and surface-functionalized carbon nanotubes, surface-functionalized PAMAM dendrimers, and zeolite nano-crystals. Silver nanoparticles exhibit broad-spectrum anti-microbial activity through well-known mechanisms. Carbon nanotubes (CNTs) are emerging as potential anti-microbial materials, but mechanisms of CNT anti-microbial activity are speculative at present. Generally, dendrimers and zeolites are non-biocidal; however, both can be impregnated with silver ions, which are broad-spectrum anti-microbials. Antimicrobial films can be prepared by dispersing antimicrobial nanoparticles in the PVA casting solution. Suitable antimicrobial nanoparticles include silver nanoparticles, silver-complexed dendrimers, silver-exchanged zeolites, fullerenic nanoparticles, and carbon nanotubes.

As disclosed herein, the polymer matrix layer can be provided by interfacial polymerization, to provide, for example a polyamide. Suitable monomers include m-phenylenediamine and trimesoyl chloride. The film can be provided by polymerizing on the porous support having a thickness on the order of about the size of the selected nanoparticles.

Additionally, decreased permeability in a membrane incorporating a hydrophilic layer can be addressed by including nanoparticles in the hydrophilic layer. That is, in one aspect, the nanoparticles can be selected to enhance permeability, thus offsetting any decrease due to the additional membrane thickness when a hydrophilic layer is included.

In one aspect, the nanoparticles and the mixture are selected so that the membrane is substantially more permeable to water as a result of the nanoparticles therein.

For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein.

Also disclosed are methods of preparing a water permeable composite membrane by forming a porous support from a mixture of nanoparticles and a polymeric material; polymerizing a polymer matrix film onto the porous support, thereby forming a composite membrane; and coating a hydrophilic coating onto the polymer matrix film, the hydrophilic coating having antimicrobial nanoparticles dispersed within, wherein the membrane exhibits greater fouling resistance than a comparable composite membrane lacking antimicrobial nanoparticles in the hydrophilic coating. The hydrophilic coating can be cross-linked after coating the polymer matrix film.

Also disclosed are methods of water purification by applying pressure to a water solution having at least one solute, the solution positioned on one side of composite membrane having a polymer matrix film, a porous support on which the film is formed by polymerization, and a cross-linked hydrophilic coating on the polymer matrix film with antimicrobial nanoparticles dispersed within; and collecting purified water on another side of the membrane, wherein the membrane exhibits less flux decline (fouling) over time than a comparable composite membrane lacking antimicrobial nanoparticles in the hydrophilic coating. Typically, the solution is positioned on the coated side of the composite membrane.

3. Hydrophilic and Antimicrobial Filtration Membranes

Antimicrobial filtration membranes can be prepared by dispersing hydrophilic and antimicrobial nanoparticles within polymer films, where the nanocomposite film is used to filter suspensions containing microorganisms. Methods of forming and using conventional filtration and mixed matrix membranes are well known. However, biofouling severely limits the use and increases the cost of water treatment membrane processes.

Nanocomposite filtration membranes formed by dispersing silver nanoparticles or silver-exchanged zeolite nanoparticles or silver-complexed dendrimers or silver-dendrimer nanocomposites or other antimicrobial nanoparticles known to those skilled in the art within porous polymer films leads to creation of filtration membranes with antimicrobial functionality. In the case of silver-exchanged zeolite nanoparticles, the extent of bacterial adhesion can be reduced due to the hydrophilicity of the LTA particles. Antimicrobial functionality can be combined with hydrophilicity to produce truly antifouling membranes. Typically, antimicrobial PSf membranes are more difficult to clean than ordinary PSf membranes, while pure LTA nanoparticle based UF membrane are easiest to clean. Silver nanoparticle and silver-exchanged LTA based membranes produce significant amounts of dead bacteria by direct contact, but they also produce more adhered bacteria even after cleaning—because of the hydrophobicity of PSf. Thus, the combination of antimicrobial and hydrophilic surface functionalities can provide water permeable filtration membranes exhibiting greater fouling resistance through both passive and active antimicrobial mechanisms.

One advantage of the disclosed membranes is integrated antimicrobial functionality such as can be used in membrane-based separation of microorganisms, purification of wastewater or process water, or filtration of surface waters in drinking water production.

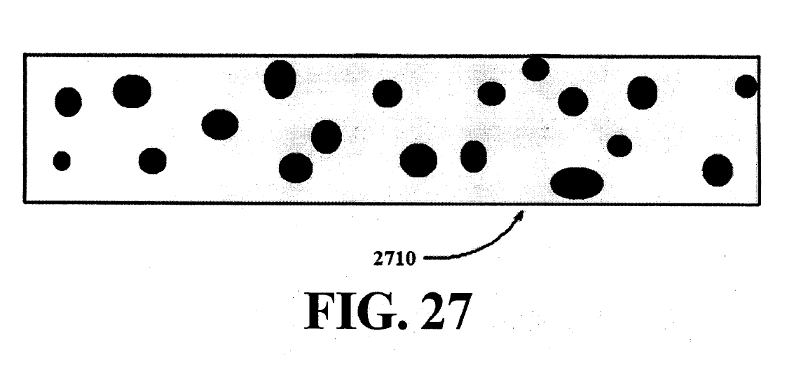

Thus, disclosed are water permeable filtration membranes having a porous ultrafiltration or nanofiltration membrane having nanoparticles dispersed therein, wherein the membrane exhibits greater fouling resistance, which is less flux decline over time than a comparable filtration membrane lacking nanoparticles in the membrane. In one aspect, the ultrafiltration or nanofiltration membrane can be a porous polymeric (e.g., polysulfone) membrane of the same construction as the porous support membranes described herein. Accordingly, such a porous ultrafiltration or nanofiltration membrane can be referred to as a support membrane, although, in such aspects, no polymeric matrix film is polymerized thereon. As such, also disclosed are water permeable filtration membranes having a porous support having nanoparticles dispersed therein, wherein the membrane exhibits greater fouling resistance, which is less flux decline over time than a comparable filtration membrane lacking nanoparticles in the membrane. With reference to FIG. 27, for example, a porous support layer 2710 can have nanoparticles dispersed therein.

The membrane can be prepared in a manner analogous to, and using the same materials (e.g., polysulfone) as, the nanocomposite support layers disclosed herein.

In one aspect, the nanoparticles and the mixture are selected so that the membrane is substantially more permeable to water as a result of the nanoparticles therein. For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein.

In a further aspect, the nanoparticles can be selected so that the membrane is substantially more antimicrobial. Suitable antimicrobial nanoparticles include silver nanoparticles, silver-complexed dendrimers, zeolite nanocrystals, silver-exchanged zeolites, fullerenic nanoparticles, and carbon nanotubes.

The disclosed membranes can be prepared by dispersion casting a porous support from a mixture of nanoparticles and a polymeric material.

The disclosed membranes can be used in methods of water purification by applying pressure to a water solution having at least one solute, the solution positioned on one side of a water permeable filtration membrane having nanoparticles dispersed therein; and collecting purified water on another side of the membrane,

4. Thin Film Nanocomposite Membranes with Surface Modified Nanoparticles

The structure and performance of the disclosed membranes can be further tailored by surface modifying nanoparticles prior to their use in polymerization of thin film nanocomposite membranes.

As disclosed herein, both thin film composite and thin film nanocomposite membranes can be formed onto micro-porous polysulfone ultrafiltration membranes via in situ polycondensation of two monomeric solutions, for example, m-phenylene diamine (MPD) with trimesoyl chloride (TMC). Formation of TFN membranes results from dispersing nanoparticles in the solution containing TMC. The water permeability of TFN membranes is generally better than an equivalent TFC membrane (made without nanoparticles) without an apparent sacrifice in salt rejection.

During the polymer matrix layer formation, Linde type A (also referred to as LTA or Zeolite A) zeolite nanoparticles (in sodium form) dispersed in the TMC solution specifically interact with TMC molecules before, and potentially during, the polymerization reaction with MPD. Nanoparticles can be surface-modified to promote or inhibit specific interactions with monomers during interfacial polymerization; these interactions can then drive the polymerization kinetics and thin film structure, stability, charge, hydrophilicity, and morphology. For example, in the coating of seawater RO thin films, maintaining an adequate concentration of TMC can be important to forming a polymer matrix layer (e.g., polyamide thin film) with adequate molecular weight (and, thus, film thickness) to produce the needed rejection of dissolved solids. It is well known that TMC controls polyamide thin film thickness because it is the limiting reactant, typically present at a concentration of about 5 percent of MPD during reaction.

Without wishing to be bound by theory, it is believed that sodium-complexed LTA zeolite nanoparticles (NaA nanoparticles) interact with TMC molecules through π-bonding between acid chloride moieties of TMC and the sodium cation immobilized within the LTA crystal structure. NaA-type zeolites do not possess significant surface hydroxyl groups when immersed in the organic solvent, but a strong bond can form between the zeolite and polyamide through interaction of it electrons (from aromatic rings, amide groups, and carboxylic acid groups) in the polymer with the Na cations of the zeolite. This effectively reduces the TMC concentration in the bulk of the suspension and thereby reduces the available TMC for reaction with MPD. The result is a thinner film and higher permeability, which can, in certain aspects, be accompanied by an undesired reduction in salt rejection—attributed to the reduced film thickness.

By coating NaA nanoparticles with an organic modifying agent, we inhibit this π-π interaction between the nanoparticles and TMC, and thus, drive formation of an adequately thick polyamide film for use in saltwater reverse osmosis filtration. An alternative approach can be to raise the TMC concentration to an adequate level, but this can, in certain aspects, unfavorably impact the baseline economics of TFC/TFN membrane fabrication and lead to low flux membranes. However, nanoparticles also can be surface modified to promote interaction with TMC such that nanoparticles become covalently bound within the polyamide thin films, which is desirable to further tailor the structure and performance of TFN membranes for virtually any RO application.

The surfaces of nanoparticles containing silica functionality (e.g., amorphous silica, alumino-silicates) can be modified by covalent coupling of a silane-terminated molecule of nearly any functionality. For example, one can functionalize LTA nanoparticles with a silane coupling agent, containing primary amine moiety at the terminal end, which produces an amine-functionalized LTA nanoparticle.

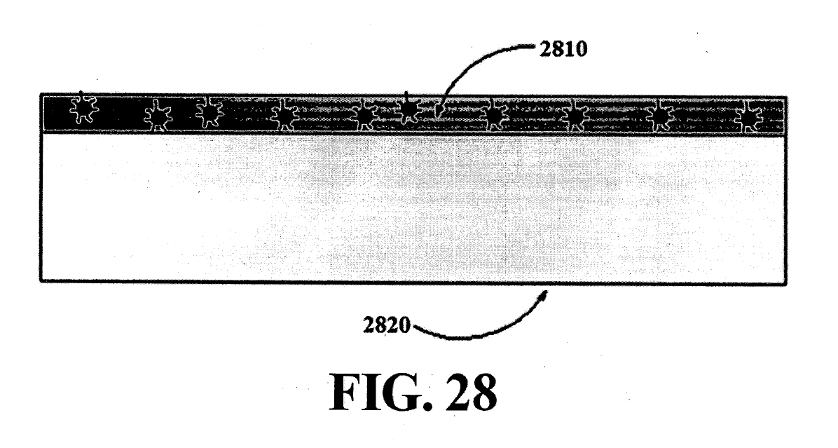

Thus, disclosed are composite membranes having a polymer matrix film formed from one or more monomers in the presence of surface-modified nanoparticles so that the nanoparticles are dispersed in the polymer matrix film; a porous support on which the film is formed by polymerization; and optionally, a cross-linked hydrophilic coating on the polymer matrix film, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film. With reference to FIG. 28, a composite membrane can comprise a porous support layer 2820 with a polymer matrix film 2810 formed thereon, wherein the polymer matrix film 2810 comprises surface-modified nanoparticles dispersed therein. It is contemplated that the support can, optionally, also have nanoparticles dispersed therein. It is contemplated that the optional hydrophilic coating can, optionally, also have nanoparticles dispersed therein.

Several advantages can be achieved by employing surface modified nanoparticles. For example, the surface functionalities can “mask” the nanoparticles with moieties similar to those of the monomers, thereby increasing the stability of the nanoparticles in the reaction dispersion. Moreover, by including reactive surface functionalities on the nanoparticles, the modified nanoparticles can form covalent bonds with the polymer network during formation of the polymer matrix film, thereby actually becoming part of the polymer chemical structure, in addition to being dispersed within the polymer layer. Additionally, this same functionality can increase the loading of nanoparticles within the thin film, by increasing the concentration of nanoparticles that can be included in a stable dispersion. Suitable functionalities include alkyl groups, alkoxy groups, amino-functionalized groups, ether groups, ester groups, urea groups, carboxylate groups, succinate groups, and acyl chloride groups.

As a result of the incorporation of surface modified nanoparticles, a composite membrane can have a lower average film thickness than a comparable composite membrane lacking surface-modified nanoparticles in the polymer matrix film.

The reactive functionalities that can be selected for attachment of the modifying moieties can be, in the case of silica particles for example, silane-terminated molecules of nearly any functionality.

Analogously, the reactive functionalities that can be selected for attachment of the modifying moieties can be, in the cases of gold, silver, copper, palladium, and platinum nanoparticles for example, thiol-terminated molecules of nearly any functionality. Further, the reactive functionalities that can be selected for attachment of the modifying moieties can be, in the cases of aluminum and mica particles for example, alkyl carboxylates of nearly any functionality. A wide variety of reactive compounds that can be employed to modify the surface of nanoparticles are known and commercially available. Suitable compounds can be obtained from, e.g., Sigma-Aldrich; a listing of contemplated compounds can be found at:

http://www.sigmaaldrich.com/Area_of_Interest/Chemistry/Materials_Science/Micro_and_Na noelectronics/Silane Coupling Agents.html,
http://www.sigmaaldrich.com/Area_of_Interest/Chemistry/Materials_Science/Micro_and_Na noelectronics/SAMS_Polyelectrolytes.html,
http://www.sigmaaldrich.com/Area_of_Interest/Chemistry/Materials_Science/Micro_and_Na noelectronics/Inks.html#Thiols, and
http://www.sigmaaldrich.com/Area_of_Interest/Chemistry/Materials_Science/Micro_and_Na noelectronics/Surfactants.html.

Suitable modifying moieties include compounds having one or more nucleophilic groups and one or more electrophilic groups. Nucleophilic groups include primary, secondary, and tertiary amines, alcohols, phosphines, thiols, and the like.

Suitable electrophilic groups include silanes substituted with one or more alkyl, halogen, and/or alkoxyl groups; alkyl groups substituted with one or more halogens or pseudohalides; carboxyl groups and derivatives thereof (including acyl halides and anhydrides); and the like.

For example, the surface-modified nanoparticles can have functional groups that are residues of a compound having a structure:

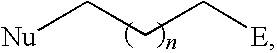

wherein n is an integer from 0 to 24, covalently bonded to the surface of the nanoparticle, wherein Nu is a nucleophilic functionality or a protected nucleophilic functionality, wherein E is an electrophilic functionality or a protected electrophilic functionality, wherein at least one of Nu and E is capable of reacting with at least one of the two monomers during polymerization. A “residue” of a chemical species refers to the moiety that is the resulting product of the chemical species in a particular reaction scheme or subsequent formulation or chemical product, regardless of whether the moiety is actually obtained from the chemical species. It is understood that the residue can be optionally further substituted with alkyl, heteroalkyl, aryl, or heteroaryl groups, as desired.

In a further aspect, the compound can have a structure:

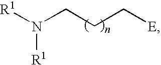

wherein each R′ is independently hydrogen or C₁-C₄ alkyl.

In a further aspect, the compound can have a structure:

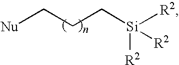

wherein each R² is independently alkyl, halogen, or alkoxyl, with the proviso that at least one R is halogen or alkoxyl.

In a yet further aspect, the compound can have a structure:

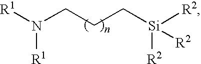

wherein each R′ is independently hydrogen or C₁-C₄ alkyl, and wherein each R² is independently alkyl, halogen, or alkoxyl, with the proviso that at least one R is halogen or alkoxyl. In one aspect, the compound employed to modify the nanoparticles can be 3-(diethoxy(methyl)silyl)propan-1-amine, having a structure:

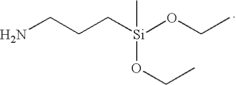

After reaction with nanoparticles, compound can be bound to the surface of the nanoparticle via the electrophilic functionality or protected electrophilic functionality. In one aspect, the bond is a covalent bond.

The membrane, wherein the nanoparticles are selected so that the membrane is substantially more compaction resistant as a result of the nanoparticles therein.

In one aspect, the nanoparticles and the mixture are selected so that the membrane is substantially more permeable to water as a result of the nanoparticles therein. For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein.

In a further aspect, the cross-linked hydrophilic coating is present on the polymer matrix film and wherein the nanoparticles in the polymer matrix film are hydrophobic (e.g., organic/alkyl modified) nanoparticles, thereby providing the membrane having a greater ion rejection than a comparable composite membrane lacking nanoparticles in the polymer matrix film or a comparable composite membrane having hydrophilic nanoparticles in the polymer matrix film.

Also disclosed are methods of preparing a water permeable composite membrane by adding surface-modified nanoparticles to a mixture with one or more monomers, the nanoparticles and at least one of the monomers interacting when polymerized to form a hydrophilic polymer matrix in which the nanoparticles are dispersed; polymerizing the mixture on a porous support to form a composite membrane; and, optionally, coating a hydrophilic coating onto the polymer matrix film, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film.

Also disclosed are methods of water purification by applying pressure to a water solution having at least one solute, the solution positioned on one side of a composite membrane having a polymer matrix film formed from two monomers in the presence of surface-modified nanoparticles so that the nanoparticles are dispersed in the polymer matrix film; a porous support on which the film is formed by polymerization, and, optionally, a cross-linked hydrophilic coating on the polymer matrix film; and collecting purified water on another side of the membrane, wherein the surface-modified nanoparticles and one of the two monomers react during polymerization so that the concentration of the one monomer is increased in proximity to the surface modified nanoparticles relative to the other monomer, thereby providing the composite membrane having a greater permeability than a comparable composite membrane lacking surface-modified nanoparticles in the polymer matrix film.

In one aspect, the membrane is prepared by adding surface-modified nanoparticles to a mixture with two monomers, the nanoparticles and at least one of the monomers interacting when polymerized to form a hydrophilic polymer matrix in which the nanoparticles are dispersed; polymerizing the mixture on a porous support to form a composite membrane; and optionally, coating a hydrophilic coating onto the polymer matrix film. Typically, the solution is positioned on the optionally coated side of the composite membrane.

In a further aspect, the nanoparticles are selected so that the membrane is substantially more permeable to water as a result of the nanoparticles therein.

5. Nanocomposite RO Membranes with Surface Modified Nanoparticles

The structure and performance of reverse osmosis (RO) membranes can be further tailored by dispersing surface-modified nanoparticles within microporous polysulfone supports and subsequently using the nanocomposite supports to direct polymerization of thin film composite or thin film nanocomposite RO membranes. Both TFC and TFN membranes are coated onto micro-porous polysulfone ultrafiltration membranes via in situ polycondensation of two monomeric solutions, for example, m-phenylene diamine (MPD) with trimesoyl chloride (TMC). Formation of TFN membranes results from dispersing nanoparticles in the solution containing TMC. The water permeability of TFN membranes is generally better than an equivalent TFC membrane (made without nanoparticles) without an apparent sacrifice in salt rejection.

Surface modified nanoparticles, as described herein, can be used to produce nanocomposite support membranes on which TFC or TFN membranes are subsequently formed. Thin film composite RO membranes formed over nanocomposite supports (with the MPD-TMC reaction conditions as disclosed herein) can exhibit dramatically different separation and interfacial characteristics. Nanoparticles also can be surface modified to promote favorable interactions with support membrane polymers, thereby improving compatibility with the support material and/or increasing nanoparticle loading in the support. Additionally, any surface-modified nanoparticles positioned at the support surface (i.e., at the interface of the support and any polymeric matrix film) can interact or react directly with monomers and become covalently bound within the polyamide thin films, which is desirable to further tailor the structure and performance of TFC and TFN membranes.

For example, surfaces of nanoparticles containing silica functionality (e.g., amorphous silica, alumino-silicates, etc.) can be modified by covalent attachment of silane-terminated molecules of nearly any functionality. For example, one can functionalize silica or zeolite nanoparticles with silane coupling agent containing primary amine moiety at the terminal end, which produces an amine-functionalized nanoparticle. Other methods of nanoparticle surface modification could also be used to achieve the same or different end results.

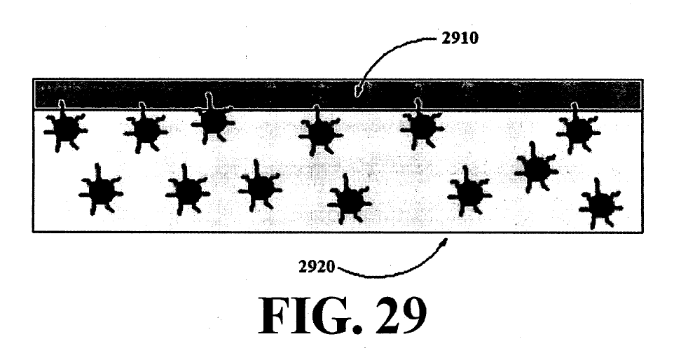

Thus, also disclosed are composite membranes having a polymer matrix film polymerized from one or more monomers upon a porous support, wherein the support has surface-modified nanoparticles dispersed therein, and, optionally, a cross-linked hydrophilic coating on the polymer matrix film, wherein the membrane exhibits greater delamination resistance than a comparable composite membrane lacking surface-modified nanoparticles in the porous support. With reference to FIG. 29, for example, a composite membrane can comprise a support layer 2920 having surface-modified nanoparticles dispersed therein and having a polymer matrix film 2910 formed thereon. In a further aspect, the membrane can be prepared by (a) forming a porous support from a mixture of surface-modified nanoparticles and a polymeric material and (b) polymerizing a polymer matrix film on the porous support to form a composite membrane.

The nanoparticles can be selected so that the membrane is substantially more compaction resistant as a result of the nanoparticles therein. A disclosed membrane can have a pure water contact angle of less than 90°. The membrane can have a pure water flux of at least 0.02 gallons per square foot of membrane per day per pound per square inch of applied pressure.

Also disclosed are methods of preparing a water permeable composite membrane by forming a porous support from a mixture of surface-modified nanoparticles and a polymeric material, and polymerizing one or more monomers to form a polymer matrix film onto the porous support, thereby forming a composite membrane; and, optionally, coating a hydrophilic coating onto the polymer matrix film, wherein the membrane exhibits greater delamination resistance than a comparable composite membrane lacking surface-modified nanoparticles in the porous support.

In one aspect, the cross-linked hydrophilic coating is present on the polymer matrix film and wherein the nanoparticles in the polymer matrix film are hydrophobic nanoparticles, thereby providing the membrane having a greater ion rejection than a comparable composite membrane lacking nanoparticles in the polymer matrix film or a comparable composite membrane having hydrophilic nanoparticles in the polymer matrix film.

Also disclosed are methods of water purification by applying pressure to a water solution having at least one solute, the solution positioned on one side of a composite membrane having a polymer matrix film polymerized from one or more monomers onto a porous support, wherein the support has surface-modified nanoparticles dispersed therein, and, optionally, a cross-linked hydrophilic coating on the polymer matrix film; and collecting purified water on another side of the membrane, wherein the membrane exhibits greater delamination resistance than a comparable composite membrane lacking surface-modified nanoparticles in the porous support. In one aspect, the membrane is prepared by forming a porous support from a mixture of surface-modified nanoparticles and a polymeric material, and polymerizing one or more monomers to form a polymer matrix film onto the porous support, thereby forming a composite membrane; and optionally, coating a hydrophilic coating onto the polymer matrix film. Typically, the solution is positioned on the optionally coated side of the composite membrane.

In one aspect, the nanoparticles and the mixture are selected so that the membrane is substantially more permeable to water as a result of the nanoparticles therein. For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein.

In a further aspect, the cross-linked hydrophilic coating is present on the polymer matrix film and wherein the nanoparticles in the polymer matrix film are hydrophobic nanoparticles, thereby providing the membrane having a greater ion rejection than a comparable composite membrane lacking nanoparticles in the polymer matrix film or a comparable composite membrane having hydrophilic nanoparticles in the polymer matrix film.

6. Engineering of Membranes Having Multiple Nanoparticle-Impregnated Layers

Membranes can be engineered to provide one or more types of nanoparticles in one, two, or three of the layers of the composite membrane. Thus, the disclosed membranes can be augmented by the selection and the addition of nanoparticles to simultaneously achieve, for example, two or more of the properties of flux enhancement, selectivity control, compaction resistance, and/or fouling resistance.

In one aspect, the nanoparticles can be are selected so that the membrane is substantially more permeable to water as a result of the nanoparticles therein. For example, the nanoparticles can be porous. The nanoparticles can be hydrophilic nanoparticles. The nanoparticles can be in the range of about 50 nm to about 500 nm, for example, from about 50 to about 250 nm. In one aspect, the nanoparticles are selected to have a multi-dimensional interconnected open framework having a pore size in the range of about 3 to about 30 Å. The nanoparticles used in the membrane can be selected from nanoparticles known by those of skill in the art and, in particular, can be selected from the nanoparticles disclosed herein. Suitable nanoparticles include metals and metal oxides, amorphous or crystalline inorganic particles, including silica, alumina, clay, and zeolites, carbon nanotubes, and carbon black.

In a further aspect, the nanoparticles can be are selected so that the membrane is substantially more compaction resistant as a result of the nanoparticles therein. Typically, nanoparticles selected for use in this aspect are hard and/or inorganic; inclusion of such nanoparticles can result in less reduced flux over time and/or less reduction in membrane thickness. The nanoparticles used in the membrane can be selected from nanoparticles known by those of skill in the art and, in particular, can be selected from the nanoparticles disclosed herein. Suitable nanoparticles include metals and metal oxides, amorphous or crystalline inorganic particles, including silica, alumina, clay, and zeolites, and carbon black.

In a further aspect, the nanoparticles are selected so that the membrane is more hydrophilic as a result of the nanoparticles therein. In a further aspect, the nanoparticles are selected so that the membrane has a greater negative surface charge as a result of the nanoparticles therein.

In a further aspect, the nanoparticles can be selected so that the membrane is substantially more antimicrobial. Suitable antimicrobial nanoparticles include silver nanoparticles, silver-complexed dendrimers, zeolite nanocrystals, silver-exchanged zeolites, fullerenic nanoparticles, and carbon nanotubes.

The nanoparticles in the various layers can be the same type of nanoparticles or a different type of nanoparticles. That is, the nanoparticles in the polymer matrix film, the nanoparticles in the porous support, and the nanoparticles in the hydrophilic coating can independently be the same type or a different type of nanoparticles. Likewise, the nanoparticles in the polymer matrix film and the nanoparticles in the porous support can independently be the same type or a different type of nanoparticles. Likewise, the nanoparticles in the polymer matrix film and the nanoparticles in the hydrophilic coating can independently be the same type or a different type of nanoparticles. Likewise, the nanoparticles in the porous support and the nanoparticles in the hydrophilic coating can independently be the same type or a different type of nanoparticles.

It is understood that more than one type of nanoparticles can be dispersed within an individual membrane layer. It is also understood that surface-modified nanoparticles, as disclosed herein, can also be dispersed in the various layers of the membranes.

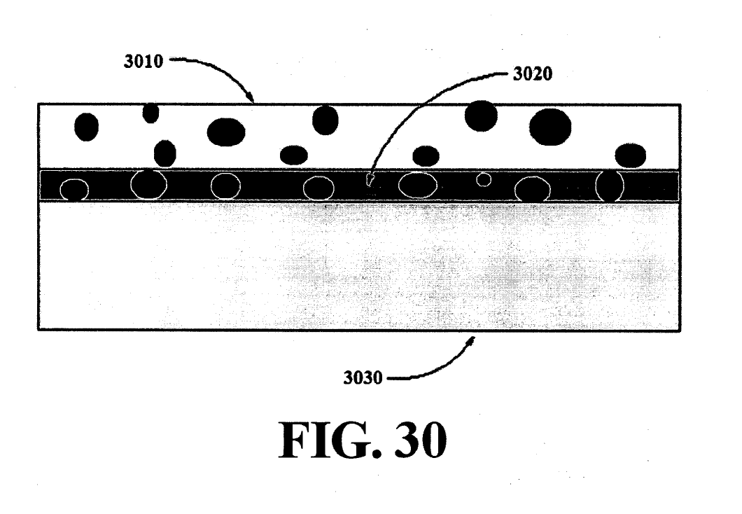

In one aspect, nanoparticles can be selected and dispersed in the polymer matrix film and hydrophilic coating. Thus, disclosed are water permeable composite membranes having a polymer matrix film formed in the presence of nanoparticles so that the nanoparticles are dispersed in the polymer matrix film; a porous support on which the film is formed by polymerization; and a cross-linked hydrophilic coating on the polymer matrix film with antimicrobial nanoparticles dispersed within, wherein the membrane exhibits less loss of flux per time than a comparable polymer matrix membrane lacking nanoparticles in the polymer matrix film, and wherein the membrane exhibits greater fouling resistance than a comparable composite membrane lacking antimicrobial nanoparticles in the hydrophilic coating. With reference to FIG. 30, for example, a water permeable composite membrane can comprise a support layer 3030 having a polymer matrix film layer 3020 formed thereon, wherein the polymer matrix film layer 3020 comprises a hydrophilic coating layer 3010 thereon, wherein both the polymer matrix film layer 3020 and the hydrophilic coating layer 3010 comprise nanoparticles dispersed therein.

Also disclosed are methods of preparing a water permeable composite membrane by adding nanoparticles to a mixture with one or more monomers, the nanoparticles and the monomers interacting when polymerized to form a polymer matrix film in which the nanoparticles are dispersed; polymerizing the monomers on a porous support to provide a polymer matrix film, thereby providing a composite membrane; and coating a hydrophilic coating onto the polymer matrix film, wherein the hydrophilic coating has antimicrobial nanoparticles dispersed within. In one aspect, such a membrane exhibits less loss of flux per time than a comparable polymer matrix membrane lacking nanoparticles in the polymer matrix film, and/or greater fouling resistance than a comparable composite membrane lacking antimicrobial nanoparticles in the hydrophilic coating.

Also disclosed are methods of water purification by applying pressure to a water solution having at least one solute, the solution positioned on one side of composite membrane having a polymer matrix film with nanoparticles dispersed therein, a porous support on which the film is formed by polymerization, and a cross-linked hydrophilic coating on the polymer matrix film, wherein the hydrophilic coating has antimicrobial nanoparticles dispersed within; and collecting purified water on another side of the membrane. In one aspect, the membrane exhibits less loss of flux per time than a comparable polymer matrix membrane lacking nanoparticles in the polymer matrix film, and/or greater fouling resistance than a comparable composite membrane lacking antimicrobial nanoparticles in the hydrophilic coating.

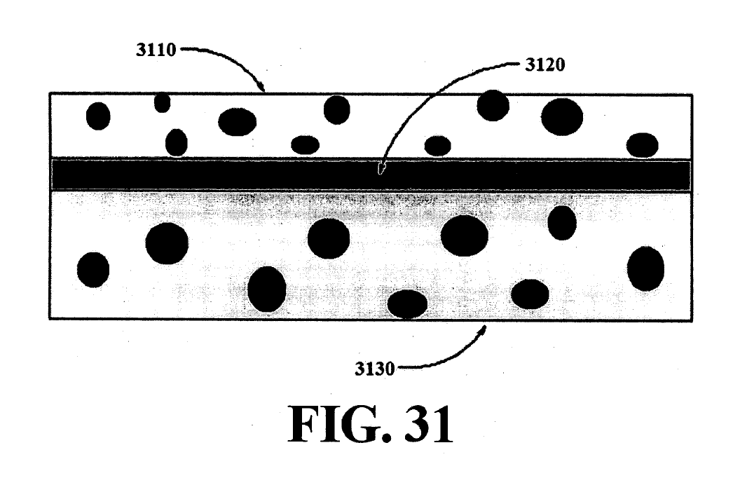

In one aspect, nanoparticles can be selected and dispersed in the porous support and hydrophilic coating. Thus, disclosed are water permeable composite membranes having a porous support on which a polymer matrix film is formed by polymerization, wherein the support has nanoparticles dispersed therein; and a cross-linked hydrophilic coating on the polymer matrix film with antimicrobial nanoparticles dispersed within, wherein the membrane exhibits greater compaction resistance than a comparable composite membrane lacking nanoparticles in the porous support, and wherein the membrane exhibits greater fouling resistance than a comparable composite membrane lacking antimicrobial nanoparticles in the hydrophilic coating. With reference to FIG. 31, for example, a water permeable composite membrane can comprise a porous support layer 3330 having a polymer matrix film layer 3320 formed thereon, wherein the polymer matrix film layer 3320 comprises a hydrophilic coating layer 3310 thereon, and wherein each of the porous support layer 3320, the polymer matrix film layer 3320, and the hydrophilic coating layer comprises nanoparticles dispersed therein.

Also disclosed are methods of preparing a water permeable composite membrane by forming a porous support from a mixture of nanoparticles and a polymeric material, polymerizing one or more monomers to provide a polymer matrix film on the porous support, thereby providing a composite membrane; and coating a hydrophilic coating onto the polymer matrix film, wherein the hydrophilic coating has antimicrobial nanoparticles dispersed within. In one aspect, such a membrane exhibits greater compaction resistance than a comparable composite membrane lacking nanoparticles in the porous support, and/or greater fouling resistance, than a comparable composite membrane lacking antimicrobial nanoparticles in the hydrophilic coating.

Also disclosed are methods of water purification by applying pressure to a water solution having at least one solute, the solution positioned on one side of composite membrane having a polymer matrix film polymerized on a porous support with nanoparticles dispersed within, and a cross-linked hydrophilic coating on the polymer matrix film, wherein the hydrophilic coating has antimicrobial nanoparticles dispersed within; and collecting purified water on another side of the membrane. In one aspect, the membrane exhibits greater compaction resistance than a comparable composite membrane lacking nanoparticles in the porous support, and/or greater fouling resistance than a comparable composite membrane lacking antimicrobial nanoparticles in the hydrophilic coating.

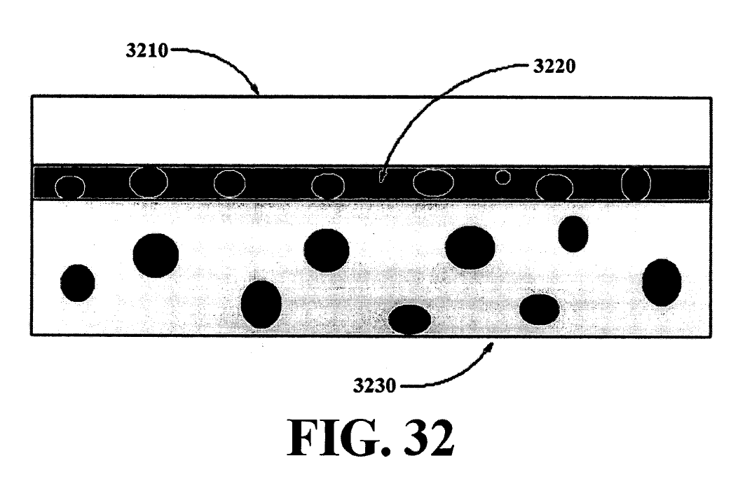

In one aspect, nanoparticles can be selected and dispersed in the polymer matrix film and porous support. Thus, disclosed are water permeable composite membranes having a polymer matrix film formed in the presence of nanoparticles so that the nanoparticles are dispersed in the polymer matrix film; a porous support on which the film is formed by polymerization, wherein the support has nanoparticles dispersed therein; and a cross-linked hydrophilic coating on the polymer matrix film, wherein the membrane exhibits less loss of flux per time than a comparable polymer matrix membrane lacking nanoparticles in the polymer matrix film, and wherein the membrane exhibits greater compaction resistance than a comparable composite membrane lacking nanoparticles in the porous support. In one aspect, such a membrane exhibits greater fouling resistance than a comparable composite membrane lacking the cross-linked hydrophilic coating on the polymer matrix film. With reference to FIG. 32, for example, a water permeable composite membrane can comprise a porous support 3230 having a polymer matrix film layer 3220 formed thereon and nanoparticles dispersed therein, wherein the polymer matrix film layer 3220 comprises a hydrophilic coating layer 3210 thereon and nanoparticles dispersed therein.

Also disclosed are methods of preparing a water permeable composite membrane by forming a porous support from a mixture of nanoparticles and a polymeric material, adding nanoparticles to a mixture with one or more monomers, the nanoparticles and the monomers interacting when polymerized to form a polymer matrix film in which the nanoparticles are dispersed; polymerizing the monomers to provide a polymer matrix film on the porous support, thereby providing a composite membrane; and coating a hydrophilic coating onto the polymer matrix film. In one aspect, such a membrane exhibits less loss of flux per time than a comparable polymer matrix membrane lacking nanoparticles in the polymer matrix film, and/or greater compaction resistance than a comparable composite membrane lacking nanoparticles in the porous support. In a further aspect, the membrane exhibits greater fouling resistance than a comparable composite membrane lacking the cross-linked hydrophilic coating on the polymer matrix film.

Also disclosed are methods of water purification by applying pressure to a water solution having at least one solute, the solution positioned on one side of a composite membrane having a polymer matrix film with nanoparticles dispersed therein, a porous support with nanoparticles dispersed within on which the film is formed by polymerization, and a cross-linked hydrophilic coating on the polymer matrix film; and collecting purified water on another side of the membrane. In one aspect, such a membrane exhibits less loss of flux per time than a comparable polymer matrix membrane lacking nanoparticles in the polymer matrix film, and/or greater compaction resistance than a comparable composite membrane lacking nanoparticles in the porous support.

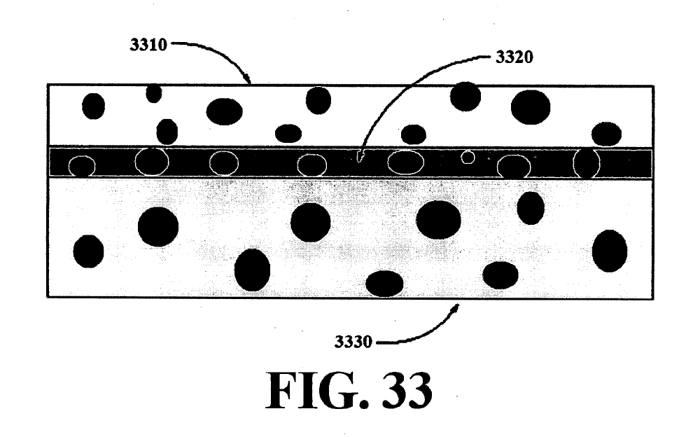

In one aspect, nanoparticles can be selected and dispersed in the porous support, polymer matrix film, and hydrophilic coating. Thus, disclosed are water permeable composite membranes having a polymer matrix film formed in the presence of nanoparticles so that the nanoparticles are dispersed in the polymer matrix film; a porous support on which the film is formed by polymerization, wherein the support has nanoparticles dispersed therein; and a cross-linked hydrophilic coating on the polymer matrix film with nanoparticles dispersed within, wherein the membrane exhibits less loss of flux per time than a comparable polymer matrix membrane lacking nanoparticles in the polymer matrix film, and/or wherein the membrane exhibits greater compaction resistance than a comparable composite membrane lacking nanoparticles in the porous support, and/or wherein the membrane exhibits greater fouling resistance than a comparable composite membrane lacking antimicrobial nanoparticles in the hydrophilic coating and/or wherein the membrane exhibits substantially more permeability to water as a result of the nanoparticles therein than a comparable composite membrane lacking nanoparticles. With reference to FIG. 33, for example, a water permeable composite membrane can comprise a support layer 3330 having a polymer matrix film layer 3320 formed thereon and nanoparticles dispersed therein, wherein the polymer matrix film layer 3320 comprises a hydrophilic coating layer 3310, and wherein each of the support layer 3330, polymer matrix film layer 3320, and hydrophilic coating layer 3310 have nanoparticles dispersed therein, since each layer is formed in the presence of nanoparticles.

Also disclosed are methods of preparing a water permeable composite membrane by forming a porous support from a mixture of nanoparticles and a polymeric material, adding nanoparticles to a mixture with one or more monomers, the nanoparticles and the monomers interacting when polymerized to form a polymer matrix film in which the nanoparticles are dispersed; polymerizing the monomers to provide a polymer matrix film on the porous support, thereby providing a composite membrane; and coating a hydrophilic coating onto the polymer matrix film, wherein the hydrophilic coating has antimicrobial nanoparticles dispersed within. In one aspect, the membrane exhibits less loss of flux per time than a comparable polymer matrix membrane lacking nanoparticles in the polymer matrix film, and/or greater compaction resistance than a comparable composite membrane lacking nanoparticles in the porous support, and/or greater fouling resistance than a comparable composite membrane lacking antimicrobial nanoparticles in the hydrophilic coating and/or wherein the membrane exhibits substantially more permeability to water as a result of the nanoparticles therein than a comparable composite membrane lacking nanoparticles.

Also disclosed are methods of water purification by applying pressure to a water solution having at least one solute, the solution positioned on one side of composite membrane having a polymer matrix film with nanoparticles dispersed therein, a porous support with nanoparticles dispersed within on which the film is formed by polymerization, and a cross-linked hydrophilic coating on the polymer matrix film, wherein the hydrophilic coating has antimicrobial nanoparticles dispersed within; and collecting purified water on another side of the membrane. In one aspect, the membrane exhibits less loss of flux per time than a comparable polymer matrix membrane lacking nanoparticles in the polymer matrix film, and/or greater compaction resistance than a comparable composite membrane lacking nanoparticles in the porous support, and/or greater fouling resistance than a comparable composite membrane lacking antimicrobial nanoparticles in the hydrophilic coating and/or wherein the membrane exhibits substantially more permeability to water as a result of the nanoparticles therein than a comparable composite membrane lacking nanoparticles.

### G. Experimental

The following examples are put forth so as to provide those of ordinary skill in the art with a complete disclosure and description of how the compounds, compositions, articles, devices and/or methods disclosed herein can be made and evaluated, and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. and is at ambient temperature, and pressure is at or near atmospheric.

1. Evaluation of Compaction Mechanisms

A laboratory scale, cross-flow membrane filtration system was constructed to evaluate compaction mechanisms in commercial and nano-structured NF/RO thin film composite membranes. Membranes were compacted for 24 hours at varying pressures while the temperature was kept constant at 25° C. The flux was measured as a function of pressure by a digital chromatography flow meter. Pressures ranging from 0 to 600 psi were tested. Deionized (DI) water was used with varying concentrations of MgSO₄ to supply the necessary osmotic pressure. Using a standard Darcy resistance model, the apparent membrane resistance was determined for each membrane across the appropriate range of applied pressures. The relationship between pressure and membrane resistance was unique to each membrane. Cross-section SEM images were taken of both compacted and uncompacted membranes to determine the physical change in the sub-structure of the membrane. Using both the SEM images and the experimentally determined membrane resistances in combination with the Kozeny-Carmen model, the mechanisms through which RO/NF membranes are physically compacted and irreversibly fouled can be determined.

For example, in RO seawater desalination applications the applied pressures are over 50 bars and this causes the support layer membrane to be physically compacted to about 50 percent of its initial thickness over the first few days of operation. As a result, the water permeability of the membrane declines to about 50 percent of the initial value. Considering the membrane can be responsible for as much as 50 percent of the overall energy consumption in a RO desalination process, the overall energy consumption can increase by as much as 25 percent due to membrane compaction.

Thin film nanocomposite (TFC) RO membranes formed over either pure polysulfone supports or nanocomposite polysulfone supports exhibit very little or no loss of permeability at pressures over 30 bars, while similarly prepared TFC membranes exhibit dramatic loss of permeability when tested under the same conditions. For thin film nanocomposite (TFN) membranes formed over pure polysulfone supports, this observation defies the conventional wisdom that physical compaction of the support membrane is responsible for the observed loss of permeability. Nanoparticles dispersed within a thin polyamide film can alter the film structure (radially about each nanoparticle) such that the thin film is dramatically mechanically more robust and unusually able to reduce physical compaction.

2. Formation of Hydrophilic Coating with PVA

A PVA coating layer can be formed on a substrate as follows. An aqueous PVA solution with ˜0.1-10 wt % PVA with molecular weight ranging from 2,000 to over 70,000 can be prepared by dissolving the polymer in distilled/deionized water. PVA powder is easily dissolved in water by stirring at ˜90° C. for ˜5 hours. The already formed polyamide composite membrane is contacted with the PVA solution and the deposited film is dried overnight. Subsequently, the membrane can be brought into contact (from the PVA side) with a solution containing a cross-linking agent (e.g., dialdehydes and dibasic acids) and catalyst (e.g., ˜2.4 wt % acetic acid) for about 1 second. The membrane can then be heated in an oven at a predetermined temperature for a predetermined period. Various cross-linking agents (glutaraldehyde, PVA-glutaraldehyde mixture, paraformaldehyde, formaldehyde, glyoxal) and additives in the PVA solution (formaldehyde, ethyl alcohol, tetrahydrofuran, manganese chloride, and cyclohexane) can be used to prepare PVA films cast over existing membranes in combination with heat treatment of prepared PVA films to modify film properties.

3. Hydrophilic and Antimicrobial Nanocomposite UF

Polysulfone (PSf) transparent beads with number average molecular weight of 70,000 Da (Acros-Organics, USA), N-methylpyrrolidone (NMP) (reagent grade, Acros Organics, USA), and laboratory prepared de-ionized water were used to form polysulfone supports. In this example, a total of 14 different nanoparticles were used from different sources, the detail of which is given in the table. Dextran with different molecular weights (ranging from 50,000-360,000) were obtained from M/s. Fluka, USA.

a. Membrane Preparation

Support membranes are prepared by dissolving 18 g PSf beads in 72 mL of NMP in airtight glass bottles. In the case of the nanocomposites, various nanoparticles of 3.6 g were dispersed in the NMP before its addition to the polysulfone polymer. The solution was then agitated for several hours until complete dissolution was achieved, forming the dope solution. The dope solution was then spread over a non-woven fabric (SepRO, Oceanside, Calif.) that was attached to a glass plate via a knife-edge. The glass plate is immediately immersed in demineralized water acclimated to room temperature to induce phase inversion. After 30 minutes the non-woven fabric supported polysulfone and nanocomposite films are removed from the water bath and separated from the glass plate. The membrane is washed thoroughly with demineralized water and stored in a laboratory refrigerator maintained at 5° C.

b. Membrane Characterization

Pure water permeability is determined by filtering deionized water through hand-cast UF support membranes using stainless steel dead-end stirred cell (HP4750 Stirred Cell, Sterlitech Corp., Kent, Wash.) resting on a magnetic stir plate. Pure water flux was also measured as a function of time for PSf as well as some of the nanostructured PSf membranes at 20 psi pressures in room temperature. The MWCO of these membranes was determined from the separation of various molecular weights dextran solution. The MWCO is defined as the molecular weight of the dextran molecules that are rejected by the membrane for 90% and more.

Surface morphology of membranes is visualized by scanning electron microscopy, SEM (XL30 FEG SEM, FEI Company, Hitachi, Japan) and cross-sectional morphology is visualized using SEM (M/s. Photomatrix). Quantitative surface roughness analysis of polyamide films is measured using an atomic force microscope, AFM (Digital Instruments-Multimode 3, Santa Barbara, Calif., USA), equipped with standard silicon nitride cantilever (MikroMasch, Portland, Oreg., USA). The estimated tip radius is less than 10 nm, cantilever length is 125 μm and force constant of 5 N·m¹. Air-dried membrane samples are fixed on a specimen holder and 10 μm×10 μm areas are scanned by tapping mode in air. Roughness is reported in terms of the measured root mean square (RMS) roughness and surface area difference (SAD).

Surface hydrophilicity of all membranes is evaluated from the average equilibrium sessile drop contact angles of de-ionized water on dried membrane surfaces. At least twelve equilibrium contact angles are obtained for each membrane, where the average of left and right contact angles defines the equilibrium contact angle. The minimum and maximum equilibrium angles are dropped.

Mechanical strength of the membranes was measured in terms of ultimate tensile strength (stress) using Instron Testing Machine. In this test, a membrane specimen (dimension: 4 cm×1.5 cm) is stretched at a predetermined rate (0.5 mm/min.) until breakage. The ultimate tensile strength (stress) is calculate from maximum load applied in breaking a tensile test piece divided by the original cross-sectional area of the test piece.

c. Fouling Experiments

Fouling experiments were performed at 10 psi pressure. Deionized (DI) water was first passed through the membrane until the flux remained stable over at least 45 minutes (minimum 4-5 h of DI water filtration). The end of the stabilization period was taken to be the zero time point in the filtration plots. The cell was then emptied and refilled with the model foulant solution. Protein solutions comprised 1000 mg/L bovine serum albumin (BSA) in PBS with a pH between 7.4 and 7.5. A sample of permeate was collected after 1 h of filtration. Foulant retention values were obtained by measuring the foulant concentration in this sample by TOC analysis of feed and permeate samples. After 24 hrs of operation, the filtration cell was rinsed 6-7 times with DI water and then refilled with DI water as a feed to determine the reversibility of fouling. Similar experiments were performed using Pseudomonas putida to evaluate fouling resistance against bacteria.

d. Bacterial Viability

After fouling tests (1^{st} batch) or cleaning tests (2^{nd} batch), the membrane coupons were gently removed from the cells. The viability of bacteria on membrane surface was determined using a Live/Dead Baclight staining kit (Molecular Probes, CA, USA). Membrane sample was put into the staining reagent mixtures in the ratio of 1:1 of SYTO 9 green fluorescent nucleic acid stain and red fluorescent stain, propidium iodide and then stored in the absence of light for 15 min after which the membrane sample was analyzed by different fluorescence microscopy.

Nanoparticles listed in the following table have been evaluated for use in creation of nanocomposite UF membranes. The basic properties of the nanocomposite membranes are given in the table below.

| Name | Description | Supplier | Size (nm) |
|---|---|---|---|
| LTA | Zeolite-LTA | NanoScape | ~250 |
| ODLTA | Organic modified Zeolite-LTA | NanoScape | ~250 |
| Ag-x-LTA | NS-LTA Ag exchanged in our lab | NanoScape + UCLA | ~250 |
| Silica-STZL | Amorphous nonporous silica | Nissan Chemicals | ~130 |
| Silica-M1040 | Amorphous nonporous silica | Nissan Chemicals | ~120 |
| Silica-ST20L | Amorphous nonporous silica | Nissan Chemicals | ~68 |
| Silica-ST50 | Amorphous nonporous silica | Nissan Chemicals | ~38 |
| Metal-Cu | Metal powder | Quantum Sphere | ~10-70 |
| Metal-Ag | Metal powder | Quantum Sphere | ~10-70 |
| AgIon-AJ1 | Zeolite with Ag/Cu exchanged | AgION | ~5000 |
| AgIon-AJ2 | Zeolite with Ag/Cu exchanged | AgION | ~6500 |
| AgIon-AK | Zeolite with Ag/Cu exchanged | AgION | ~1800 |

| | | Polymer | NMP | Additive | MWCO* | Pure water** | Water contact | AFM roughness | | σ*** |
|---|---|---|---|---|---|---|---|---|---|---|
| Polymer | Nanoparticle | (gm) | (mL) | (gm) | (kDa) | flux (gfd) | angle (°) | RMS (nm) | SAD (%) | MPa |
| PSf | — | 18 | 72 | 0 | 180 | 206.8 ± 3.2 | 76.2 ± 1.3 | 13.0 ± 0.1 | 6.7 ± 0.8 | 26.8 ± 0.6 |
| PSf | LTA | 18 | 72 | 3.6 | 140 | 299.2 ± 3.8 | 73.7 ± 2.9 | 26.7 ± 4.1 | 12.5 ± 5.9 | 41.1 ± 2.1 |
| PSf | ODLTA | 18 | 72 | 3.6 | 240 | 176.0 ± 4.2 | 79.0 ± 1.0 | 25.4 ± 3.3 | 11.4 ± 2.1 | 22.4 ± 1.1 |
| PSf | Ag-LTA | 18 | 72 | 3.6 | 300 | 198.0 ± 3.7 | 76.1 ± 1.5 | 27.6 ± 4.0 | 28.1 ± 8.1 | 31.0 ± 1.9 |
| PSf | Silica-STZL | 18 | 72 | 3.6 | 280 | 159.0 ± 3.0 | 81.8 ± 0.6 | 21.9 ± 2.9 | 6.4 ± 1.1 | 39.9 ± 1.4 |
| PSf | Silica- | 18 | 72 | 3.6 | 200 | 189.0 ± 4.1 | 75.2 ± 2.4 | 16.1 ± 1.0 | 8.3 ± 1.9 | 45.8 ± 2.4 |
| | M1040 | | | | | | | | | |
| PSf | Silica- | 18 | 72 | 3.6 | 220 | 112.0 ± 2.9 | 70.0 ± 0.9 | 17.7 ± 1.0 | 9.1 ± 0.9 | 39.6 ± 2.0 |
| | ST20L | | | | | | | | | |
| PSf | Silica-ST50 | 18 | 72 | 3.6 | 600 | 210.9 ± 14.6 | 74.1 ± 4.1 | 30.0 ± 2.6 | 4.0 ± 0.3 | 48.1 ± 2.8 |
| PSf | Metal-Cu | 18 | 72 | 3.6 | 400 | 318.9 ± 3.1 | 78.0 ± 0.6 | 20.8 ± 10.0 | 2.4 ± 0.3 | 40.7 ± 1.8 |
| NP9 | Metal-Ag | 18 | 72 | 3.6 | >600 | 249.1 ± 3.5 | 66.9 ± 1.7 | 21.2 ± 11.0 | 2.9 ± 0.6 | 28.3 ± 1.7 |
| NP10 | AgIon-AJ1 | 18 | 72 | 3.6 | >600 | 234.8 ± 3.1 | 69.5 ± 2.6 | 37.7 ± 26.0 | 17.5 ± 7.0 | 31.2 ± 2.1 |
| NP11 | AgIon-AJ2 | 18 | 72 | 3.6 | 600 | 405.8 ± 6.9 | 73.8 ± 3.0 | 30.8 ± 14.0 | 2.9 ± 1.2 | 25.5 ± 2.0 |
| NP12 | AgIon-AK | 18 | 72 | 3.6 | 200 | 109.4 ± 4.2 | 70.2 ± 2.2 | 26.3 ± 1.5 | 8.1 ± 6.0 | 31.5 ± 1.6 |

The table above provides analysis of: (1) pure water flux given in units of “gfd” or gallons per square foot of membrane per day; (2) flux decline due to fouling by bovine serum albumin (BSA), a well-studied blood protein commonly used to assess biofouling potential of ultrafiltration membranes given as flux at start and end of experiment (24 hour filtration time); (3) percent of pure water flux recovered after cleaning by 6 sequential rinses with deionized water; and (4) observed rejection of BSA determined from total organic carbon analysis of feed and filtration solutions (samples collected after 1 hour of filtration). It should be noted that MX50 is a commercially produced polyacrylonitrile (PAN) ultrafiltration membrane surface modified to be extremely hydrophilic.

| | Pure | Flux in presence | Percent of | BSA |
|---|---|---|---|---|
| | water flux | of BSA start/end | pure water | rejection |
| Membrane | (gfd) | (gfd) | flux recovered | (%) |
| PSf | 82.5 | 28.6/3.65 | 28.6 | 98.2 |
| PSf + LTA | 96.9 | 59.3/6.41 | 63.7 | 99.0 |
| PSf + AgNP | 52.0 | 24.5/2.96 | 52.6 | 98.8 |
| PSf + ST20L | 71.6 | 35.2/3.94 | 47.5 | 98.0 |
| PSf + STZL | 38.0 | 26.5/3.64 | 60.7 | 96.5 |
| PSf + | 71.5 | 39.7/4.28 | 35.2 | 74.0 |
| OM_silica | | | | |
| MX50 | 72.0 | 54.0/7.30 | 63.2 | 87.0 |

The table below provides analysis of: (1) pure water flux given in gfd; (2) flux decline due to fouling by Pseudomonas putida (PP), a common gram-negative soil bacterium, given as flux at start and end of experiment (24 hour filtration time); (3) percent of pure water flux recovered after cleaning by 6 sequential rinses with deionized water; and (4) fraction of surface covered by live and dead cells (remaining fraction giving a total of 100% had no bacteria adhered). Number (per mL) of bacteria cell in feed suspension ranged from 6.59×10¹⁰ to 8.54×10¹⁰. In each experiment, the fraction of live cells versus dead cells in the bulk of the feed suspension was between 92 and 100 percent.

| Membrane | Pure | Flux in presence | Percent of | Live/ |
|---|---|---|---|---|
| (polymer + | water flux | of PP start/end | pure water | Dead |
| NP) | (gfd) | (gfd) | flux recovered | (%) |
| PSf | 73.0 | 67.2/23.3 | 55.5 | 40.1/35.6 |
| PSf + LTA | 91.4 | 90.7/28.2 | 68.3 | 7.3/0.6 |
| PSf + AgNP | 115.8 | 114.6/36.3 | 47.2 | 31.0/20.0 |
| PSf + | 131.7 | 112.6/29.0 | 32.7 | 33.0/6.4 |
| Ag-LTA | | | | |

Referring to the table above, a number of nanocomposite UF membranes exhibit significantly higher intrinsic flux than pure PSf UF membranes. For example, the metal-Ag and LTA based membranes. A number of nanocomposite UF membranes exhibit significantly larger breaking strengths over pure PSf UF membranes. For example, LTA and various silica-based membranes appear stronger. However, the only nanocomposite that exhibits both increase permeability and strength is the LTA based UF membrane. In addition, this membrane is measurably more hydrophilic, which can facilitate fouling resistance. The fouling experiments confirm that LTA based UF nanocomposite membranes are more permeable and resistant to protein fouling than all other combinations. Moreover, silver exchanged LTA nanoparticles exhibit biocidal properties and when used to create nanocomposite UF membranes this combination appears promising as a new high flux (energy efficient), hydrophilic (passively fouling resistant), and antimicrobial (actively fouling resistant) UF membranes.

4. Surface Functionalized LTA Based nTFC

a. Preparation of Membranes

Nano-structured thin film composite (nTFC) membranes are hand-cast on preformed nanocomposite polysulfone microporous membranes through interfacial polymerization. First, a support membrane casting solution is prepared by dissolving 18 g polysulfone (PSf) in 72 mL N-methylpyrrolidone (NMP). In the case of the nanocomposites, various nanoparticles of 3.6 g were dispersed in the NMP before its addition to the polysulfone polymer. The asymmetric membranes from pure polymer and nanocomposite casting solutions were prepared by a phase inversion technique. A total of 14 different nanoparticles were used so far, the details of which are given in the table, supra.

In next step, the support membrane is immersed in an aqueous solution of m-phenylenediamine (MPD) which contains other additives like triethyl amine (TEA), (+)-10-champhor sulfonic acid (CSA), sodium lauryl sulfate (SLS), and isopropanol for 15 seconds. Excess MPD solution is removed from the support membrane surface using lab gas forced through a custom fabricated air knife. Aqueous MPD saturated support membrane is then immersed into trimesoyl chloride (TMC) solution in isopar-G at 30° C. for 15 seconds to get composite membrane. The resulting composite membranes are heat cured at 82° C. for 10 minutes, washed thoroughly with de-ionized water, and stored in de-ionized water filled lightproof containers at 5° C.

b. Characterization of Membranes

The separation performance of synthesized membranes was evaluated in terms of pure water flux and salt rejection using dead-end filtration cell (HP4750 Stirred Cell, Sterlitech Corp., Kent, Wash.). The membrane was washed thoroughly for 45 min under 225 psi pressure. Then the volume of pure water collected over 30 min. divided by the membrane area gave the permeate flux. Then NaCl solution was used as feed and permeate sample was collected after 30 min. Subsequently, the membrane was washed with DI water thoroughly for 45 min under pressure.

The surface (zeta) potential of hand-cast membranes was determined by measuring the streaming potential with 10 mM NaCl solution at unadjusted pH (−5.8). Sessile drop contact angles of deionized water were measured on air dried samples of synthesized membranes in an environmental chamber mounted to the contact angle goniometer (DSA 10, KR″uSS). The equilibrium value was the steady-state average of left and right angles. Surface roughness of the synthesized membranes was measured by AFM (Nanoscope IIIa, Digital Instruments).

### TFC and nTFC Separation Performance

| | | TMC | | NaCl solution | |
|---|---|---|---|---|---|
| | MPD solution* | solution** | Pure water flux | flux | NaCl rejection |
| | (% w/v) | (% w/v) | (gfd) | (gfd) | (%) |
| TFC | 2.0:2.0:4.0:0.02:10 | 0.1 | 9.2 ± 0.6 | 5.8 ± 0.3 | 85 ± 1.0 |
| LTA-TFC | 2.0:2.0:4.0:0.02:10 | 0.1 | 12.7 ± 1.8 | 8.7 ± 1.1 | 93 ± 0.6 |
| ODLTA-TFC | 2.0:2.0:4.0:0.02:10 | 0.1 | 23 ± 2.0 | 20 ± 1.4 | 78 ± 2.3 |

*MPD:TEACSA:SLS:IPA
**TMC dissolved in Isopar-G

### TFC and nTFC Surface Properties

| | Water contact | ζ_{membrane} |
|---|---|---|
| | Angle (°) | (mV) |
| TFC | 71.2 ± 0.8 | −8.3 ± 1.0 |
| LTA-TFC | 67.3 ± 1.3 | −5.6 ± 0.9 |
| ODLTA-TFC | 69.0 ± 1.4 | −14.1 ± 1.3 |

Referring to the table above, the permeability of organic modified LTA (ODLTA) nanoparticle based nTFC membranes is substantially higher than either pure polymer TFC or LTA based nTFC membranes. In addition, the membrane surface is slightly more hydrophilic and more negatively charged.

5. Surface Functionalized LTA Based TFN

Chemicals used for thin film polyamide formation include monomers 1,3-diamino benzene or m-phenylenediamine (MPD) and 1,3,5-benzene tricarboxylic acid chloride or trimesoyl chloride (TMC) as well as aqueous solution additives triethyl amine, TEA (liquid, 99.5%; Sigma-Aldrich), (+)-10-champhor sulfonic acid (CSA) (powder, 99.0%; Sigma-Aldrich) and, sodium lauryl sulfate (SLS) (Fisher Scientific, Pittsburg, Pa., USA). Isopar G (Gallade Chemical, Inc.; Santa Ana, Calif.) is the organic solvent used for preparing TMC solutions. Nanoparticles include Linde Type A (LTA) and an alkyl silane modified LTA (ODLTA) particle (NanoScape AG).

a. Membrane Preparation

Both thin film composite (TFC) and thin film nanocomposite (TFN) membranes were hand-cast on preformed polysulfone ultrafiltration (UF) membranes (provided by SepRO, Oceanside, Calif.) through in-situ interfacial polymerization. At first, polysulfone support membrane is taped all four side over a glass plate using adhesive tapes keeping active membrane side on the top. First, the polysulfone support membrane is immersed in an aqueous solution of m-phenylenediamine (MPD) contains other additives like triethyl amine (TEA), (+)-10-champhor sulfonic acid (CSA), sodium lauryl sulfate (SLS), and isopropanol (in some case) for 15 seconds. Excess MPD solution is removed from the support membrane surface using lab gas forced through custom fabricated air knife. Aqueous MPD saturated support membrane is then immersed into isopar-G solution of trimesoyl chloride (TMC) at 30° C. for 15 seconds and thin polyamide film is formation takes place in the interface i.e. over polysulfone support. The resulting composite membranes are heat cured at 82° C. for 10 minutes, washed thoroughly with de-ionized water, and stored in de-ionized water filled light-proof containers at 5° C. TFN membranes are made by dispersing 0.2% (w/v) of LTA or ODLTA nanoparticles in the isopar-G-TMC solution. Nanoparticle dispersion is obtained by ultrasonication for 40 minutes at room temperature immediately prior to interfacial polymerization.

b. Membrane Characterization

The separation performance of synthesized membranes was evaluated in terms of pure water flux and salt rejection using dead-end filtration cell (HP4750 Stirred Cell, Sterlitech Corp., Kent, Wash.). The membrane was washed thoroughly for 45 min under 225 psi pressure. Then the volume of pure water collected over 30 min divided by the membrane area gave the permeate flux. Then NaCl solution was used as feed and permeate sample was collected after 30 min. Subsequently, the membrane was washed with DI water thoroughly for 45 min under pressure. Then MgSO₄ solution was used as feed and permeate sample was collected after 30 min. The same procedure was repeated for PEG-200.

The surface (zeta) potential of hand-cast membranes was determined by measuring the streaming potential with 10 mM NaCl solution at unadjusted pH (−5.8). Sessile drop contact angles of deionized water were measured on air dried samples of synthesized membranes in an environmental chamber mounted to the contact angle goniometer (DSA10, KR″uSS). The equilibrium value was the steady-state average of left and right angles. Surface roughness of the synthesized membranes was measured by AFM (Nanoscope IIIa, Digital Instruments). Surface morphology of membranes is visualized by scanning electron microscopy, SEM (XL30 FEG SEM, FEI Company, Hitachi, Japan) and cross-sectional morphology is visualized using transmission electron microscopy, TEM (JEOL 100CX) according to previously described methods.

| | | NP | | TMC | | | |
|---|---|---|---|---|---|---|---|
| Membrane | NP | concentration | MPD solution | concentration | Pure water | NaCl solution | NaCl solution |
| Type | Type | (w/v %) | MPD:TEACSA:SLS | (w/v %) | flux (gfd) | flux (gfd) | Rejection |
| TFC | — | 0 | 3.2:4.5:0.02 | 0.13 | 12.0 ± 0.8 | 7.5 ± 0.5 | 98.1 ± 0.6 |
| TFN | LTA | 0.2 | 3.2:4.5:0.02 | 0.13 | 70.9 ± 2.1 | 41.0 ± 3.1 | 50.9 ± 2.2 |
| TFN | ODLTA | 0.2 | 3.2:4.5:0.02 | 0.13 | 21.4 ± 0.9 | 14.5 ± 0.4 | 99.4 ± 0.6 |

| | | NP | MPD solution | TMC | | | AFM roughness | |
|---|---|---|---|---|---|---|---|---|
| Membrane | Nanoparticle | concentration | (w/v %) | concentration | Contact | Zeta potential | data | |
| Type | Type | (w/v %) | MPD:TEACSA:SLS | (w/v %) | Angle (°) | (mV) | Rᵣₘₛ (nm) | SAD (%) |
| TFC | — | 0 | 3.2:4.5:0.02 | 0.13 | 62.2 ± 1.1 | −93.0 ± 4.7 | 59.2 ± 8.9 | 20.6 ± 5.9 |
| TFN | NS-LTA | 0.2 | 3.2:4.5:0.02 | 0.13 | 72.0 ± 4.1 | −1.4 ± 0.3 | 80.8 ± 4.4 | 19.0 ± 3.2 |
| TFN | NS-ODLTA | 0.2 | 3.2:4.5:0.02 | 0.13 | 67.0 ± 2.1 | −10.2 ± 2.1 | 81.7 ± 15.9 | 76.0 ± 4.1 |

The data in the tables above indicate that LTA-based TFN membranes (of this formulation) give rise to remarkably high fluxes, but salt rejection that is generally unacceptable for most reverse osmosis separations. These membranes behave like nanofiltration membranes in terms of their flux and rejection characteristics. However, the organic modified LTA (ODLTA) based TFN membranes exhibit double the flux of a pure TFC membrane with seawater RO membrane-like salt rejections, while exhibiting good hydrophilicity and less negative charge, which aids fouling resistance.

6. PVA and nPVA Coated TFC and TFN RO Membranes

Membrane coupons (7.6 cm*2.5 cm) were thoroughly rinsed with DI and soaked in DI water for 24 h, before being loaded into membrane testing cells. No feed spacer was placed in test cell. Membrane coupons were compacted with DI at 950 psi for 24 h. After compaction, operating pressure was decreased to 800 psi and pure water flux was measured. An appropriate volume of premixed stock of NaCl solution was added to provide a 32000 mg/L salt concentration. After salt addition, the unit was allowed to equilibrate for 1 h. Permeate samples were drawn and conductivity was measured (Accumet pH meter, Fisher Scientific, Pittsburgh, Pa.).

The data in the table below indicate that PVA coatings produce decreasing permeability, but increasing salt rejection when coated over TFC or TFN membranes.

| | | TEA | | | | | Nano- | Pure | Salt | Observed | Instrinsic |
|---|---|---|---|---|---|---|---|---|---|---|---|
| | MPD | CSA | TMC | Nano- | NP | PVA | particle | water | water | Rejection | Rejection |
| Membrane | Conc | Conc | Conc | particle | conc | conc. | in PVA | flux | flux | R_obs | R_int |
| Type | [wt %] | [wt %] | [wt %] | Type | [w/v %] | [wt %] | layer | [gfd] | [gfd] | [%] | [%] |
| TFC | 3.2 | 2.2 | 0.18 | — | 0 | — | — | 120.3 | 40.0 | 94.48 | 95.93 |
| TFC-PVA0.25 | 3.2 | 2.2 | 0.18 | — | 0 | 0.25 | — | 115.2 | 38.0 | 98.99 | 99.26 |
| TFC-PVA0.5 | 3.2 | 2.2 | 0.18 | — | 0 | 0.5 | — | 95.3 | 17.3 | 98.95 | 99.37 |
| TFC-PVA1.0 | 3.2 | 2.2 | 0.18 | — | 0 | 1 | — | 78.7 | 29.0 | 97.32 | 97.91 |
| TFN | 3.2 | 2.2 | 0.18 | NS-AOD | 0.2 | — | — | 126.6 | 43.8 | 96.37 | 97.26 |
| TFN-PVA0.25 | 3.2 | 2.2 | 0.18 | NS-AOD | 0.2 | 0.25 | — | 111.9 | 39.4 | 97.77 | 98.30 |
| TFN-PVA0.5 | 3.2 | 2.2 | 0.18 | NS-AOD | 0.2 | 0.5 | — | 39.4 | 17.1 | 90.22 | 91.49 |
| TFN-PVA1.0 | 3.2 | 2.2 | 0.18 | NS-AOD | 0.2 | 1 | — | 93.9 | 31.7 | 97.46 | 98.11 |
| TFC-nPVA(AgLTA) | 3.2 | 2.2 | 0.18 | — | 0 | 0.5 | Ag-LTA | 67.9 | 29.7 | 77.68 | 80.48 |
| TFN-nPVA(AgLTA) | 3.2 | 2.2 | 0.18 | NS-AOD | 0.2 | 0.5 | Ag-LTA | 62.3 | 24.7 | 96.28 | 96.96 |
| TFC-nPVA(LTA) | 3.2 | 2.2 | 0.18 | — | 0 | 0.5 | LTA | 86.4 | 32.3 | 98.67 | 98.95 |
| TFN-nPVA(LTA) | 3.2 | 2.2 | 0.18 | NS-AOD | 0.2 | 0.5 | LTA | 97.9 | 35.2 | 94.06 | 95.43 |

After this stage, a culture of H. Pacifica was washed three times with an electrolyte solution identical to the one used in the fouling experiment (32000 mg/L NaCl). The washed H. Pacifica was inoculated into the feed reservoir. The initial cell concentration in 1^{st} biofouling test is 3.03*10¹⁰ cells per liter and that in 2^{nd} biofouling test is 3.85*10⁹ cells per liter and 4.03*10⁹ cells per liter. During the entire test run, feed water temperature was maintained at 25±1° C. Both concentrate and permeate were recycled back to the feed tank to maintain constant feed tank concentration. Flux was determined by a digital flow meter (Optiflow 1000, Agilent Technology Inc., Foster City, Calif.). Cross-flow velocity for each cell was 0.075 m/s.

| | | Cake | | Flux | |
|---|---|---|---|---|---|
| | Initial | Resistance | | Retention | |
| Membrane | Flux | (m−1) | | (%) | |
| Type | (gfd) | (3 h) | (24 h) | (3 h) | (24 h) |
| TFC | 29.28 | 4.35E+14 | 4.78E+14 | 32.8 | 30.7 |
| TFC-PVA1.0 | 1.45 | 3.04E+15 | 5.18E+15 | 58.5 | 45.3 |
| TFN | 48.23 | 1.89E+13 | 1.14E+14 | 87.2 | 53.0 |
| TFN-PVA1.0 | 14.24 | 1.30E+14 | 4.17E+14 | 76.9 | 51.1 |
| TFC-nPVA(AgLTA) | 11.88 | 2.45E+13 | 1.41E+14 | 95.5 | 78.7 |
| TFN-nPVA(AgLTA) | 14.20 | 8.14E+13 | 2.44E+14 | 84.3 | 64.1 |

The data of the table above indicate the cake layer that accumulates on PVA coated RO membranes is significantly lower than the cake layer that accumulates on bare TFC membranes. Also interesting is the dramatically higher flux of the TFN membrane and the very low cake layer resistance, indicating TFN membranes are intrinsically more energy efficient and fouling resistant than TFC membranes. Also, nearly all PVA coated membranes maintain higher fluxes over 24 hours when challenged with extremely high fouling bacterial suspensions. The TFC membrane loses about 70 percent of its initial flux after only 3 hours, whereas all PVA coated films retain at least 50 percent of their initial flux after 24 hours.

### H. Bacterial Viability

After fouling test (1^{st} batch) or cleaning test (2^{nd} batch), the membrane coupons were gently removed from the cells. The viability of bacteria on membrane surface was determined using a Live/Dead Baclight staining kit (Molecular Probes, CA, USA). Membrane sample was put into the staining reagent mixtures in the ratio of 1:1 of SYTO 9 green fluorescent nucleic acid stain and red fluorescent stain, propidium iodide and then stored in the absence of light for 15 minutes after which the membrane sample was analyzed by different fluorescence microscopy.

| | | | | | TFC + | TFN + |
|---|---|---|---|---|---|---|
| | | | | | PVA- | PVA- |
| Surface | TFC | TFN | TFC + PVA | TFN + PVA | AgLTA | AgLTA |
| uncoated | 0% | 9% | 96% | 47% | 0% | 75% |
| live (%) | 49% | 45% | 1% | 18% | 53% | 9% |
| dead (%) | 51% | 46% | 3% | 35% | 48% | 16% |

The data of the table above indicate that fewer bacteria remain adhered to TFN and PVA coated membranes. The best performing formulations appear to be PVA coated TFC and TFN membranes. PVA coated TFC membranes appear very fouling resistant as almost no bacteria remain adhered to the membrane after rinsing with water, whereas the TFC membranes is completely coated with bacteria—some alive and some dead. In addition, the PVA-AgLTA coated TFN membrane because of the high fraction of surface that is uncoated with bacteria and the significant inactivation of bacteria directly by the surface.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1-61. (canceled)

62. A method of making a compaction and fouling resistant TFC membrane, comprising:
disbursing nanoparticles in a casting solution;
casting a porous support membrane with the casting solution;
dispersing nanoparticles in at least one of an aqueous and an organic solution, each such solution including at least one monomer;
contacting the aqueous and organic solution the porous support membrane to form a selective membrane; and
coating a hydrophilic layer on the selective membrane.

63. The method of claim 62, wherein dispersing nanoparticles in the casting solution further comprises:
selecting nanoparticles different than the nanoparticles in the aqueous solution.

64. The method of claim 62, wherein dispersing nanoparticles in the casting solution further comprises:
selecting nanoparticles different than the nanoparticles in the organic solution.

65. The method of claim 62, wherein dispersing nanoparticles in the casting solution further comprises:
selecting nanoparticles different than the nanoparticles in the aqueous or organic solution.

66. The method of claim 62, wherein coating a hydrophilic layer on a second surface of the porous support membrane further comprises:
dispersing nanoparticles in the hydrophilic layer.

67. The method of claim 66, wherein dispersing nanoparticles in the casting solution further comprises:
selecting nanoparticles different than the nanoparticles in the hydrophilic layer.

68. The method of claim 67, wherein dispersing nanoparticles in the casting solution further comprises:
selecting nanoparticles different than the nanoparticles in the aqueous or organic solutions.

69. The method of claim 62, further comprising:
selecting nanoparticles for dispersion in the casting solution to maximize compaction resistance and reduce loss of flux over time.

70. The method of claim 69, further comprising:
selecting nanoparticles for dispersion in the aqueous or organic solutions to maximize flux and rejection.

71. The method of claims 66, further comprising:
selecting nanoparticles for dispersion in the hydrophilic layer to minimize fouling.

72. The method of claim 71, further comprising:
selecting nanoparticles for dispersion in the casting solution to maximize compaction resistance and reduce loss of flux over time.

73. The method of claim 72, further comprising:
selecting nanoparticles for dispersion in the aqueous or organic solutions to maximize flux and rejection.

74. The method of claim 73, further comprising:
selecting nanoparticles for dispersion in the hydrophilic layer to maximize surface hydrophilicity.

75. The method of claim 74, wherein selecting nanoparticles for dispersion in the hydrophilic layer further comprises:
selecting nanoparticles for dispersion in the hydrophilic layer to minimize fouling by antimicrobial activity.

76. The method of claim 66, wherein selecting nanoparticles for dispersion in the hydrophilic layer further comprises:
selecting nanoparticles for dispersion in the hydrophilic layer to maximize hydrophilicity and minimize fouling by antimicrobial activity.

77. The method of claim 76, wherein the nanoparticles are LTA particles.

78. The method of claim 76, wherein the nanoparticles are surface modified LTA particles.

79. The method of claim 62, wherein the hydrophilic layer is cross linked.

80. The method of claim 62, wherein the hydrophilic layer is PVA.

81. A compaction and fouling resistant TFC membrane made by any of the methods of claim 62.
